(19) United States
(12) Patent Application Publication
(10) Pub. No.: US 2025/0030503 A1
(43) Pub. Date: Jan. 23, 2025

(54) PARTIAL BANDWIDTH FEEDBACK FOR 480/640 MHZ TRANSMISSION IN WI-FI

(71) Applicant: QUALCOMM Incorporated, San Diego, CA (US)

(72) Inventors: Jialing Li CHEN, San Diego, CA (US); Lin YANG, San Diego, CA (US); Bin TIAN, San Diego, CA (US)

(21) Appl. No.: 18/356,141

(22) Filed: Jul. 20, 2023

(51) Int. Cl. H04L 1/1607; H04L 5/00; H04W 72/12

(52) U.S. Cl. CPC H04L 1/1614; H04L 5/0092; H04W 72/12; H04W 84/12

(57) ABSTRACT

This disclosure provides methods, components, devices and systems for partial bandwidth feedback for 480 and 640 MHz transmission in Wi-Fi. Some aspects more specifically relate to the inclusion of a partial bandwidth information field in a null data packet (NDP) announcement frame that indicates for which frequency portions of the 480 or 640 MHz channel bandwidth to generate channel information feedback. In some examples, a receiving device (for example, a station (STA)) may perform channel estimation on an NDP and transmit a beamforming report to the transmitting device (for example, an access point (AP)) based on the NDP. The transmitting device schedules the NDP using an NDP announcement frame, which includes the partial bandwidth information field. The partial bandwidth information field in the NDP announcement frame may include a frequency resolution field and a bitmap with values and lengths based on the channel bandwidth being 480 or 640 MHz.

### TECHNICAL FIELD

This disclosure relates to wireless communication and, more specifically, to partial bandwidth feedback for 480 and/or 640 megahertz (MHz) transmission in Wi-Fi.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In some WLANs, wireless communications devices such as STAs and APs transmit and receive wireless communications to and from one another in the form of physical layer (PHY) protocol data units (PPDUs). PPDUs conforming to the IEEE 802.11n, 802.11ac, 802.11ax and 802.11be standard amendments may be transmitted over the 2.4 gigahertz (GHz), 5 GHz or 6 GHz bands. Each band may include multiple channels. Currently, 20, 40, 80, 160, and 360 megahertz (MHz) channels may be used, and a channel is defined by a center frequency index and operating bandwidth (for example, 20, 40, 80, 160, and 360 MHz). A receiving device (for example, a STA) may perform channel estimation on a null data packet (NDP) and transmit a feedback report (for example, a beamforming report) to the transmitting device (for example, an AP) based on measurements performed based on the NDP. The transmitting device may select beams for transmissions of PPDUs to the receiving device based on the beamforming report. The transmitting device schedules the NDP using an NDP announcement frame.

### SUMMARY

The systems, methods, and devices of this disclosure each have several innovative aspects, no single one of which is solely responsible for the desirable attributes disclosed herein.

A method for wireless communications by a wireless communications device is described. The method may include receiving a null data packet (NDP) announcement (NDPA) frame including a partial bandwidth information field, the partial bandwidth information field including a first set of bits indicating a frequency resolution and a second set of bits including a feedback bitmap, the feedback bitmap indicating one or more portions of a channel bandwidth over which to provide feedback in accordance with the frequency resolution, where a value of the first set of bits and a quantity of bits in the second set of bits are based on the channel bandwidth being one of 480 MHz or 640 MHz, receiving, in accordance with the NDPA frame, an NDP, and transmitting a feedback report based on the NDP and the partial bandwidth information field.

A wireless communications device for wireless communications is described. The wireless communications device may include a processing system that includes processor circuitry and memory circuitry that stores code, the processing system configured to cause the wireless communication device to: receive an NDPA frame including a partial bandwidth information field, the partial bandwidth information field including a first set of bits indicating a frequency resolution and a second set of bits including a feedback bitmap, the feedback bitmap indicating one or more portions of a channel bandwidth over which to provide feedback in accordance with the frequency resolution, where a value of the first set of bits and a quantity of bits in the second set of bits are based on the channel bandwidth being one of 480 MHz or 640 MHz, receive, in accordance with the NDPA frame, an NDP, and transmit a feedback report based on the NDP and the partial bandwidth information field.

Another wireless communications device for wireless communications is described. The wireless communications device may include means for receiving an NDPA frame including a partial bandwidth information field, the partial bandwidth information field including a first set of bits indicating a frequency resolution and a second set of bits including a feedback bitmap, the feedback bitmap indicating one or more portions of a channel bandwidth over which to provide feedback in accordance with the frequency resolution, where a value of the first set of bits and a quantity of bits in the second set of bits are based on the channel bandwidth being one of 480 MHz or 640 MHz, means for receiving, in accordance with the NDPA frame, an NDP, and means for transmitting a feedback report based on the NDP and the partial bandwidth information field.

A non-transitory computer-readable medium storing code for wireless communications is described. The code may include instructions executable by a processor to receive an NDPA frame including a partial bandwidth information field, the partial bandwidth information field including a first set of bits indicating a frequency resolution and a second set of bits including a feedback bitmap, the feedback bitmap indicating one or more portions of a channel bandwidth over which to provide feedback in accordance with the frequency resolution, where a value of the first set of bits and a quantity of bits in the second set of bits are based on the channel bandwidth being one of 480 MHz or 640 MHz, receive, in accordance with the NDPA frame, an NDP, and transmit a feedback report based on the NDP and the partial bandwidth information field.

In some examples of the method, wireless communications devices, and non-transitory computer-readable medium described herein, the channel bandwidth may be 480 MHz, the first set of bits includes one bit and indicates that the frequency resolution may be 40 MHz, and the feedback bitmap includes 12 bits.

In some examples of the method, wireless communications devices, and non-transitory computer-readable medium described herein, the channel bandwidth may be 480 MHz, the first set of bits includes two bits and indicates that the frequency resolution may be 80 MHz, and the feedback bitmap includes 6 bits.

In some examples of the method, wireless communications devices, and non-transitory computer-readable medium described herein, the channel bandwidth may be 640 MHz, the first set of bits includes one bit and indicates that the frequency resolution may be 40 MHz, and the feedback bitmap includes 16 bits.

In some examples of the method, wireless communications devices, and non-transitory computer-readable medium described herein, the channel bandwidth may be 640 MHz, the first set of bits includes two bits and indicates that the frequency resolution may be 80 MHz, and the feedback bitmap includes 8 bits.

In some examples of the method, wireless communications devices, and non-transitory computer-readable medium described herein, transmitting the feedback report may include operations, features, means, or instructions for transmitting feedback indexed by a set of subcarrier indices, where the set of subcarrier indices ranges from −3060 to 3060 for a 480 MHz channel bandwidth and −4084 to 4048 for a 640 MHz channel bandwidth, where subcarrier indices included in the set of subcarrier indices may be based on a grouping value, where the NDPA frame includes a grouping field that indicates the grouping value.

In some examples of the method, wireless communications devices, and non-transitory computer-readable medium described herein, the channel bandwidth may be 480 MHz, the NDPA frame indicates that feedback may be requested in accordance with 242 tone resource units, a first subset of subcarrier indices that provide feedback for a first 20 MHz subchannel of the 480 MHz channel bandwidth includes [−3060:Ng:−2820], a second subset of subcarrier indices that provide feedback for a second 20 MHz subchannel of the 480 MHz channel bandwidth includes [−2812:Ng:−2572], a third subset of subcarrier indices that provide feedback for a third 20 MHz subchannel of the 480 MHz channel bandwidth includes [−2548:Ng:−2308], a fourth subset of subcarrier indices that provide feedback for a fourth 20 MHz subchannel of the 480 MHz channel bandwidth includes [−2300:Ng:−2060], a fifth subset of subcarrier indices that provide feedback for a fifth 20 MHz subchannel of the 480 MHz channel bandwidth includes [−2036:Ng: −1796], a sixth subset of subcarrier indices that provide feedback for a sixth 20 MHz subchannel of the 480 MHz channel bandwidth includes [−1788:Ng: −1548], a seventh subset of subcarrier indices that provide feedback for a seventh 20 MHz subchannel of the 480 MHz channel bandwidth includes [−1524:Ng: −1284], an eighth subset of subcarrier indices that provide feedback for an eighth 20 MHz subchannel of the 480 MHz channel bandwidth includes [−1276:Ng: −1036], a ninth subset of subcarrier indices that provide feedback for a ninth 20 MHz subchannel of the 480 MHz channel bandwidth includes [−1012:Ng: −772], a tenth subset of subcarrier indices that provide feedback for a tenth 20 MHz subchannel of the 480 MHz channel bandwidth includes [−764:Ng: −524], an eleventh subset of subcarrier indices that provide feedback for an eleventh 20 MHz subchannel of the 480 MHz channel bandwidth includes [−500:Ng: −260], a twelfth subset of subcarrier indices that provide feedback for a twelfth 20 MHz subchannel of the 480 MHz channel bandwidth includes [−252:Ng:−12], a thirteenth subset of subcarrier indices that provide feedback for a thirteenth 20 MHz subchannel of the 480 MHz channel bandwidth includes [12:Ng:252], a fourteenth subset of subcarrier indices that provide feedback for a fourteenth 20 MHz subchannel of the 480 MHz channel bandwidth includes [260:Ng:500], a fifteenth subset of subcarrier indices that provide feedback for a fifteenth 20 MHz subchannel of the 480 MHz channel bandwidth includes [524:Ng:764], a sixteenth subset of subcarrier indices that provide feedback for a sixteenth 20 MHz subchannel of the 480 MHz channel bandwidth includes [772:Ng:1012], a seventeenth subset of subcarrier indices that provide feedback for a seventeenth 20 MHz subchannel of the 480 MHz channel bandwidth includes [1036:Ng: 1276], an eighteenth subset of subcarrier indices that provide feedback for an eighteenth 20 MHz subchannel of the 480 MHz channel bandwidth includes [1284:Ng: 1524], a nineteenth subset of subcarrier indices that provide feedback for a nineteenth 20 MHz subchannel of the 480 MHz channel bandwidth includes [1548:Ng: 1788], a twentieth subset of subcarrier indices that provide feedback for a twentieth 20 MHz subchannel of the 480 MHz channel bandwidth includes [1796:Ng: 2036], a twenty-first subset of subcarrier indices that provide feedback for a twenty-first 20 MHz subchannel of the 480 MHz channel bandwidth includes [2060:Ng:2300], a twenty-second subset of subcarrier indices that provide feedback for a twenty-second 20 MHz subchannel of the 480 MHz channel bandwidth includes [2308:Ng:2548], a twenty-third subset of subcarrier indices that provide feedback for a twenty-third 20 MHz subchannel of the 480 MHz channel bandwidth includes [2572:Ng:2812], a twenty-fourth subset of subcarrier indices that provide feedback for a twenty-fourth 20 MHz subchannel of the 480 MHz channel bandwidth includes [2820:Ng:3060], and Ng may be equal to the grouping value.

In some examples of the method, wireless communications devices, and non-transitory computer-readable medium described herein, the channel bandwidth may be 640 MHz, the NDPA frame indicates that feedback may be requested in accordance with 242 tone resource units, a first subset of subcarrier indices that provide feedback for a first 20 MHz subchannel of the 640 MHz channel bandwidth includes [−4084:Ng:−3844], a second subset of subcarrier indices that provide feedback for a second 20 MHz subchannel of the 640 MHz channel bandwidth includes [−3836:Ng:−3596], a third subset of subcarrier indices that provide feedback for a third 20 MHz subchannel of the 640 MHz channel bandwidth includes [−3572:Ng:−3332], a fourth subset of subcarrier indices that provide feedback for a fourth 20 MHz subchannel of the 640 MHz channel bandwidth includes [−3324:Ng:−3084], a fifth subset of subcarrier indices that provide feedback for a fifth 20 MHz subchannel of the 640 MHz channel bandwidth includes [−3060:Ng:−2820], a sixth subset of subcarrier indices that provide feedback for a sixth 20 MHz subchannel of the 640 MHz channel bandwidth includes [−2812:Ng:−2572], a seventh subset of subcarrier indices that provide feedback for a seventh 20 MHz subchannel of the 640 MHz channel bandwidth includes [−2548:Ng:−2308], an eighth subset of subcarrier indices that provide feedback for an eighth 20 MHz subchannel of the 640 MHz channel bandwidth includes [−2300:Ng:−2060], a ninth subset of subcarrier indices that provide feedback for a ninth 20 MHz subchannel of the 640 MHz channel bandwidth includes [−2036:Ng: −1796], a tenth subset of subcarrier indices that provide feedback for a tenth 20 MHz subchannel of the 640 MHz channel bandwidth includes [−1788:Ng: −1548], an eleventh subset of subcarrier indices that provide feedback for an eleventh 20 MHz subchannel of the 640 MHz channel bandwidth includes [−1524:Ng: −1284], a twelfth subset of subcarrier indices that provide feedback for a twelfth 20 MHz subchannel of the 640 MHz channel bandwidth includes [−1276:Ng: −1036], a thirteenth subset of subcarrier indices that provide feedback for a thirteenth 20 MHz subchannel of the 640 MHz channel bandwidth includes [−1012:Ng: −772], a fourteenth subset of subcarrier indices that provide feedback for a fourteenth 20 MHz subchannel of the 640 MHz channel bandwidth includes [−764:Ng: −524], a fifteenth subset of subcarrier indices that provide feedback for a fifteenth 20 MHz subchannel of the 640 MHz channel bandwidth includes [−500:Ng: −260], a sixteenth subset of subcarrier indices that provide feedback for a sixteenth 20 MHz subchannel of the 640 MHz channel bandwidth includes [−252:Ng:−12], a seventeenth subset of subcarrier indices that provide feedback for a seventeenth 20 MHz subchannel of the 640 MHz channel bandwidth includes [12:Ng:252], an eighteenth subset of subcarrier indices that provide feedback for an eighteenth 20 MHz subchannel of the 640 MHz channel bandwidth includes [260:Ng:500], a nineteenth subset of subcarrier indices that provide feedback for a nineteenth 20 MHz subchannel of the 640 MHz channel bandwidth includes [524:Ng:764], a twentieth subset of subcarrier indices that provide feedback for a twentieth 20 MHz subchannel of the 640 MHz channel bandwidth includes [772:Ng:1012], a twenty-first subset of subcarrier indices that provide feedback for a twenty-first 20 MHz subchannel of the 640 MHz channel bandwidth includes [1036:Ng: 1276], a twenty-second subset of subcarrier indices that provide feedback for a twenty-second 20 MHz subchannel of the 640 MHz channel bandwidth includes [1284:Ng: 1524], a twenty-third subset of subcarrier indices that provide feedback for a twenty-third 20 MHz subchannel of the 640 MHz channel bandwidth includes [1548:Ng: 1788], a twenty-fourth subset of subcarrier indices that provide feedback for a twenty-fourth 20 MHz subchannel of the 640 MHz channel bandwidth includes [1796:Ng: 2036], a twenty-fifth subset of subcarrier indices that provide feedback for a twenty-fifth 20 MHz subchannel of the 640 MHz channel bandwidth includes [2060:Ng:2300], a twenty-sixth subset of subcarrier indices that provide feedback for a twenty-sixth 20 MHz subchannel of the 640 MHz channel bandwidth includes [2308:Ng:2548], a twenty-seventh subset of subcarrier indices that provide feedback for a twenty-seventh 20 MHz subchannel of the 640 MHz channel bandwidth includes [2572:Ng:2812], a twenty-eighth subset of subcarrier indices that provide feedback for a twenty-eighth 20 MHz subchannel of the 640 MHz channel bandwidth includes [2820:Ng:3060], a twenty-ninth subset of subcarrier indices that provide feedback for a twenty-ninth 20 MHz subchannel of the 640 MHz channel bandwidth includes [3084:Ng:3324], a thirtieth subset of subcarrier indices that provide feedback for a thirtieth 20 MHz subchannel of the 640 MHz channel bandwidth includes [3332:Ng:3572], a thirty-first subset of subcarrier indices that provide feedback for a thirty-first 20 MHz subchannel of the 640 MHz channel bandwidth includes [3596:Ng:3836], a thirty-second subset of subcarrier indices that provide feedback for a thirty-second 20 MHz subchannel of the 640 MHz channel bandwidth includes [3844:Ng:4084], and Ng may be equal to the grouping value.

In some examples of the method, wireless communications devices, and non-transitory computer-readable medium described herein, the channel bandwidth may be 480 MHz, the NDPA frame indicates that feedback may be requested in accordance with 996 tone resource units, the grouping value may be 4, a first subset of subcarrier indices that provide feedback for a first 80 MHz subchannel of the 480 MHz channel bandwidth includes [−3060:4:−2564, −2556:4:−2060], a second subset of subcarrier indices that provide feedback for a second 80 MHz subchannel of the 480 MHz channel bandwidth includes [−2036:4:−1540, −1532:4:−1036], a third subset of subcarrier indices that provide feedback for a third 80 MHz subchannel of the 480 MHz channel bandwidth includes [−1012:4:−516, −508:4:−12], a fourth subset of subcarrier indices that provide feedback for a fourth 80 MHz subchannel of the 480 MHz channel bandwidth includes [12:4:508, 516:4:1012], a fifth subset of subcarrier indices that provide feedback for a fifth 80 MHz subchannel of the 480 MHz channel bandwidth includes [1036:4:1532, 1540:4:2036], and a sixth subset of subcarrier indices that provide feedback for a sixth 80 MHz subchannel of the 480 MHz channel bandwidth includes [2060:4:2556, 2564:4:3060].

In some examples of the method, wireless communications devices, and non-transitory computer-readable medium described herein, the channel bandwidth may be 640 MHz, the NDPA frame indicates that feedback may be requested in accordance with 996 tone resource units, the grouping value may be 4, a first subset of subcarrier indices that provide feedback for a first 80 MHz subchannel of the 640 MHz channel bandwidth includes [−4084:4:−3588, −3580:4:−3084], a second subset of subcarrier indices that provide feedback for a second 80 MHz subchannel of the 640 MHz channel bandwidth includes [−3060:4:−2564, −2556:4:−2060], a third subset of subcarrier indices that provide feedback for a third 80 MHz subchannel of the 640 MHz channel bandwidth includes [−2036:4:−1540, −1532:4:−1036], a fourth subset of subcarrier indices that provide feedback for a fourth 80 MHz subchannel of the 640 MHz channel bandwidth includes [−1012:4:−516, −508:4:−12], a fifth subset of subcarrier indices that provide feedback for a fifth 80 MHz subchannel of the 640 MHz channel bandwidth includes [12:4:508, 516:4:1012], a sixth subset of subcarrier indices that provide feedback for a sixth 80 MHz subchannel of the 640 MHz channel bandwidth includes [1036:4:1532, 1540:4:2036], a seventh subset of subcarrier indices that provide feedback for a seventh 80 MHz subchannel of the 640 MHz channel bandwidth includes [2060:4:2556, 2564:4:3060], and an eighth subset of subcarrier indices that provide feedback for an eighth 80 MHz subchannel of the 640 MHz channel bandwidth includes [3084:4:3580, 3588:4:4084].

In some examples of the method, wireless communications devices, and non-transitory computer-readable medium described herein, the channel bandwidth may be 480 MHz, the NDPA frame indicates that feedback may be requested in accordance with 996 tone resource units, the grouping value may be 16, a first subset of subcarrier indices that provide feedback for a first 80 MHz subchannel of the 480 MHz channel bandwidth includes [−3060:16:−2820, −2812:16:−2572, −2564, −2556, −2548:16:−2308, −2300:16:−2060], a second subset of subcarrier indices that provide feedback for a second 80 MHz subchannel of the 480 MHz channel bandwidth includes [−2036:16:−1796, −1788:16:−1548, −1540, −1532, −1524:16:−1284, −1276:16:−1036], a third subset of subcarrier indices that provide feedback for a third 80 MHz subchannel of the 480 MHz channel bandwidth includes [−1012:16:−772, −764:16:−524, −516, −508, −500:16:−260, −252:16:−12], a fourth subset of subcarrier indices that provide feedback for a fourth 80 MHz subchannel of the 480 MHz channel bandwidth includes [12:16:252, 260:16:500, 508, 516, 524:16:764, 772:16:1012], a fifth subset of subcarrier indices that provide feedback for a fifth 80 MHz subchannel of the 480 MHz channel bandwidth includes [1036:16:1276, 1284:16:1524, 1532, 1540, 1548:16:1788, 1796:16:2036], and a sixth subset of subcarrier indices that provide feedback for a sixth 80 MHz subchannel of the 480 MHz channel bandwidth includes [2060:16:2300, 2308:16:2548, 2556, 2564, 2572:16:2812, 2820:16:3060].

In some examples of the method, wireless communications devices, and non-transitory computer-readable medium described herein, the channel bandwidth may be 640 MHz, the NDPA frame indicates that feedback may be requested in accordance with 996 tone resource units, the grouping value may be 16, a first subset of subcarrier indices that provide feedback for a first 80 MHz subchannel of the 640 MHz channel bandwidth includes [−4084:16:−3844, −3836:16:−3596, −3588, −3580, −3572:16:−3332, −3324:16:−3084], a second subset of subcarrier indices that provide feedback for a second 80 MHz subchannel of the 640 MHz channel bandwidth includes [−3060:16:−2820, −2812:16:−2572, −2564, −2556, −2548:16:−2308, −2300:16:−2060], a third subset of subcarrier indices that provide feedback for a third 80 MHz subchannel of the 640 MHz channel bandwidth includes [−2036:16:−1796, −1788:16:−1548, −1540, −1532, −1524:16:−1284, −1276:16:−1036], a fourth subset of subcarrier indices that provide feedback for a fourth 80 MHz subchannel of the 640 MHz channel bandwidth includes [−1012:16:−772, −764:16:−524, −516, −508, −500:16:−260, −252:16:−12], a fifth subset of subcarrier indices that provide feedback for a fifth 80 MHz subchannel of the 640 MHz channel bandwidth includes [12:16:252, 260:16:500, 508, 516, 524:16:764, 772:16:1012], a sixth subset of subcarrier indices that provide feedback for a sixth 80 MHz subchannel of the 640 MHz channel bandwidth includes [1036:16:1276, 1284:16:1524, 1532, 1540, 1548:16:1788, 1796:16:2036], a seventh subset of subcarrier indices that provide feedback for a seventh 80 MHz subchannel of the 640 MHz channel bandwidth includes [2060:16:2300, 2308:16:2548, 2556, 2564, 2572:16:2812, 2820:16:3060], and an eighth subset of subcarrier indices that provide feedback for an eighth 80 MHz subchannel of the 640 MHz channel bandwidth includes [3084:16:3324, 3332:16:3572, 3580, 3588, 3596:16:3836, 3844:16:4084].

A method for wireless communications wireless communications device by an apparatus is described. The method may include transmitting an NDPA frame including a partial bandwidth information field, the partial bandwidth information field including a first set of bits indicating a frequency resolution and a second set of bits including a feedback bitmap, the feedback bitmap indicating one or more portions of a channel bandwidth over which to provide feedback in accordance with the frequency resolution, where a value of the first set of bits and a quantity of bits in the second set of bits are based on the channel bandwidth being one of 480 MHz or 640 MHz, transmitting, in accordance with the NDPA frame, an NDP, and receiving a feedback report based on the NDP and the partial bandwidth information field.

A wireless communications device for wireless communications is described. The wireless communications device may include a processing system that includes processor circuitry and memory circuitry that stores code, the processing system configured to cause the wireless communication device to: transmit an NDPA frame including a partial bandwidth information field, the partial bandwidth information field including a first set of bits indicating a frequency resolution and a second set of bits including a feedback bitmap, the feedback bitmap indicating one or more portions of a channel bandwidth over which to provide feedback in accordance with the frequency resolution, where a value of the first set of bits and a quantity of bits in the second set of bits are based on the channel bandwidth being one of 480 MHz or 640 MHz, transmit, in accordance with the NDPA frame, an NDP, and receive a feedback report based on the NDP and the partial bandwidth information field.

Another apparatus for wireless communications wireless communications device is described. The apparatus may include means for transmitting an NDPA frame including a partial bandwidth information field, the partial bandwidth information field including a first set of bits indicating a frequency resolution and a second set of bits including a feedback bitmap, the feedback bitmap indicating one or more portions of a channel bandwidth over which to provide feedback in accordance with the frequency resolution, where a value of the first set of bits and a quantity of bits in the second set of bits are based on the channel bandwidth being one of 480 MHz or 640 MHz, means for transmitting, in accordance with the NDPA frame, an NDP, and means for receiving a feedback report based on the NDP and the partial bandwidth information field.

A non-transitory computer-readable medium storing code for wireless communications wireless communications device is described. The code may include instructions executable by a processor to transmit an NDPA frame including a partial bandwidth information field, the partial bandwidth information field including a first set of bits indicating a frequency resolution and a second set of bits including a feedback bitmap, the feedback bitmap indicating one or more portions of a channel bandwidth over which to provide feedback in accordance with the frequency resolution, where a value of the first set of bits and a quantity of bits in the second set of bits are based on the channel bandwidth being one of 480 MHz or 640 MHz, transmit, in accordance with the NDPA frame, an NDP, and receive a feedback report based on the NDP and the partial bandwidth information field.

In some examples of the method, apparatus, and non-transitory computer-readable medium described herein, the channel bandwidth may be 480 MHz, the first set of bits includes one bit and indicates that the frequency resolution may be 40 MHz, and the feedback bitmap includes 12 bits.

In some examples of the method, apparatus, and non-transitory computer-readable medium described herein, the channel bandwidth may be 480 MHz, the first set of bits includes two bits and indicates that the frequency resolution may be 80 MHz, and the feedback bitmap includes 6 bits.

In some examples of the method, apparatus, and non-transitory computer-readable medium described herein, the channel bandwidth may be 640 MHz, the first set of bits includes one bit and indicates that the frequency resolution may be 40 MHz, and the feedback bitmap includes 16 bits.

In some examples of the method, apparatus, and non-transitory computer-readable medium described herein, the channel bandwidth may be 640 MHz, the first set of bits includes two bits and indicates that the frequency resolution may be 80 MHz, and the feedback bitmap includes 8 bits.

In some examples of the method, apparatus, and non-transitory computer-readable medium described herein, receiving the feedback report may include operations, features, means, or instructions for receiving feedback indexed by a set of subcarrier indices, where the set of subcarrier indices ranges from −3060 to 3060 for a 480 MHz channel bandwidth and −4084 to 4048 for a 640 MHz channel bandwidth, where subcarrier indices included in the set of subcarrier indices may be based on a grouping value, where the NDPA frame includes a grouping field that indicates the grouping value.

In some examples of the method, apparatus, and non-transitory computer-readable medium described herein, the channel bandwidth may be 480 MHz, the NDPA frame indicates that feedback may be requested in accordance with 242 tone resource units, a first subset of subcarrier indices that provide feedback for a first 20 MHz subchannel of the 480 MHz channel bandwidth includes [−3060:Ng:−2820], a second subset of subcarrier indices that provide feedback for a second 20 MHz subchannel of the 480 MHz channel bandwidth includes [−2812:Ng:−2572], a third subset of subcarrier indices that provide feedback for a third 20 MHz subchannel of the 480 MHz channel bandwidth includes [−2548:Ng:−2308], a fourth subset of subcarrier indices that provide feedback for a fourth 20 MHz subchannel of the 480 MHz channel bandwidth includes [−2300:Ng:−2060], a fifth subset of subcarrier indices that provide feedback for a fifth 20 MHz subchannel of the 480 MHz channel bandwidth includes [−2036:Ng: −1796], a sixth subset of subcarrier indices that provide feedback for a sixth 20 MHz subchannel of the 480 MHz channel bandwidth includes [−1788:Ng: −1548], a seventh subset of subcarrier indices that provide feedback for a seventh 20 MHz subchannel of the 480 MHz channel bandwidth includes [−1524:Ng: −1284], an eighth subset of subcarrier indices that provide feedback for an eighth 20 MHz subchannel of the 480 MHz channel bandwidth includes [−1276:Ng: −1036], a ninth subset of subcarrier indices that provide feedback for a ninth 20 MHz subchannel of the 480 MHz channel bandwidth includes [−1012:Ng: −772], a tenth subset of subcarrier indices that provide feedback for a tenth 20 MHz subchannel of the 480 MHz channel bandwidth includes [−764:Ng: −524], an eleventh subset of subcarrier indices that provide feedback for an eleventh 20 MHz subchannel of the 480 MHz channel bandwidth includes [−500:Ng: −260], a twelfth subset of subcarrier indices that provide feedback for a twelfth 20 MHz subchannel of the 480 MHz channel bandwidth includes [−252:Ng:−12], a thirteenth subset of subcarrier indices that provide feedback for a thirteenth 20 MHz subchannel of the 480 MHz channel bandwidth includes [12:Ng:252], a fourteenth subset of subcarrier indices that provide feedback for a fourteenth 20 MHz subchannel of the 480 MHz channel bandwidth includes [260:Ng:500], a fifteenth subset of subcarrier indices that provide feedback for a fifteenth 20 MHz subchannel of the 480 MHz channel bandwidth includes [524:Ng:764], a sixteenth subset of subcarrier indices that provide feedback for a sixteenth 20 MHz subchannel of the 480 MHz channel bandwidth includes [772:Ng:1012], a seventeenth subset of subcarrier indices that provide feedback for a seventeenth 20 MHz subchannel of the 480 MHz channel bandwidth includes [1036:Ng: 1276], an eighteenth subset of subcarrier indices that provide feedback for an eighteenth 20 MHz subchannel of the 480 MHz channel bandwidth includes [1284:Ng: 1524], a nineteenth subset of subcarrier indices that provide feedback for a nineteenth 20 MHz subchannel of the 480 MHz channel bandwidth includes [1548:Ng: 1788], a twentieth subset of subcarrier indices that provide feedback for a twentieth 20 MHz subchannel of the 480 MHz channel bandwidth includes [1796:Ng: 2036], a twenty-first subset of subcarrier indices that provide feedback for a twenty-first 20 MHz subchannel of the 480 MHz channel bandwidth includes [2060:Ng:2300], a twenty-second subset of subcarrier indices that provide feedback for a twenty-second 20 MHz subchannel of the 480 MHz channel bandwidth includes [2308:Ng:2548], a twenty-third subset of subcarrier indices that provide feedback for a twenty-third 20 MHz subchannel of the 480 MHz channel bandwidth includes [2572:Ng:2812], a twenty-fourth subset of subcarrier indices that provide feedback for a twenty-fourth 20 MHz subchannel of the 480 MHz channel bandwidth includes [2820:Ng:3060], and Ng may be equal to the grouping value.

In some examples of the method, apparatus, and non-transitory computer-readable medium described herein, the channel bandwidth may be 640 MHz, the NDPA frame indicates that feedback may be requested in accordance with 242 tone resource units, a first subset of subcarrier indices that provide feedback for a first 20 MHz subchannel of the 640 MHz channel bandwidth includes [−4084:Ng:−3844], a second subset of subcarrier indices that provide feedback for a second 20 MHz subchannel of the 640 MHz channel bandwidth includes [−3836:Ng:−3596], a third subset of subcarrier indices that provide feedback for a third 20 MHz subchannel of the 640 MHz channel bandwidth includes [−3572:Ng:−3332], a fourth subset of subcarrier indices that provide feedback for a fourth 20 MHz subchannel of the 640 MHz channel bandwidth includes [−3324:Ng:−3084], a fifth subset of subcarrier indices that provide feedback for a fifth 20 MHz subchannel of the 640 MHz channel bandwidth includes [−3060:Ng:−2820], a sixth subset of subcarrier indices that provide feedback for a sixth 20 MHz subchannel of the 640 MHz channel bandwidth includes [−2812:Ng:−2572], a seventh subset of subcarrier indices that provide feedback for a seventh 20 MHz subchannel of the 640 MHz channel bandwidth includes [−2548:Ng:−2308], an eighth subset of subcarrier indices that provide feedback for an eighth 20 MHz subchannel of the 640 MHz channel bandwidth includes [−2300:Ng:−2060], a ninth subset of subcarrier indices that provide feedback for a ninth 20 MHz subchannel of the 640 MHz channel bandwidth includes [−2036:Ng: −1796], a tenth subset of subcarrier indices that provide feedback for a tenth 20 MHz subchannel of the 640 MHz channel bandwidth includes [−1788:Ng: −1548], an eleventh subset of subcarrier indices that provide feedback for an eleventh 20 MHz subchannel of the 640 MHz channel bandwidth includes [−1524:Ng: −1284], a twelfth subset of subcarrier indices that provide feedback for a twelfth 20 MHz subchannel of the 640 MHz channel bandwidth includes [−1276:Ng: −1036], a thirteenth subset of subcarrier indices that provide feedback for a thirteenth 20 MHz subchannel of the 640 MHz channel bandwidth includes [−1012:Ng: −772], a fourteenth subset of subcarrier indices that provide feedback for a fourteenth 20 MHz subchannel of the 640 MHz channel bandwidth includes [−764:Ng: −524], a fifteenth subset of subcarrier indices that provide feedback for a fifteenth 20 MHz subchannel of the 640 MHz channel bandwidth includes [−500:Ng: −260], a sixteenth subset of subcarrier indices that provide feedback for a sixteenth 20 MHz subchannel of the 640 MHz channel bandwidth includes [−252:Ng:−12], a seventeenth subset of subcarrier indices that provide feedback for a seventeenth 20 MHz subchannel of the 640 MHz channel bandwidth includes [12:Ng:252], an eighteenth subset of subcarrier indices that provide feedback for an eighteenth 20 MHz subchannel of the 640 MHz channel bandwidth includes [260:Ng:500], a nineteenth subset of subcarrier indices that provide feedback for a nineteenth 20 MHz subchannel of the 640 MHz channel bandwidth includes [524:Ng:764], a twentieth subset of subcarrier indices that provide feedback for a twentieth 20 MHz subchannel of the 640 MHz channel bandwidth includes [772:Ng:1012], a twenty-first subset of subcarrier indices that provide feedback for a twenty-first 20 MHz subchannel of the 640 MHz channel bandwidth includes [1036:Ng: 1276], a twenty-second subset of subcarrier indices that provide feedback for a twenty-second 20 MHz subchannel of the 640 MHz channel bandwidth includes [1284:Ng: 1524], a twenty-third subset of subcarrier indices that provide feedback for a twenty-third 20 MHz subchannel of the 640 MHz channel bandwidth includes [1548:Ng: 1788], a twenty-fourth subset of subcarrier indices that provide feedback for a twenty-fourth 20 MHz subchannel of the 640 MHz channel bandwidth includes [1796:Ng: 2036], a twenty-fifth subset of subcarrier indices that provide feedback for a twenty-fifth 20 MHz subchannel of the 640 MHz channel bandwidth includes [2060:Ng:2300], a twenty-sixth subset of subcarrier indices that provide feedback for a twenty-sixth 20 MHz subchannel of the 640 MHz channel bandwidth includes [2308:Ng:2548], a twenty-seventh subset of subcarrier indices that provide feedback for a twenty-seventh 20 MHz subchannel of the 640 MHz channel bandwidth includes [2572:Ng:2812], a twenty-eighth subset of subcarrier indices that provide feedback for a twenty-eighth 20 MHz subchannel of the 640 MHz channel bandwidth includes [2820:Ng:3060], a twenty-ninth subset of subcarrier indices that provide feedback for a twenty-ninth 20 MHz subchannel of the 640 MHz channel bandwidth includes [3084:Ng:3324], a thirtieth subset of subcarrier indices that provide feedback for a thirtieth 20 MHz subchannel of the 640 MHz channel bandwidth includes [3332:Ng:3572], a thirty-first subset of subcarrier indices that provide feedback for a thirty-first 20 MHz subchannel of the 640 MHz channel bandwidth includes [3596:Ng:3836], a thirty-second subset of subcarrier indices that provide feedback for a thirty-second 20 MHz subchannel of the 640 MHz channel bandwidth includes [3844:Ng:4084], and Ng may be equal to the grouping value.

In some examples of the method, apparatus, and non-transitory computer-readable medium described herein, the channel bandwidth may be 480 MHz, the NDPA frame indicates that feedback may be requested in accordance with 996 tone resource units, the grouping value may be 4, a first subset of subcarrier indices that provide feedback for a first 80 MHz subchannel of the 480 MHz channel bandwidth includes [−3060:4:−2564, −2556:4:−2060], a second subset of subcarrier indices that provide feedback for a second 80 MHz subchannel of the 480 MHz channel bandwidth includes [−2036:4:−1540, −1532:4:−1036], a third subset of subcarrier indices that provide feedback for a third 80 MHz subchannel of the 480 MHz channel bandwidth includes [−1012:4:−516, −508:4:−12], a fourth subset of subcarrier indices that provide feedback for a fourth 80 MHz subchannel of the 480 MHz channel bandwidth includes [12:4:508, 516:4:1012], a fifth subset of subcarrier indices that provide feedback for a fifth 80 MHz subchannel of the 480 MHz channel bandwidth includes [1036:4:1532, 1540:4:2036], and a sixth subset of subcarrier indices that provide feedback for a sixth 80 MHz subchannel of the 480 MHz channel bandwidth includes [2060:4:2556, 2564:4:3060].

In some examples of the method, apparatus, and non-transitory computer-readable medium described herein, the channel bandwidth may be 640 MHz, the NDPA frame indicates that feedback may be requested in accordance with 996 tone resource units, the grouping value may be 4, a first subset of subcarrier indices that provide feedback for a first 80 MHz subchannel of the 640 MHz channel bandwidth includes [−4084:4:−3588, −3580:4:−3084], a second subset of subcarrier indices that provide feedback for a second 80 MHz subchannel of the 640 MHz channel bandwidth includes [−3060:4:−2564, −2556:4:−2060], a third subset of subcarrier indices that provide feedback for a third 80 MHz subchannel of the 640 MHz channel bandwidth includes [−2036:4:−1540, −1532:4:−1036], a fourth subset of subcarrier indices that provide feedback for a fourth 80 MHz subchannel of the 640 MHz channel bandwidth includes [−1012:4:−516, −508:4:−12], a fifth subset of subcarrier indices that provide feedback for a fifth 80 MHz subchannel of the 640 MHz channel bandwidth includes [12:4:508, 516:4:1012], a sixth subset of subcarrier indices that provide feedback for a sixth 80 MHz subchannel of the 640 MHz channel bandwidth includes [1036:4:1532, 1540:4:2036], a seventh subset of subcarrier indices that provide feedback for a seventh 80 MHz subchannel of the 640 MHz channel bandwidth includes [2060:4:2556, 2564:4:3060], and an eighth subset of subcarrier indices that provide feedback for an eighth 80 MHz subchannel of the 640 MHz channel bandwidth includes [3084:4:3580, 3588:4:4084].

In some examples of the method, apparatus, and non-transitory computer-readable medium described herein, the channel bandwidth may be 480 MHz, the NDPA frame indicates that feedback may be requested in accordance with 996 tone resource units, the grouping value may be 16, a first subset of subcarrier indices that provide feedback for a first 80 MHz subchannel of the 480 MHz channel bandwidth includes [−3060:16:−2820, −2812:16:−2572, −2564, −2556, −2548:16:−2308, −2300:16:−2060], a second subset of subcarrier indices that provide feedback for a second 80 MHz subchannel of the 480 MHz channel bandwidth includes [−2036:16:−1796, −1788:16:−1548, −1540, −1532, −1524:16:−1284, −1276:16:−1036], a third subset of subcarrier indices that provide feedback for a third 80 MHz subchannel of the 480 MHz channel bandwidth includes [−1012:16:−772, −764:16:−524, −516, −508, −500:16:−260, −252:16:−12], a fourth subset of subcarrier indices that provide feedback for a fourth 80 MHz subchannel of the 480 MHz channel bandwidth includes [12:16:252, 260:16:500, 508, 516, 524:16:764, 772:16:1012], a fifth subset of subcarrier indices that provide feedback for a fifth 80 MHz subchannel of the 480 MHz channel bandwidth includes [1036:16:1276, 1284:16:1524, 1532, 1540, 1548:16:1788, 1796:16:2036], and a sixth subset of subcarrier indices that provide feedback for a sixth 80 MHz subchannel of the 480 MHz channel bandwidth includes [2060:16:2300, 2308:16:2548, 2556, 2564, 2572:16:2812, 2820:16:3060].

In some examples of the method, apparatus, and non-transitory computer-readable medium described herein, the channel bandwidth may be 640 MHz, the NDPA frame indicates that feedback may be requested in accordance with 996 tone resource units, the grouping value may be 16, a first subset of subcarrier indices that provide feedback for a first 80 MHz subchannel of the 640 MHz channel bandwidth includes [−4084:16:−3844, −3836:16:−3596, −3588, −3580, −3572:16:−3332, −3324:16:−3084], a second subset of subcarrier indices that provide feedback for a second 80 MHz subchannel of the 640 MHz channel bandwidth includes [−3060:16:−2820, −2812:16:−2572, −2564, −2556, −2548:16:−2308, −2300:16:−2060], a third subset of subcarrier indices that provide feedback for a third 80 MHz subchannel of the 640 MHz channel bandwidth includes [−2036:16:−1796, −1788:16:−1548, −1540, −1532, −1524:16:−1284, −1276:16:−1036], a fourth subset of subcarrier indices that provide feedback for a fourth 80 MHz subchannel of the 640 MHz channel bandwidth includes [−1012:16:−772, −764:16:−524, −516, −508, −500:16:−260, −252:16:−12], a fifth subset of subcarrier indices that provide feedback for a fifth 80 MHz subchannel of the 640 MHz channel bandwidth includes [12:16:252, 260:16:500, 508, 516, 524:16:764, 772:16:1012], a sixth subset of subcarrier indices that provide feedback for a sixth 80 MHz subchannel of the 640 MHz channel bandwidth includes [1036:16:1276, 1284:16:1524, 1532, 1540, 1548:16:1788, 1796:16:2036], a seventh subset of subcarrier indices that provide feedback for a seventh 80 MHz subchannel of the 640 MHz channel bandwidth includes [2060:16:2300, 2308:16:2548, 2556, 2564, 2572:16:2812, 2820:16:3060], and an eighth subset of subcarrier indices that provide feedback for an eighth 80 MHz subchannel of the 640 MHz channel bandwidth includes [3084:16:3324, 3332:16:3572, 3580, 3588, 3596:16:3836, 3844:16:4084].

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3a shows an example extremely high throughput (EHT) physical layer (PHY) protocol data unit (PPDU) usable for communications between a wireless AP and one or more wireless STAs.

FIG. 3b shows an example ultra high reliability (UHR) multi-user PPDU usable for communications between a wireless AP or non-AP STA and one or more wireless STAs.

FIG. 3c shows an example UHR sounding null data packet (NDP) usable for communications between a wireless AP or non-AP STA and one or more wireless STAs.

FIG. 4 shows a hierarchical format of an example PPDU usable for communications between a wireless AP and one or more wireless STAs.

FIG. 5 shows an example of a signaling diagram that supports partial bandwidth feedback for 480 and 640 megahertz (MHz) transmission in Wi-Fi.

FIG. 6 shows an example of a process flow that supports partial bandwidth feedback for 480 and 640 MHz transmission in Wi-Fi.

FIGS. 7 and 8 show block diagrams of devices that support partial bandwidth feedback for 480 and 640 MHz transmission in Wi-Fi in accordance with one or more aspects of the present disclosure.

FIG. 9 shows a block diagram of an example wireless communication device that supports partial bandwidth feedback for 480 and 640 MHz transmission in Wi-Fi.

FIGS. 10 and 11 show flowcharts illustrating example processes that support partial bandwidth feedback for 480 and 640 MHz transmission in Wi-Fi.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IOT) network.

Various aspects relate generally to supporting channel feedback in 480 and 640 megahertz (MHz) channel bandwidth in wireless communications. Some aspects more specifically relate to the inclusion of a partial bandwidth information field in a null data packet (NDP) announcement frame that indicates for which frequency portions of the 480 or 640 MHz channel bandwidth to generate channel information feedback. In some examples, the partial bandwidth information field may include a frequency resolution field and a bitmap, and the values and lengths of the frequency resolution field and the bitmap may be based on the channel bandwidth being 480 or 640 MHz. For example, the frequency resolution may be 40 MHz and the feedback bitmap may be 12 bits for a 480 MHz channel bandwidth or 16 bits for a 640 MHz channel bandwidth. As another example, the frequency resolution may be 80 MHz and the feedback bitmap may be 8 bits for a 480 MHz channel bandwidth or 8 bits for a 640 MHz channel bandwidth. A transmitting wireless communications device may transmit an NDP announcement (NDPA) frame and an NDP to a receiving device. The receiving device may generate and transmit to the transmitting device a feedback report (for example, a beamforming report) based on the NDP in accordance with the NDPA frame. The feedback report may indicate channel information (for example, channel matrix information) by subcarrier index. The subcarrier indices which to include in the beamforming report depend on the channel bandwidth, as a larger channel bandwidth (for example, 480 MHz and 640 MHz) includes more subcarriers. Accordingly, new subcarrier indices may be defined for the 480 and 640 MHz bandwidths.

Particular aspects of the subject matter described in this disclosure can be implemented to realize one or more of the following potential advantages. In some examples, by expanding channel bandwidth to 480 or 640 MHz, the described techniques can be used to achieve higher peak throughput as compared to 20, 40, 80, 160, or 320 MHz channel bandwidths. The partial bandwidth information field may be structured to account for the increased bandwidth, and accordingly the increased resource units (RUs), available in a 480 or 640 MHz channel bandwidth, as compared to 20, 40, 80, 160, or 320 MHz channel bandwidths, thereby allowing for channel feedback for 480 and 640 MHz channels. Channel feedback may allow for efficient selection of beamforming parameters, which may allow for more efficient communications between devices.

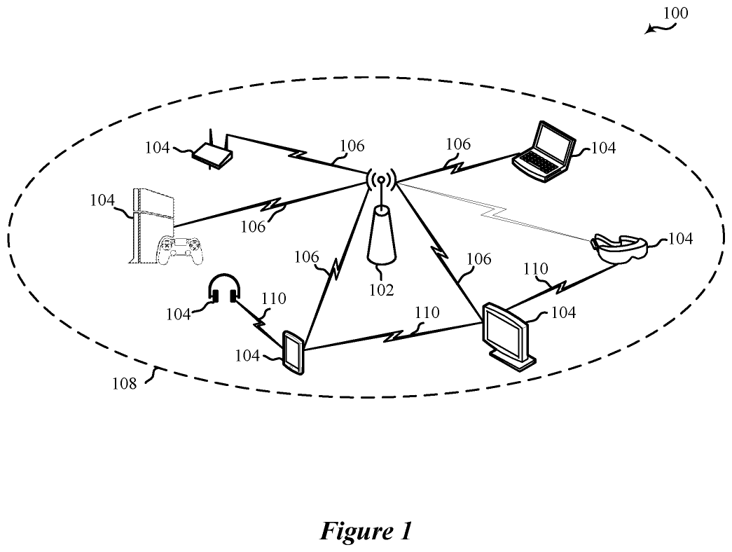

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the WLAN wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

Puncturing is a wireless communication technique that enables a wireless communication device (such as an AP 102 or a STA 104) to transmit and receive wireless communications over a portion of a wireless channel exclusive of one or more particular subchannels (hereinafter also referred to as “punctured subchannels”). Puncturing specifically may be used to exclude one or more subchannels from the transmission of a PPDU, including the signaling of the preamble, to avoid interference from a static source, such as an incumbent system, or to avoid interference of a more dynamic nature such as that associated with transmissions by other wireless communication devices in overlapping BSSs (OBSSs). The transmitting device (such as AP 102 or STA 104) may puncture the subchannels on which there is interference and in essence spread the data of the PPDU to cover the remaining portion of the bandwidth of the channel. For example, if a transmitting device determines (for example, detects, identifies, ascertains, or calculates), in association with a contention operation, that one or more 20 MHz subchannels of a wider bandwidth wireless channel are busy or otherwise not available, the transmitting device implement puncturing to avoid communicating over the unavailable subchannels while still utilizing the remaining portions of the bandwidth. Accordingly, puncturing enables a transmitting device to improve or maximize throughput, and in some instances reduce latency, by utilizing as much of the available spectrum as possible. Static puncturing in particular makes it possible to consistently use wideband channels in environments or deployments where there may be insufficient contiguous spectrum available, such as in the 5 GHz and 6 GHz bands.

In some examples, the AP 102 or the STAs 104 of the wireless communication network 100 may implement Extremely High Throughput (EHT) or other features compliant with current and future generations of the IEEE 802.11 family of wireless communication protocol standards (such as the IEEE 802.11be and 802.11bn standard amendments) to provide additional capabilities over other previous systems (for example, High Efficiency (HE) systems or other legacy systems). For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT and newer wireless communication protocols (such as the protocols referred to as or associated with the IEEE 802.11bn standard amendment) may support flexible operating bandwidth enhancements, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHz, 240 MHz, and 320 MHz. EHT systems may support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT and newer generations of the IEEE 802.11 family of wireless communication protocol standards. For example, the AP 102 or the STA 104 attempting to gain access to the wireless medium of wireless communication network 100 may perform techniques (which may include modifications to existing rules, structure, or signaling implemented for legacy systems) such as clear channel assessment (CCA) operation based on EHT enhancements such as increased bandwidth, puncturing, or refinements to carrier sensing and signal reporting mechanisms.

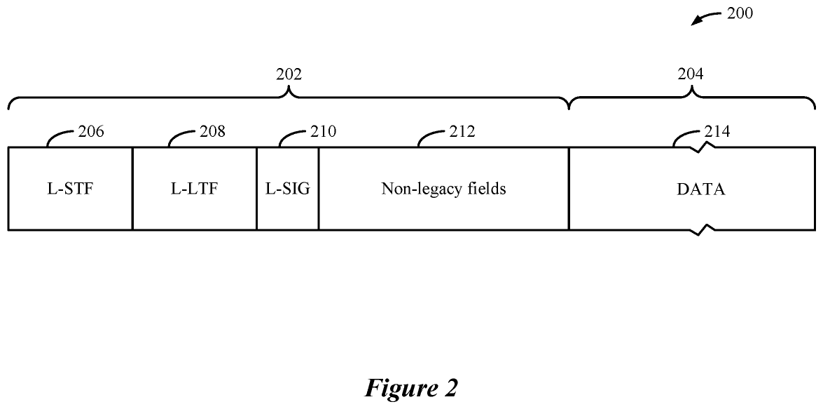

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

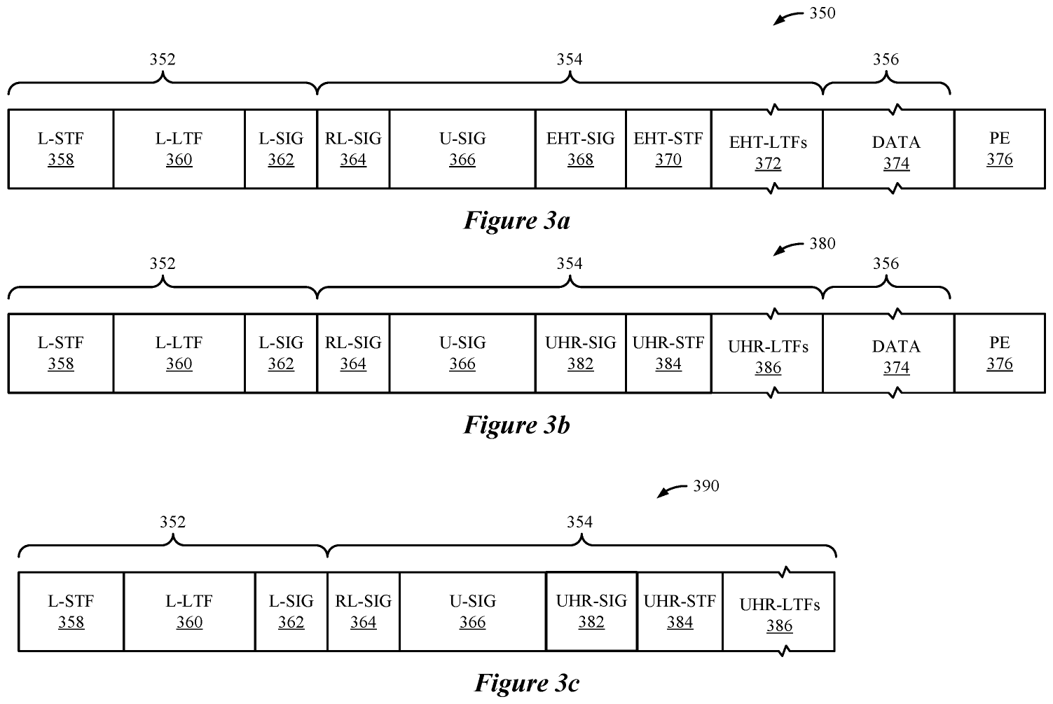

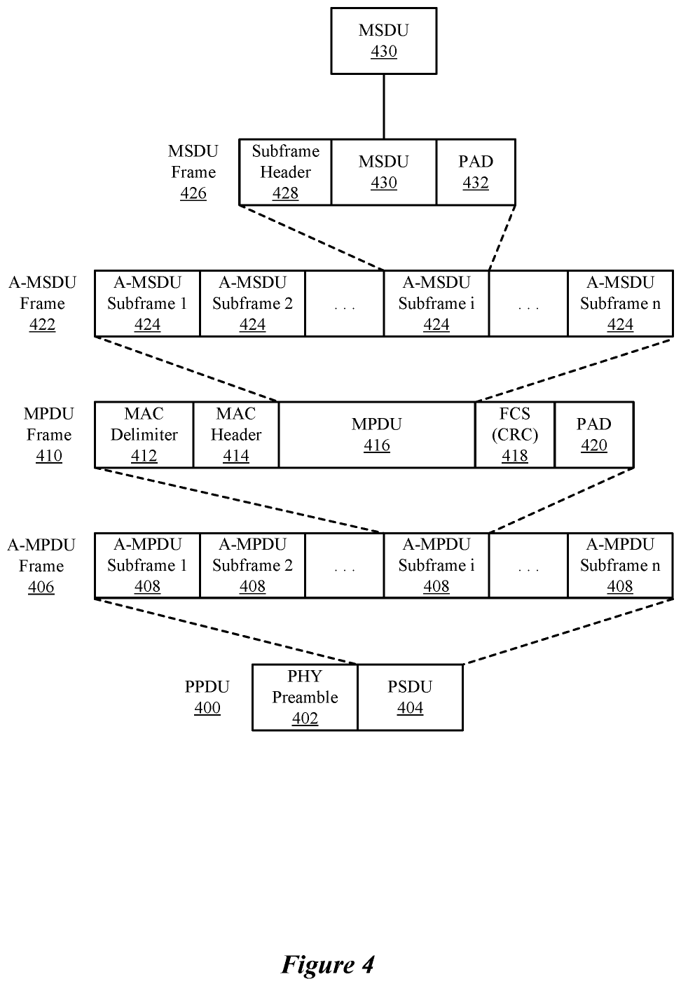

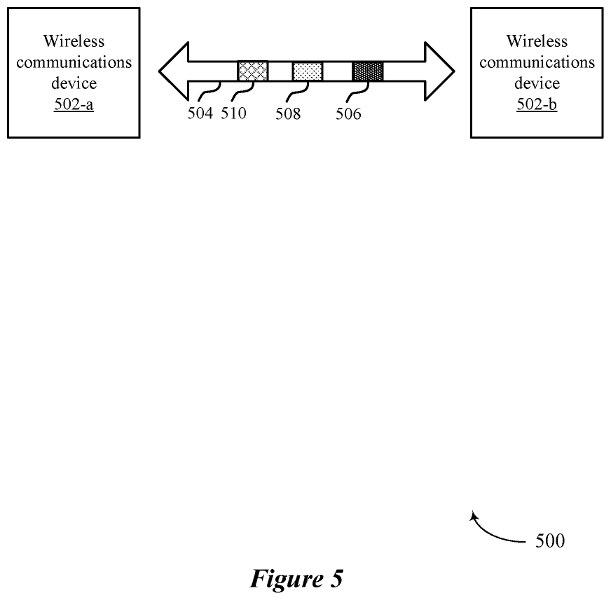

FIG. 3a shows an example physical layer (PHY) protocol data unit (PPDU) 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, a payload 356 that includes a data field 374, and a packet extension 376. The legacy portion 352 of the preamble includes an L-STF 358, an L-LTF 360, and an L-SIG 362. The non-legacy portion 354 of the preamble includes a repetition of L-SIG (RL-SIG) 364 and multiple wireless communication protocol version-dependent signal fields after RL-SIG 364. For example, the non-legacy portion 354 may include a universal signal field 366 (referred to herein as “U-SIG 366”) and an EHT signal field 368 (referred to herein as “EHT-SIG 368”). The presence of RL-SIG 364 and U-SIG 366 may indicate to EHT- or later version-compliant STAs 104 that the PPDU 350 is an EHT PPDU or a PPDU conforming to any later (post-EHT) version of a new wireless communication protocol conforming to a future IEEE 802.11 wireless communication protocol standard. One or both of U-SIG 366 and EHT-SIG 368 may be structured as, and carry version-dependent information for, other wireless communication protocol versions associated with amendments to the IEEE family of standards beyond EHT. For example, U-SIG 366 may be used by a receiving device (such as the AP 102 or the STA 104) to interpret bits in one or more of EHT-SIG 368 or the data field 374. In a 20, 40, or 80 MHz PPDU, the information in U-SIG 366 may be duplicated in every unpunctured 20 MHz subchannels. In 160, 320, 480, or 640 MHz PPDU, the information in U-SIG 366 may be duplicated within the entire 80 MHz frequency subblock, and there may be content variation of U-SIG 366 in different 80 MHz frequency subblocks.

The non-legacy portion 354 further includes an additional short training field 370 (referred to herein as “EHT-STF 370,” although it may be structured as, and carry version-dependent information for, other wireless communication protocol versions beyond EHT) and one or more additional long training fields 372 (referred to herein as “EHT-LTFs 372,” although they may be structured as, and carry version-dependent information for, other wireless communication protocol versions beyond EHT). EHT-STF 370 may be used for timing and frequency tracking and AGC, and EHT-LTF 372 may be used for more refined channel estimation.

EHT-SIG 368 may be used by an AP 102 to identify and inform one or multiple STAs 104 that the AP 102 has scheduled uplink (UL) or downlink (DL) resources for them. EHT-SIG 368 may be decoded by each compatible STA 104 served by the AP 102. EHT-SIG 368 may generally be used by the receiving device to interpret bits in the data field 374. For example, EHT-SIG 368 may include RU allocation information, spatial stream configuration information, and per-user (for example, STA-specific) signaling information. Each EHT-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

FIG. 3b shows an example ultra high reliability (UHR) multi-user PPDU 380 usable for communications between a wireless AP or non-AP STA and one or more wireless STAs. The UHR multi-user PPDU 380 may be the same as the EHT PPDU 350 of FIG. 3a, except in the UHR multi-user PPDU 380, the EHT-SIG 368 is replaced with a UHR signal field 382 (referred to herein as “UHR-SIG 382”), the EHT-STF 370 is replaced with a UHR-STF 384, and the EHT-LTF 372 is replaced with a UHR-LTF 386 in the non-legacy portion 354. In UHR multi-user PPDU 380, one or both of U-SIG 366 and the UHR-SIG 382 may be structured as, and carry version-independent and version-dependent information for, other wireless communication protocol versions associated with amendments to the IEEE family of standards beyond EHT and UHR. For example, U-SIG 366 may be used by a receiving device (such as the AP 102 or the STA 104) to interpret bits in one or more of UHR-SIG 382 or the data field 374. In a 20, 40, or 80 MHz PPDU, the information in U-SIG 366 may be duplicated in every unpunctured 20 MHz subchannels. In 160, 320, 480, or 640 MHz PPDUs, the information in U-SIG 366 may be duplicated within the entire 80 MHz frequency subblock, and there may be content variation of U-SIG 366 in different 80 MHz frequency subblocks. UHR-STF 384 may be used for timing and frequency tracking and AGC, and UHR-LTF 386 may be used for more refined channel estimation.

UHR-SIG 382 may be used by an AP 102 to identify and inform one or multiple STAs 104 that the AP 102 has scheduled uplink or downlink resources for them. UHR-SIG 382 may be decoded by each compatible STA 104 served by the AP 102. UHR-SIG 382 may generally be used by the receiving device to interpret bits in the data field 374. For example, UHR-SIG 382 may include RU allocation information, spatial stream configuration information, and per-user (for example, STA-specific) signaling information. Each UHR-SIG 382 may include a common field and at least one user-specific field. In the context of OFDMA, the common field can indicate RU allocations to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

FIG. 3c shows an example UHR sounding NDP 390 usable for communications between a wireless AP or non-AP STA and one or more wireless STAs. The UHR sounding NDP 390 may be the same as the UHR multi-user PPDU 380, except that the UHR sounding NDP 390 may not include a data field 374 or a packet extension 376.

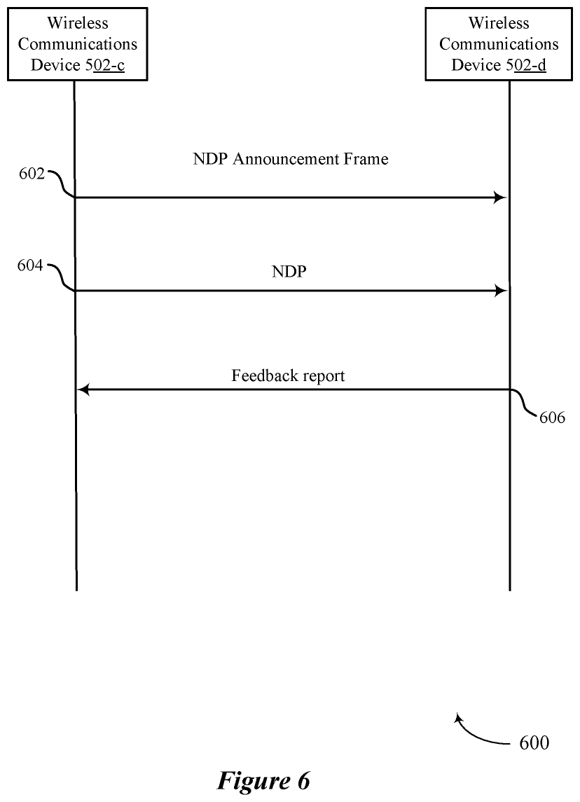

FIG. 4 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 400 includes a PHY preamble 402 and a PSDU 404. Each PSDU 404 may represent (or “carry”) one or more MAC protocol data units (MPDUs) 416. For example, each PSDU 404 may carry an aggregated MPDU (A-MPDU) 406 that includes an aggregation of multiple A-MPDU subframes 408. Each A-MPDU subframe 406 may include an MPDU frame 410 that includes a MAC delimiter 412 and a MAC header 414 prior to the accompanying MPDU 416, which includes the data portion (“payload” or “frame body”) of the MPDU frame 410. Each MPDU frame 410 also may include a frame check sequence (FCS) field 418 for error detection (for example, the FCS field may include a cyclic redundancy check (CRC)) and padding bits 420. The MPDU 416 may carry one or more MAC service data units (MSDUs) 416. For example, the MPDU 416 may carry an aggregated MSDU (A-MSDU) 422 including multiple A-MSDU subframes 424. Each A-MSDU subframe 424 contains a corresponding MSDU 430 preceded by a subframe header 428 and in some cases followed by padding bits 432.

Referring back to the MPDU frame 410, the MAC delimiter 412 may serve as a marker of the start of the associated MPDU 416 and indicate the length of the associated MPDU 416. The MAC header 414 may include multiple fields containing information that defines or indicates characteristics or attributes of data encapsulated within the frame body 416. The MAC header 414 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration, and enables the receiving device to establish its network allocation vector (NAV). The MAC header 414 also includes one or more fields indicating addresses for the data encapsulated within the frame body 416. For example, the MAC header 414 may include a combination of a source address, a transmitter address, a receiver address or a destination address. The MAC header 414 may further include a frame control field containing control information. The frame control field may specify a frame type, for example, a data frame, a control frame, or a management frame.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and then contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (for example, identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is then compared to a threshold to determine (for example, identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (for example, the AP 102 or the STA 104) may contend for access to the wireless medium of WLAN 100 in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

Some APs and STAs (for example, the AP 102 and the STAs 104 described with reference to FIG. 1) may implement spatial reuse techniques. For example, APs 102 and STAs 104 configured for communications using the protocols defined in the IEEE 802.11ax or 802.11be standard amendments may be configured with a BSS color. APs 102 associated with different BSSs may be associated with different BSS colors. A BSS color is a numerical identifier of an AP 102's respective BSS (such as a 6 bit field carried by the SIG field). Each STA 104 may learn its own BSS color upon association with the respective AP 102. BSS color information is communicated at both the PHY and MAC sublayers. If an AP 102 or a STA 104 detects, obtains, selects, or identifies, a wireless packet from another wireless communication device while contending for access, the AP 102 or STA 104 may apply different contention parameters in accordance with whether the wireless packet is transmitted by, or transmitted to, another wireless communication device (such another AP 102 or STA 104) within its BSS or from a wireless communication device from an overlapping BSS (OBSS), as determined, identified, ascertained, or calculated by a BSS color indication in a preamble of the wireless packet. For example, if the BSS color associated with the wireless packet is the same as the BSS color of the AP 102 or STA 104, the AP 102 or STA 104 may use a first RSSI detection threshold when performing a CCA on the wireless channel. However, if the BSS color associated with the wireless packet is different than the BSS color of the AP 102 or STA 104, the AP 102 or STA 104 may use a second RSSI detection threshold in lieu of using the first RSSI detection threshold when performing the CCA on the wireless channel, the second RSSI detection threshold being greater than the first RSSI detection threshold. In this way, the criteria for winning contention are relaxed when interfering transmissions are associated with an OBSS.

Some APs and STAs (for example, the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may then be allocated resources during the TXOP as described above.

Retransmission protocols, such as hybrid automatic repeat request (HARQ), also may offer performance gains. A HARQ protocol may support various HARQ signaling between transmitting and receiving wireless communication devices (for example, the AP 102 and the STAs 104 described with reference to FIG. 1) as well as signaling between the PHY and MAC layers to improve the retransmission operations in a WLAN. HARQ uses a combination of error detection and error correction. For example, a HARQ transmission may include error checking bits that are added to data to be transmitted using an error-detecting (ED) code, such as a cyclic redundancy check (CRC). The error checking bits may be used by the receiving device to determine if it has properly decoded the received HARQ transmission. In some examples, the original data (information bits) to be transmitted may be encoded with a forward error correction (FEC) code, such as using a low-density parity check (LDPC) coding scheme that systematically encodes the information bits to produce parity bits. The transmitting device may transmit both the original information bits as well as the parity bits in the HARQ transmission to the receiving device. The receiving device may be able to use the parity bits to correct errors in the information bits, thus avoiding a retransmission.

Implementing a HARQ protocol in a WLAN may improve reliability of data communicated from a transmitting device to a receiving device. The HARQ protocol may support the establishment of a HARQ session between the two devices. Once a HARQ session is established, if a receiving device cannot properly decode (and cannot correct the errors) a first HARQ transmission received from the transmitting device, the receiving device may transmit a HARQ feedback message to the transmitting device (for example, a negative acknowledgement (NACK)) that indicates at least part of the first HARQ transmission was not properly decoded. Such a HARQ feedback message may be different than the traditional Block ACK feedback message type associated with conventional ARQ. In response to receiving the HARQ feedback message, the transmitting device may transmit a second HARQ transmission to the receiving device to communicate at least part of further assist the receiving device in decoding the first HARQ transmission. For example, the transmitting device may include some or all of the original information bits, some or all of the original parity bits, as well as other, different parity bits in the second HARQ transmission. The combined HARQ transmissions may be processed for decoding and error correction such that the complete signal associated with the HARQ transmissions can be obtained.

In some examples, the receiving device may be enabled to control whether to continue the HARQ process or revert to a non-HARQ retransmission scheme (such as an automatic repeat request (ARQ) protocol). Such switching may reduce feedback overhead and increase the flexibility for retransmissions by allowing devices to dynamically switch between ARQ and HARQ protocols during frame exchanges. Some implementations also may allow multiplexing of communications that employ ARQ with those that employ HARQ.

APs and STAs (for example, the AP 102 and the STAs 104 described with reference to FIG. 1) that include multiple antennas may support various diversity schemes. For example, spatial diversity may be used by one or both of a transmitting device (such as either an AP 102 or a STA 104) or a receiving device (such as either an AP 102 or a STA 104) to increase the robustness of a transmission. For example, to implement a transmit diversity scheme, a transmitting device may transmit the same data redundantly over two or more antennas.

APs 102 and STAs 104 that include multiple antennas also may support space-time block coding (STBC). With STBC, a transmitting device also transmits multiple copies of a data stream across multiple antennas to exploit the various received versions of the data to increase the likelihood of decoding the correct data. More specifically, the data stream to be transmitted is encoded in blocks, which are distributed among the spaced antennas and across time. Generally, STBC can be used when the number N_{Tx} of transmit antennas exceeds the number N_{SS} of spatial streams. The N_{SS} spatial streams may be mapped to a number N_{STS} of space-time streams, which are then mapped to N_{Tx} transmit chains.

APs 102 and STAs 104 that include multiple antennas also may support spatial multiplexing, which may be used to increase the spectral efficiency and the resultant throughput of a transmission. To implement spatial multiplexing, the transmitting device divides the data stream into a number N_{SS} of separate, independent spatial streams. The spatial streams are then separately encoded and transmitted in parallel via the multiple N_{Tx} transmit antennas.

APs 102 and STAs 104 that include multiple antennas also may support beamforming. Beamforming generally refers to the steering of the energy of a transmission in the direction of a target receiver. Beamforming may be used both in a single-user (SU) context, for example, to improve a signal-to-noise ratio (SNR), as well as in a multi-user (MU) context, for example, to enable MU-MIMO transmissions (also referred to as spatial division multiple access (SDMA)). In the MU-MIMO context, beamforming may additionally or alternatively involve the nulling out of energy in the directions of other receiving devices. To perform SU beamforming or MU-MIMO, a transmitting device, referred to as the beamformer, transmits a signal from each of multiple antennas. The beamformer configures the amplitudes and phase shifts between the signals transmitted from the different antennas such that the signals add constructively along particular directions towards the intended receiver (referred to as the beamformee) or add destructively in other directions towards other devices to mitigate interference in a MU-MIMO context. The manner in which the beamformer configures the amplitudes and phase shifts depends on channel state information (CSI) associated with the wireless channels over which the beamformer intends to communicate with the beamformee.

To obtain the CSI necessary for beamforming, the beamformer may perform a channel sounding procedure with the beamformee. For example, the beamformer may transmit one or more sounding signals (for example, in the form of an NDP) to the beamformee. An NDP is a PPDU without any data field. The beamformee may then perform measurements for each of the N_{Tx}×N_{Rx} sub-channels corresponding to all of the transmit antenna and receive antenna pairs associated with the sounding signal. The beamformee generates a feedback matrix associated with the channel measurements and, typically, compresses the feedback matrix before transmitting the feedback to the beamformer. The beamformer may then generate a precoding (or “steering”) matrix for the beamformee associated with the feedback and use the steering matrix to precode the data streams to configure the amplitudes and phase shifts for subsequent transmissions to the beamformee. The beamformer may use the steering matrix to determine (for example, identify, detect, ascertain, calculate, or compute) how to transmit a signal on each of its antennas to perform beamforming. For example, the steering matrix may be indicative of a phase shift, power level, etc. to use to transmit a respective signal on each of the beamformer's antennas.

When performing beamforming, the transmitting beamforming array gain is logarithmically proportional to the ratio of N_{Tx} to N_{SS}. As such, it is generally desirable, within other constraints, to increase the number N_{Tx} of transmit antennas when performing beamforming to increase the gain. It is also possible to more accurately direct transmissions or nulls by increasing the number of transmit antennas. This is especially advantageous in MU transmission contexts in which it is particularly important to reduce inter-user interference.

To increase an AP 102's spatial multiplexing capability, an AP 102 may need to support an increased number of spatial streams (such as up to 16 spatial streams). However, supporting additional spatial streams may result in increased CSI feedback overhead. Implicit CSI acquisition techniques may avoid CSI feedback overhead by taking advantage of the assumption that the UL and DL channels have reciprocal impulse responses (that is, that there is channel reciprocity). For example, the CSI feedback overhead may be reduced using an implicit channel sounding procedure such as an implicit beamforming report (BFR) technique (such as where STAs 104 transmit NDP sounding packets in the UL while the AP 102 measures the channel) because no BFRs are sent. Once the AP 102 receives the NDPs, it may implicitly assess the channels for each of the STAs 104 and use the channel assessments to configure steering matrices. In order to mitigate hardware mismatches that could break the channel reciprocity on the UL and DL (such as the baseband-to-RF and RF-to-baseband chains not being reciprocal), the AP 102 may implement a calibration method to compensate for the mismatch between the UL and the DL channels. For example, the AP 102 may select a reference antenna, transmit a pilot signal from each of its antennas, and estimate baseband-to-RF gain for each of the non-reference antennas relative to the reference antenna.

In some examples, multiple APs 102 may simultaneously transmit signaling or communications to a single STA 104 utilizing a distributed MU-MIMO scheme. Examples of such a distributed MU-MIMO transmission include coordinated beamforming (CBF) and joint transmission (JT). With CBF, signals (such as data streams) for a given STA 104 may be transmitted by only a single AP 102. However, the coverage areas of neighboring APs may overlap, and signals transmitted by a given AP 102 may reach the STAs in OBSSs associated with neighboring APs as OBSS signals. CBF allows multiple neighboring APs to transmit simultaneously while minimizing or avoiding interference, which may result in more opportunities for spatial reuse. More specifically, using CBF techniques, an AP 102 may beamform signals to in-BSS STAs 104 while forming nulls in the directions of STAs in OBSSs such that any signals received at an OBSS STA are of sufficiently low power to limit the interference at the STA. To accomplish this, an inter-BSS coordination set may be defined between the neighboring APs, which contains identifiers of all APs and STAs participating in CBF transmissions.

With JT, signals for a given STA 104 may be transmitted by multiple coordinated APs 102. For the multiple APs 102 to concurrently transmit data to a STA 104, the multiple APs 102 may all need a copy of the data to be transmitted to the STA 104. Accordingly, the APs 102 may need to exchange the data among each other for transmission to a STA 104. With JT, the combination of antennas of the multiple APs 102 transmitting to one or more STAs 104 may be considered as one large antenna array (which may be represented as a virtual antenna array) used for beamforming and transmitting signals. In combination with MU-MIMO techniques, the multiple antennas of the multiple APs 102 may be able to transmit data via multiple spatial streams. Accordingly, each STA 104 may receive data via one or more of the multiple spatial streams.

In some implementations, the AP 102 and STAs 104 can support various multi-user communications; that is, concurrent transmissions from one device to each of multiple devices (for example, multiple simultaneous downlink communications from an AP 102 to corresponding STAs 104), or concurrent transmissions from multiple devices to a single device (for example, multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple RUs each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

In some wireless communications systems, an AP 102 may allocate or assign multiple RUs to a single STA104 in an OFDMA transmission (hereinafter also referred to as “multi-RU aggregation”). Multi-RU aggregation, which facilitates puncturing and scheduling flexibility, may ultimately reduce latency. As increasing bandwidth is supported by emerging standards (such as the IEEE 802.11be standard amendment supporting 320 MHz and the IEEE 802.11bn standard amendment supporting 480 MHz and 640 MHz), various multiple RU (multi-RU) combinations may exist. Values indicating the various multi-RU combinations may be provided by a suitable standard specification (such as one or more of the IEEE 802.11 family of wireless communication protocol standards including the 802.11be standard amendment).

As Wi-Fi is not the only technology operating in the 6 GHz band, the use of multiple RUs in conjunction with channel puncturing may enable the use of large bandwidths such that high throughput is possible while avoiding transmitting on frequencies that are locally unauthorized due to incumbent operation. Puncturing may be used in conjunction with multi-RU transmissions to enable wide channels to be established using non-contiguous spectrum blocks. In such examples, the portion of the bandwidth between two RUs allocated to a particular STA 104 may be punctured. Accordingly, spectrum efficiency and flexibility may be increased.

As described previously, STA-specific RU allocation information may be included in a signaling field (such as the EHT-SIG field for an EHT PPDU) of the PPDU's preamble. Preamble puncturing may enable wider bandwidth transmissions for increased throughput and spectral efficiency in the presence of interference from incumbent technologies and other wireless communication devices. Because RUs may be individually allocated in a MU PPDU, use of the MU PPDU format may indicate preamble puncturing for SU transmissions. While puncturing in the IEEE 802.11ax standard amendment was limited to OFDMA transmissions, the IEEE 802.11be standard amendment extended puncturing to SU transmissions. In some examples, the RU allocation information in the common field of EHT-SIG can be used to individually allocate RUs to the single user, thereby avoiding the punctured channels. In some other examples, U-SIG may be used to indicate SU preamble puncturing. For example, the SU preamble puncturing may be indicated by a value of the EHT-SIG compression field in U-SIG.

In some environments, locations, or conditions, a regulatory body may impose a power spectral density (PSD) limit for one or more communication channels or for an entire band (for example, the 6 GHz band). A PSD is a measure of transmit power as a function of a unit bandwidth (such as per 1 MHz). The total transmit power of a transmission is consequently the product of the PSD and the total bandwidth by which the transmission is sent. Unlike the 2.4 GHz and 5 GHz bands, the United States Federal Communications Commission (FCC) has established PSD limits for low power devices when operating in the 6 GHz band. The FCC has defined three power classes for operation in the 6 GHz band: standard power, low power indoor, and very low power. Some APs 102 and STAs 104 that operate in the 6 GHz band may conform to the low power indoor (LPI) power class, which limits the transmit power of APs 102 and STAs 104 to 5 decibel-milliwatts per megahertz (dBm/MHz) and −1 dBm/MHz, respectively. In other words, transmit power in the 6 GHz band is PSD-limited on a per-MHz basis.

Such PSD limits can undesirably reduce transmission ranges, reduce packet detection capabilities, and reduce channel estimation capabilities of APs 102 and STAs 104. In some examples in which transmissions are subject to a PSD limit, the AP 102 or the STAs 104 of the wireless communication network WLAN 100 may transmit over a greater transmission bandwidth to allow for an increase in the total transmit power, which may increase an SNR and extend coverage of the wireless communication devices. For example, to overcome or extend the PSD limit and improve SNR for low power devices operating in PSD-limited bands, 802.11be introduced a duplicate (DUP) mode for a transmission, by which data in a payload portion of a PPDU is modulated for transmission over a “base” frequency sub-band, such as a first RU of an OFDMA transmission, and copied over (for example, duplicated) to another frequency sub-band, such as a second RU of the OFDMA transmission. In DUP mode, two copies of the data are to be transmitted, and, for each of the duplicate RUs, using dual carrier modulation (DCM), which also has the effect of copying the data such that two copies of the data are carried by each of the duplicate RUs, so that, for example, four copies of the data are transmitted. While the data rate for transmission of each copy of the user data using the DUP mode may be the same as a data rate for a transmission using a “normal” mode, the transmit power for the transmission using the DUP mode may be essentially multiplied by the number of copies of the data being transmitted, at the expense of requiring an increased bandwidth. As such, using the DUP mode may extend range but reduce spectrum efficiency.

In some other examples in which transmissions are subject to a PSD limit, a distributed tone mapping operation may be used to increase the bandwidth via which a STA 104 transmits an uplink communication to the AP 102. As used herein, the term “distributed transmission” refers to a PPDU transmission on noncontiguous tones (or subcarriers) of a wireless channel. In contrast, the term “contiguous transmission” refers to a PPDU transmission on contiguous tones. As used herein, a logical RU represents a number of tones or subcarriers that are allocated to a given STA 104 for transmission of a PPDU. As used herein, the term “regular RU” (or rRU) refers to any RU or MRU tone plan that is not distributed, such as a configuration supported by 802.11be or earlier versions of the IEEE 802.11 family of wireless communication protocol standards. As used herein, the term “distributed RU” (or dRU) refers to the tones distributed across a set of noncontiguous subcarrier indices to which a logical RU is mapped. The term “distributed tone plan” refers to the set of noncontiguous subcarrier indices associated with a dRU. The channel or portion of a channel within which the distributed tones are interspersed is referred to as a spreading bandwidth, which may be, for example, 40 MHz, 80 MHz or more. The use of dRUs may be limited to uplink communications because benefits to addressing PSD limits may only be present for uplink communications.

As described herein, some wireless communications systems may support 480 MHz and/or 640 MHz PPDUs. A receiving device (for example, a STA 104) may perform channel estimation on an NDP and transmit a beamforming report to the transmitting device (for example, an AP 102) based on the NDP. The transmitting device may select beams for transmissions of PPDUs to the receiving device based on the beamforming report. The transmitting device may schedule the NDP using an NDPA frame which includes a partial bandwidth information field. The partial bandwidth information field may include a bitmap that indicates for which portions of the channel bandwidth the receiving device is to generate feedback.

The partial bandwidth information field in the NDPA frame includes a frequency resolution field and a bitmap with values and lengths based on the channel bandwidth being 480 or 640 MHz. For example, the frequency resolution may be 40 MHz and the feedback bitmap may be 12 bits for a 480 MHz channel bandwidth or 16 bits for a 640 MHz channel bandwidth. As another example, the frequency resolution may be 80 MHz and the feedback bitmap may be 8 bits for a 480 MHz channel bandwidth (where only the first 6 bits are used for the feedback bitmap for a 480 MHz channel bandwidth) or 8 bits for a 640 MHz channel bandwidth. The beamforming report indicates channel information (for example, channel matrix information) by subcarrier index. The subcarrier indices which to include in the beamforming report depend on the channel bandwidth, as a larger channel bandwidth (for example, 480 MHz and 640 MHz) includes more subcarriers. Accordingly, standards may be updated to indicate the subcarrier indices to include in the beamforming report for 480 MHz and 640 MHz channel bandwidths, depending on additional factors such as an indicated grouping factor (Ng, indicated in the NDPA frame), and whether the feedback bitmap requests feedback for each bit of the feedback bitmap.

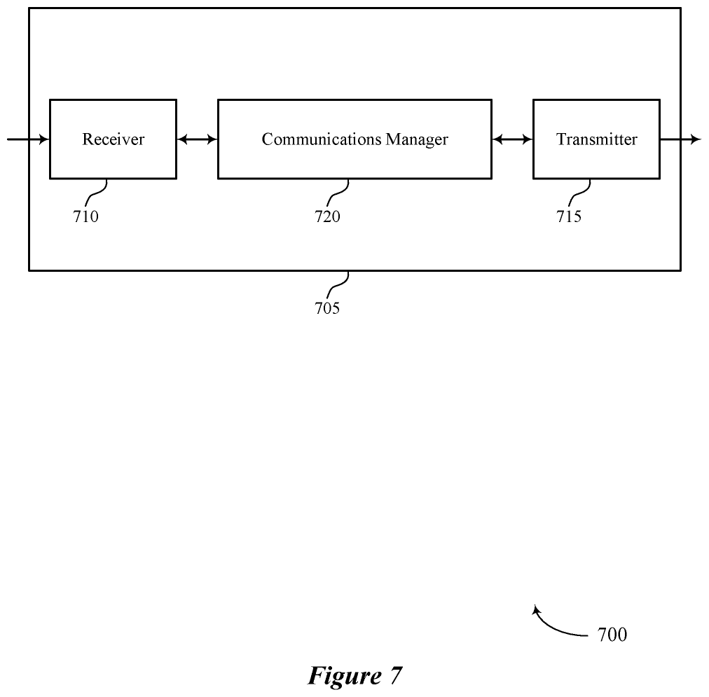

FIG. 5 shows an example of a signaling diagram 500 that supports partial bandwidth feedback for 480 and 640 MHz transmission in Wi-Fi. The signaling diagram 500 may implement or may be implemented by aspects of the wireless communication network 100. For example, the signaling diagram 500 includes a first wireless communications device 502-a and a second wireless communications device 502-b, which may be examples of APs 102 or an STAs 104 as described herein. The first wireless communications device 502-a may communicate with the second wireless communications device 502-b via a wireless link 504, which may be an example of a communication link 106 described herein.

The first wireless communications device 502-a may transmit an NDPA frame 506 which schedules an NDP 508. For example, the NDP 508 may be a UHR sounding NDP 390 of FIG. 3c. The first wireless communications device 502-a may transmit the NDP 508 in accordance with the NDPA frame 506. The second wireless communications device 502-b may perform channel estimation on the NDP 508 and transmit a feedback report 510 to the first wireless communications device 502-a based on the NDP 508. For example, the feedback report 510 may include a beamforming report. The first wireless communications device 502-a may select beams for transmissions of PPDUs to the second wireless communications device 502-b based on the feedback report 510.

The NDPA frame 506 may include a partial bandwidth information field which indicates for which portions of the channel bandwidth of the NDP 508 to generate feedback. For example, the partial bandwidth information field may include a multi bit field which includes a first set of bits that indicates a frequency resolution and a second set of bits corresponding to a bitmap for the portions corresponding to the resolution of the channel bandwidth. In some examples, the NDPA frame 506 may include a bandwidth field which indicates the bandwidth of the NDP 508. For example, the bandwidth field may indicate, the bandwidth of the NDP 508 is 20, 40, 80, 160, 320, 480, or 640 MHz.

For example, in IEEE 802.11be, the partial bandwidth information field may be a 9 bit field, where the resolution bit is the first bit (B0) and indicates either a 20 MHz or 40 MHz resolution and the second through ninth bits (B1-B8) indicate a feedback bitmap of the corresponding resolution. For example, when the PPDU carrying an EHT NDPA frame is 20, 40, 80, or 160 MHz, B0 may be set to “0” to indicate a 20 MHz resolution. As another example, when the PPDU carrying an EHT NDPA frame is 320 MHz, B0 may be set to “1” to indicate a 40 MHz resolution.

In some examples, the signaling diagram 500 may UHR, which may also be referred to as IEEE 802.11bn. UHR may support 480 and/or 640 MHz channel bandwidths.

In some examples, where a 480 MHz channel bandwidth is defined, the partial bandwidth information field may be expanded to 13 bits, the frequency resolution bit is the first bit (B0), and B1-B12 is the feedback bitmap. For a 480 MHz channel bandwidth, B0 may be set to “1” to indicate 40 MHz resolution, and accordingly the 12 bits of the feedback bitmap from B1 to B12 correspond to 12 distinct and non-overlapping 40 MHz portions of the 480 MHz channel bandwidth from lowest to highest frequency. For example, if the frequency resolution is set to 40 MHz, B1 is set to “0”, and B2-B12 are set to “1,” the partial bandwidth information field requests no feedback for the first 40 MHz portion of the 480 MHz channel bandwidth and feedback for the remaining 440 MHz. As another example, if the frequency resolution is set to 40 MHz, B2 and B3 are set to “0”, and B1 and B4-B12 are set to “1,” the partial bandwidth information field requests no feedback for the second and third 40 MHz portions of the 480 MHz channel bandwidth and feedback for the first and fourth through twelfth 40 MHz portions of the 480 MHz channel bandwidth. Accordingly, the frequency resolution and the feedback bitmap may be used to indicate for which frequency portions of the channel bandwidth to generate and report feedback. For 20, 40, 80, 160, and 320 MHz channel bandwidths, the resolution bit (B0) may indicate a different value and/or some bits of the feedback bitmap may be unused.

In some examples, where a 480 MHz channel bandwidth is defined, the partial bandwidth information field may be expanded to 10 bits, and the frequency resolution may be indicated by two bits (for example, B0 and B1). For example, B0 and B1 may indicate whether the frequency resolution is 20 MHz, 40 MHz, or 80 MHz, and B2-B9 may be an 8 bit feedback bitmap. For a 480 MHz channel bandwidth, the frequency resolution bits (B0 and B1) may indicate that the frequency resolution is 80 bits, and 6 bits of the feedback bitmap (for example, from B2 to B7) may correspond to 6 distinct and non-overlapping 80 MHz portions of the 480 MHz channel bandwidth from lowest to highest frequency. For 20, 40, 80, 160, and 320 MHz channel bandwidths, the frequency resolution bits (B0 and B1) may indicate a different value and/or some bits of the feedback bitmap may be unused.

In some examples, where a 640 MHz channel bandwidth is defined, the partial bandwidth information field may be expanded to 17 bits, the frequency resolution bit is the first bit (B0), and B1-B16 is the feedback bitmap. For a 640 MHz channel bandwidth, B0 may be set to “1” to indicate 40 MHz resolution, and accordingly the 16 bits of the feedback bitmap from B1 to B16 correspond to 16 distinct and non-overlapping 40 MHz portions of the 480 MHz channel bandwidth from lowest to highest frequency. For 20, 40, 80, 160, and 320 MHz channel bandwidths, the resolution bit (B0) may indicate a different value and/or some bits of the feedback bitmap may be unused.

In some examples, where a 640 MHz channel bandwidth is defined, the partial bandwidth information field may be expanded to 10 bits, and the frequency resolution may be indicated by two bits (for example, B0 and B1). For example, B0 and B1 may indicate whether the frequency resolution is 20 MHz, 40 MHz, or 80 MHz, and B2-B9 may be an 8 bit feedback bitmap. For a 640 MHz channel bandwidth, the frequency resolution bits (B0 and B1) may indicate that the frequency resolution is 80 bits, and 8 bits of the feedback bitmap (for example, B2 through B9) may correspond to 8 distinct and non-overlapping 80 MHz portions of the 640 MHz channel bandwidth from lowest to highest frequency. For 20, 40, 80, 160, and 320 MHz channel bandwidths, the frequency resolution bits (B0 and B1) may indicate a different value and/or some bits of the feedback bitmap may be unused.

The feedback report 510 may include average SNR information of each spatial stream and compressed beamforming feedback matrices V for use by the first wireless communications device 502-a to determine steering matrices (for example, to determine beam(s) for communication with the second wireless communications device 502-b). The feedback report 510 may include channel matrix elements indexed first by matrix angles (for example, order of angles in the compressed beamforming feedback matrix when used in a non-S1G band), and second, by data and pilot subcarrier index from the lowest frequency to the highest frequency (in case of multiple RUs (MRUs) the lowest frequency stands for the lowest frequency of first RU and the highest frequency stands for the highest frequency of the last RU) as shown in Tables 1, 2, and 3.

TABLE 1

| 242-tone | | | | | |
|---|---|---|---|---|---|
| RU index | 20 MHz | | 40 MHz | 80 MHz | 160 MHz |
| 1 | Ng = 4 | [−122, −120:4:−4, −2, | [−244:Ng:−4] | [−500:Ng:−260] | [−1012:Ng:−772] |
| | | 2, 4:4:120, 122] | | | |
| | Ng = 16 | [−122, −116:16:−4, −2, | | | |
| | | 2, 4:16:116, 122] | | | |
| 2 | | | [4:Ng:244] | [−252:Ng:−12] | [−764:Ng:−524] |
| 3 | | | | [12:Ng:252] | [−500:Ng:−260] |
| 4 | | | | [260:Ng:500] | [−252:Ng:−12] |
| 5 | | | | | [12:Ng:252] |
| 6 | | | | | [260:Ng:500] |
| 7 | | | | | [524:Ng:764] |
| 8 | | | | | [772:Ng:1012] |
| 9 | | | | | |
| 10 | | | | | |
| 11 | | | | | |
| 12 | | | | | |
| 13 | | | | | |
| 14 | | | | | |
| 15 | | | | | |
| 16 | | | | | |
| 17 | | | | | |
| 18 | | | | | |
| 19 | | | | | |
| 20 | | | | | |
| 21 | | | | | |
| 22 | | | | | |
| 23 | | | | | |
| 24 | | | | | |
| 25 | | | | | |
| 26 | | | | | |
| 27 | | | | | |
| 28 | | | | | |
| 29 | | | | | |
| 30 | | | | | |
| 31 | | | | | |
| 32 | | | | | |

| 242-tone | | | |
|---|---|---|---|
| RU index | 320 MHz | 480 MHz | 640 MHz |
| 1 | [−2036:Ng:−1796] | [−3060:Ng:−2820] | [−4084:Ng:−3844] |
| 2 | [−1788:Ng:−1548] | [−2812:Ng:−2572] | [−3836:Ng:−3596] |
| 3 | [−1524:Ng:−1284] | [−2548:Ng:−2308] | [−3572:Ng:−3332] |
| 4 | [−1276:Ng:−1036] | [−2300:Ng:−2060] | [−3324:Ng:−3084] |
| 5 | [−1012:Ng:−772] | [−2036:Ng:−1796] | [−3060:Ng:−2820] |
| 6 | [−764:Ng:−524] | [−1788:Ng:−1548] | [−2812:Ng:−2572] |
| 7 | [−500:Ng:−260] | [−1524:Ng:−1284] | [−2548:Ng:−2308] |
| 8 | [−252:Ng:−12] | [−1276:Ng:−1036] | [−2300:Ng:−2060] |
| 9 | [12:Ng:252] | [−1012:Ng:−772] | [−2036:Ng:−1796] |
| 10 | [260:Ng:500] | [−764:Ng:−524] | [−1788:Ng:−1548] |
| 11 | [524:Ng:764] | [−500:Ng:−260] | [−1524:Ng:−1284] |
| 12 | [772:Ng:1012] | [−252:Ng:−12] | [−1276:Ng:−1036] |
| 13 | [1036:Ng:1276] | [12:Ng:252] | [−1012:Ng:−772] |
| 14 | [1284:Ng:1524] | [260:Ng:500] | [−764:Ng:−524] |
| 15 | [1548:Ng:1788] | [524:Ng:764] | [−500:Ng:−260] |
| 16 | [1796:Ng:2036] | [772:Ng:1012] | [−252:Ng:−12] |
| 17 | | [1036:Ng:1276] | [12:Ng:252] |
| 18 | | [1284:Ng:1524] | [260:Ng:500] |
| 19 | | [1548:Ng:1788] | [524:Ng:764] |
| 20 | | [1796:Ng:2036] | [772:Ng:1012] |
| 21 | | [2060:Ng:2300] | [1036:Ng:1276] |
| 22 | | [2308:Ng:2548] | [1284:Ng:1524] |
| 23 | | [2572:Ng:2812] | [1548:Ng:1788] |
| 24 | | [2820:Ng:3060] | [1796:Ng:2036] |
| 25 | | | [2060:Ng:2300] |
| 26 | | | [2308:Ng:2548] |
| 27 | | | [2572:Ng:2812] |
| 28 | | | [2820:Ng:3060] |
| 29 | | | [3084:Ng:3324] |
| 30 | | | [3332:Ng:3572] |
| 31 | | | [3596:Ng:3836] |
| 32 | | | [3844:Ng:4084] |

TABLE 2

| 996-tone | | 160 | | | |
|---|---|---|---|---|---|
| RU index | 80 MHz | MHz | 320 MHz | 480 MHz | 640 MHz |
| 1 | [−500: | [−1012:4: | [−2036:4: | [−3060:4: | [−4084:4: |
| | 4:−4, | −516, | −1540, | −2564, | −3588, |
| | 4:4:500] | −508: | −1532:4: | −2556:4: | −3580:4: |
| | | 4:−12] | −1036] | −2060] | −3084] |
| 2 | | [12:4: | [−1012:4: | [−2036:4: | [−3060:4: |
| | | 508, | −516, | −1540, | −2564, |
| | | 516:4: | −508:4: | −1532:4: | −2556:4: |
| | | 1012] | −12] | −1036] | −2060] |
| 3 | | | [12:4:508, | [−1012:4: | [−2036:4: |
| | | | 516:4: | −516, | −1540, |
| | | | 1012] | −508:4:−12] | −1532:4: |
| | | | | | −1036] |
| 4 | | | [1036:4: | [12:4:508, | [−1012:4: |
| | | | 1532, | 516:4:1012] | −516, |
| | | | 1540:4: | | −508:4:−12] |
| | | | 2036] | | |
| 5 | | | | [1036:4:1532, | [12:4:508, |
| | | | | 1540:4:2036] | 516:4:1012] |
| 6 | | | | [2060:4:2556, | [1036:4:1532, |
| | | | | 2564:4:3060] | 1540:4:2036] |
| 7 | | | | | [2060:4:2556, |
| | | | | | 2564:4:3060] |
| 8 | | | | | [3084:4:3580, |
| | | | | | 3588:4:4084] |

TABLE 3

| 996- | | | | | |
|---|---|---|---|---|---|
| tone | | | | | |
| RU | | | | | |
| index | 80 MHz | 160 MHz | 320 MHz | 480 MHz | 640 MHz |
| 1 | [−500: | [−1012: | [−2036:16: | [−3060:16: | [−4084:16: |
| | 16:− | 16:−772, | −1796, | −2820, | −3844, |
| | 260, | −764:16: | −1788:16: | −2812:16: | −3836:16: |
| | 252:16: | −524, | −1548, | −2572, | −3596, |
| | −12, | −516, | −1540, | −2564, | −3588, −3580, |
| | −4, 4, | −508, | −1532, | −2556, | −3572:16: |
| | 12:16: | −500:16: | −1524:16: | −2548:16: | −3332, |
| | 252, | −260, | −1284, | −2308, | −3324:16: |
| | 260:16: | −252:16: | −1276:16: | −2300:16: | −3084] |
| | 500] | −12] | −1036] | −2060] | |
| 2 | | [12:16: | [−1012:16: | [−2036:16: | [−3060:16: |
| | | 252, | −772, | −1796, | −2820, |
| | | 260:16: | −764:16: | −1788:16: | −2812:16: |
| | | 500, | −524, | −1548, | −2572, |
| | | 508, 516, | −516, −508, | −1540, | −2564, −2556, |
| | | 524:16: | −500:16: | −1532, | −2548:16: |
| | | 764, | −260, | −1524:16: | −2308, |
| | | 772: | −252: | −1284, | −2300:16: |
| | | 16:1012] | 16:−12] | −1276:16: | −2060] |
| | | | | −1036] | |
| 3 | | | [12:16:252, | [−1012:16: | [−2036:16: |
| | | | 260:16:500, | −772, | −1796, |
| | | | 508, 516, | −764:16: | −1788:16: |
| | | | 524:16:764, | −524, | −1548, |
| | | | 772: | −516, −508, | −1540, |
| | | | 16:1012] | −500:16: | −1532, |
| | | | | −260, | −1524:16: |
| | | | | −252:16: | −1284, |
| | | | | −12] | −1276:16: |
| | | | | | −1036] |
| 4 | | | [1036:16: | [12:16:252, | [−1012:16: |
| | | | 1276, | 260:16:500, | −772, |
| | | | 1284:16: | 508, 516, | −764:16: |
| | | | 1524, | 524:16:764, | −524, |
| | | | 1532, 1540, | 772:16:1012] | −516, −508, |
| | | | 1548:16: | | −500:16: |
| | | | 1788, | | −260, |
| | | | 1796:16: | | −252:16:−12] |
| | | | 2036] | | |
| 5 | | | | [1036:16: | [12:16:252, |
| | | | | 1276, | 260:16:500, |
| | | | | 1284:16: | 508, 516, |
| | | | | 1524, | 524:16:764, |
| | | | | 1532, 1540, | 772:16:1012] |
| | | | | 1548:16: | |
| | | | | 1788, | |
| | | | | 1796:16: | |
| | | | | 2036] | |
| 6 | | | | [2060:16: | [1036:16: |
| | | | | 2300, | 1276, |
| | | | | 2308:16: | 1284:16: |
| | | | | 2548, | 1524, |
| | | | | 2556, 2564, | 1532, 1540, |
| | | | | 2572:16: | 1548:16: |
| | | | | 2812, | 1788, |
| | | | | 2820:16: | 1796:16:2036] |
| | | | | 3060] | |
| 7 | | | | | [2060:16: |
| | | | | | 2300, |
| | | | | | 2308:16: |
| | | | | | 2548, |
| | | | | | 2556, 2564, |
| | | | | | 2572:16: |
| | | | | | 2812, |
| | | | | | 2820:16:3060] |
| 8 | | | | | [3084:16: |
| | | | | | 3324, |
| | | | | | 3332:16: |
| | | | | | 3572, |
| | | | | | 3580, 3588, |
| | | | | | 3596:16: |
| | | | | | 3836, |
| | | | | | 3844:16:4084] |

Table 1 may be used for any 80 MHz portion of the channel bandwidth when not all bits in the feedback bitmap of the partial bandwidth information field in the NDPA frame 506 for that 80 MHz portion request feedback (for example, at least one bit in the feedback bitmap is set to “0” to request no feedback for that corresponding frequency portion, and the frequency resolution is less than 80 MHz). Table 2 may be used for any 80 MHz portion of the channel bandwidth (for example, 996 tone RU) when the grouping value, Ng, is set to 4 and all the bits in the feedback bitmap of the partial bandwidth information field in the NDPA frame 506 for that 80 MHz portion request feedback, and Table 3 may be used for any 80 MHz portion of the channel bandwidth when the grouping value, Ng, is set to 16 and all the bits in the feedback bitmap of the partial bandwidth information field in the NDPA frame 506 for that 80 MHz portion request feedback. The grouping value, Ng, may be indicated in the NDPA frame 506. In Tables 1, 2, and 3, [x:Ng:y] denotes an arithmetic progression from x to y in increments of Ng (i.e., x, x+Ng, x+2, . . . , y).

For example, in Table 1, if the frequency resolution indicated by the partial bandwidth information field is 40 MHz, the first bit of the feedback bitmap corresponds to the 242-tone RU indices 1 and 2, the second bit of the feedback bitmap corresponds to the 242-tone RU indices 3 and 4, the third bit of the feedback bitmap corresponds to the 242-tone RU indices 5 and 6, etc. As another example, in Tables 2 and 3, if the frequency resolution indicated by the partial bandwidth information field is 80 MHz, the first bit of the feedback bitmap corresponds to the 996-tone RU index 1, the second bit of the feedback bitmap corresponds to the 996-tone RU index 2, the third bit of the feedback bitmap corresponds to the 996-tone RU index 3, etc.

The average SNR of the space-time stream i may be found by SNR per subcarrier in decibels for the subcarriers identified in Tables 1-3, and then computing the arithmetic mean of those values. Each SNR value per subcarrier in stream i (before being averaged) may correspond to the SNR associated with column i of the beamforming feedback matrix determined at the beamformee (i.e., the second wireless communications device 502-b). Each SNR corresponds to the predicted SNR at the second wireless communications device 502-b when the beamformer (i.e., the first wireless communications device 502-a) applies all columns of the matrix V.

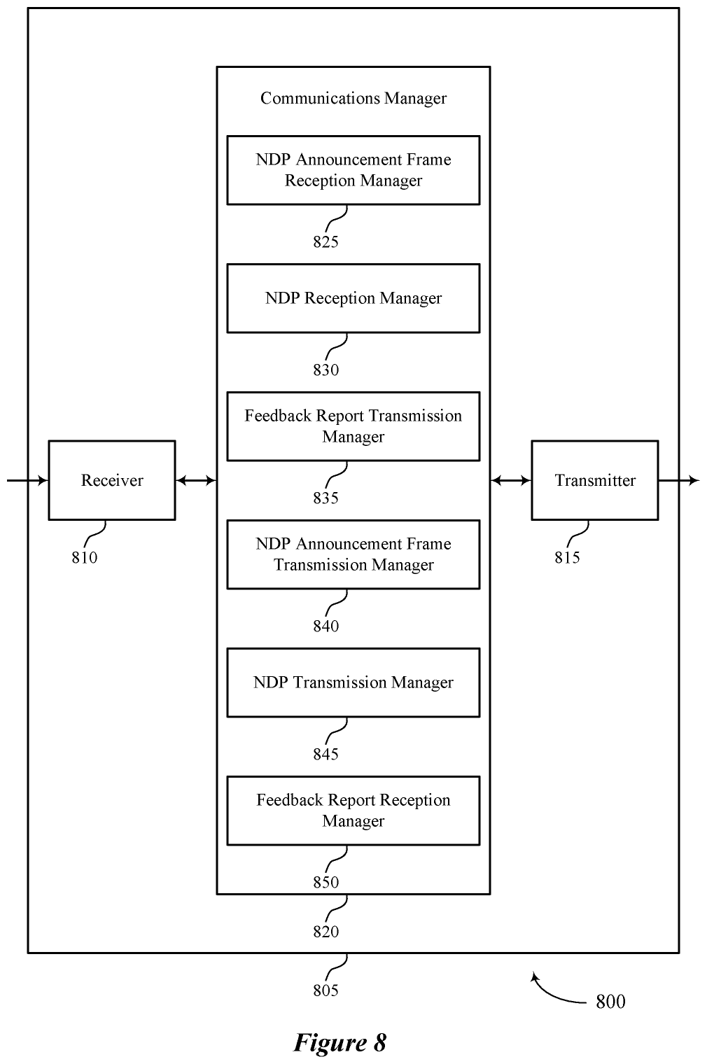

FIG. 6 shows an example of a process flow 600 that supports partial bandwidth feedback for 480 and 640 MHz transmission in Wi-Fi. The process flow includes a first wireless communications device 502-c and a second wireless communications device 502-d, which may be examples of wireless communications devices 502 as described herein. For example, the first wireless communications device 502-c may be an AP 102 or an STA 104 as described herein, and the second wireless communications device 502-d may be an AP 102 or an STA 104 as described herein. In the following description of the process flow 600, the operations between the first wireless communications device 502-c and the second wireless communications device 502-d may be transmitted in a different order than the example order shown, or the operations performed by the first wireless communications device 502-c and the second wireless communications device 502-d may be performed in different orders or at different times. Some operations also may be omitted from the process flow 600, and other operations may be added to the process flow 600.

At 602, the first wireless communications device 502-c may transmit, to the second wireless communications device 502-d, an NDPA frame including a partial bandwidth information field, the partial bandwidth information field including a first set of bits indicating a frequency resolution and a second set of bits including a feedback bitmap, the feedback bitmap indicating one or more portions of a channel bandwidth over which to provide feedback in accordance with the frequency resolution. The value of the first set of bits and the quantity of bits in the second set of bits may be based on the channel bandwidth being one of 480 MHz or 640 MHz.

In some examples, the channel bandwidth is 480 MHz, the first set of bits includes one bit and indicates that the frequency resolution is 40 MHz, and the feedback bitmap includes 12 bits. In some examples, the channel bandwidth is 480 MHz, the first set of bits includes two bits and indicates that the frequency resolution is 80 MHz, and the feedback bitmap includes 6 bits. In some examples, the channel bandwidth is 640 MHz, the first set of bits includes one bit and indicates that the frequency resolution is 40 MHz, and the feedback bitmap includes 16 bits. In some examples, the channel bandwidth is 640 MHz, the first set of bits includes two bits and indicates that the frequency resolution is 80 MHz, and the feedback bitmap includes 8 bits.

At 604, the first wireless communications device 502-c may transmit in accordance with the NDPA frame, to the second wireless communications device 502-d, an NDP.

At 606, the second wireless communications device 502-d may transmit, to the first wireless communications device 502-c, a feedback report based on the NDP and the partial bandwidth information field. In some examples, the feedback is indexed by a set of subcarrier indices, the set of subcarrier indices ranges from −3060 to 3060 for a 480 MHz channel bandwidth and −4084 to 4048 for a 640 MHz channel bandwidth. Subcarrier indices included in the set of subcarrier indices may be based on a grouping value, and the NDPA frame may include a grouping field that indicates the grouping value (Ng).

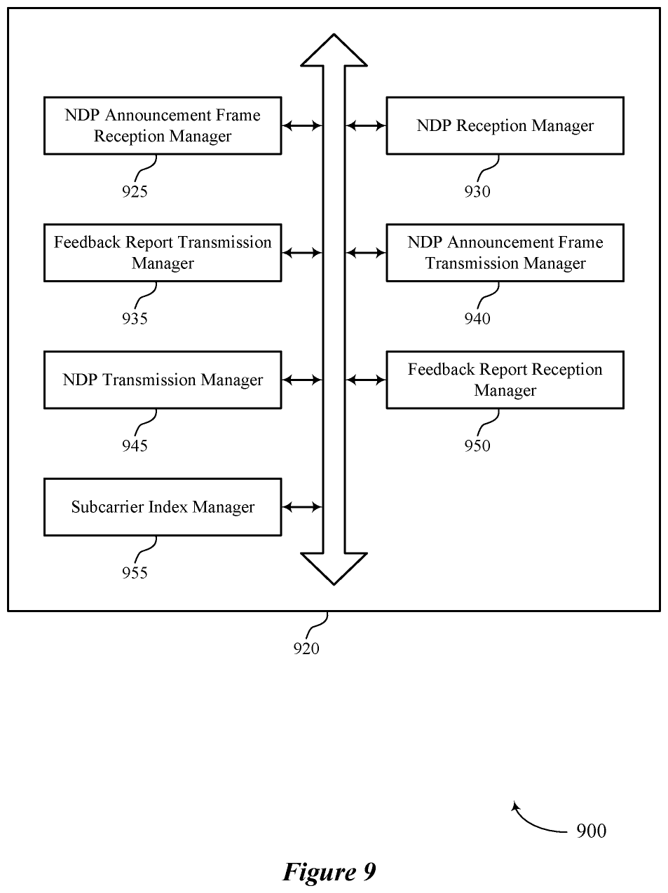

FIG. 7 shows a block diagram 700 of a device 705 that supports partial bandwidth feedback for 480 and 640 MHz transmission in Wi-Fi in accordance with one or more aspects of the present disclosure. The device 705 may be an example of aspects of an AP or a STA as described herein. The device 705 may include a receiver 710, a transmitter 715, and a communications manager 720. The device 705, or one or more components of the device 705 (for example, the receiver 710, the transmitter 715, and the communications manager 720), may include at least one processor, which may be coupled with at least one memory, to, individually or collectively, support or enable the described techniques. Each of these components may be in communication with one another (for example, via one or more buses).

The receiver 710 may provide a means for receiving information such as packets, user data, control information, or any combination thereof associated with various information channels (for example, control channels, data channels, information channels related to partial bandwidth feedback for 480 and 640 MHz transmission in Wi-Fi). Information may be passed on to other components of the device 705. The receiver 710 may utilize a single antenna or a set of multiple antennas.

The transmitter 715 may provide a means for transmitting signals generated by other components of the device 705. The transmitter 715 may utilize a single antenna or a set of multiple antennas.

The communications manager 720, the receiver 710, the transmitter 715, or various combinations thereof or various components thereof may be examples of means for performing various aspects of partial bandwidth feedback for 480 and 640 MHz transmission in Wi-Fi as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (for example, in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (for example, by one or more processors, individually or collectively, executing instructions stored in the at least one memory).

Additionally, or alternatively, the communications manager 720, the receiver 710, the transmitter 715, or various combinations or components thereof may be implemented in code (for example, as communications management software or firmware) executed by at least one processor. If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (for example, configured as or otherwise supporting, individually or collectively, a means for performing the functions described in the present disclosure).

In some examples, the communications manager 720 may be configured to perform various operations (for example, receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving an NDPA frame including a partial bandwidth information field, the partial bandwidth information field including a first set of bits indicating a frequency resolution and a second set of bits including a feedback bitmap, the feedback bitmap indicating one or more portions of a channel bandwidth over which to provide feedback in accordance with the frequency resolution, where a value of the first set of bits and a quantity of bits in the second set of bits are based on the channel bandwidth being one of 480 MHz or 640 MHz. The communications manager 720 is capable of, configured to, or operable to support a means for receiving, in accordance with the NDPA frame, an NDP. The communications manager 720 is capable of, configured to, or operable to support a means for transmitting a feedback report based on the NDP and the partial bandwidth information field.

Additionally, or alternatively, the communications manager 720 may support wireless communications wireless communications device in accordance with examples as disclosed herein. For example, the communications manager 720 is capable of, configured to, or operable to support a means for transmitting an NDPA frame including a partial bandwidth information field, the partial bandwidth information field including a first set of bits indicating a frequency resolution and a second set of bits including a feedback bitmap, the feedback bitmap indicating one or more portions of a channel bandwidth over which to provide feedback in accordance with the frequency resolution, where a value of the first set of bits and a quantity of bits in the second set of bits are based on the channel bandwidth being one of 480 MHz or 640 MHz. The communications manager 720 is capable of, configured to, or operable to support a means for transmitting, in accordance with the NDPA frame, an NDP. The communications manager 720 is capable of, configured to, or operable to support a means for receiving a feedback report based on the NDP and the partial bandwidth information field.

By including or configuring the communications manager 720 in accordance with examples as described herein, the device 705 (for example, at least one processor controlling or otherwise coupled with the receiver 710, the transmitter 715, the communications manager 720, or a combination thereof) may support techniques for more efficient utilization of communication resources.

FIG. 8 shows a block diagram 800 of a device 805 that supports partial bandwidth feedback for 480 and 640 MHz transmission in Wi-Fi in accordance with one or more aspects of the present disclosure. The device 805 may be an example of aspects of a device 705, an AP 102, or a STA 104 as described herein. The device 805 may include a receiver 810, a transmitter 815, and a communications manager 820. The device 805, or one or more components of the device 805 (for example, the receiver 810, the transmitter 815, and the communications manager 820), may include at least one processor, which may be coupled with at least one memory, to support the described techniques. Each of these components may be in communication with one another (for example, via one or more buses).

The receiver 810 may provide a means for receiving information such as packets, user data, control information, or any combination thereof associated with various information channels (for example, control channels, data channels, information channels related to partial bandwidth feedback for 480 and 640 MHz transmission in Wi-Fi). Information may be passed on to other components of the device 805. The receiver 810 may utilize a single antenna or a set of multiple antennas.

The transmitter 815 may provide a means for transmitting signals generated by other components of the device 805. The transmitter 815 may utilize a single antenna or a set of multiple antennas.

The device 805, or various components thereof, may be an example of means for performing various aspects of partial bandwidth feedback for 480 and 640 MHz transmission in Wi-Fi as described herein. For example, the communications manager 820 may include an NDP announcement frame reception manager 825, an NDP reception manager 830, a feedback report transmission manager 835, an NDP announcement frame transmission manager 840, an NDP transmission manager 845, a feedback report reception manager 850, or any combination thereof. The communications manager 820 may be an example of aspects of a communications manager 720 as described herein. In some examples, the communications manager 820, or various components thereof, may be configured to perform various operations (for example, receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The NDP announcement frame reception manager 825 is capable of, configured to, or operable to support a means for receiving an NDPA frame including a partial bandwidth information field, the partial bandwidth information field including a first set of bits indicating a frequency resolution and a second set of bits including a feedback bitmap, the feedback bitmap indicating one or more portions of a channel bandwidth over which to provide feedback in accordance with the frequency resolution, where a value of the first set of bits and a quantity of bits in the second set of bits are based on the channel bandwidth being one of 480 MHz or 640 MHz. The NDP reception manager 830 is capable of, configured to, or operable to support a means for receiving, in accordance with the NDPA frame, an NDP. The feedback report transmission manager 835 is capable of, configured to, or operable to support a means for transmitting a feedback report based on the NDP and the partial bandwidth information field.

Additionally, or alternatively, the communications manager 820 may support wireless communications wireless communications device in accordance with examples as disclosed herein. The NDP announcement frame transmission manager 840 is capable of, configured to, or operable to support a means for transmitting an NDPA frame including a partial bandwidth information field, the partial bandwidth information field including a first set of bits indicating a frequency resolution and a second set of bits including a feedback bitmap, the feedback bitmap indicating one or more portions of a channel bandwidth over which to provide feedback in accordance with the frequency resolution, where a value of the first set of bits and a quantity of bits in the second set of bits are based on the channel bandwidth being one of 480 MHz or 640 MHz. The NDP transmission manager 845 is capable of, configured to, or operable to support a means for transmitting, in accordance with the NDPA frame, an NDP. The feedback report reception manager 850 is capable of, configured to, or operable to support a means for receiving a feedback report based on the NDP and the partial bandwidth information field.

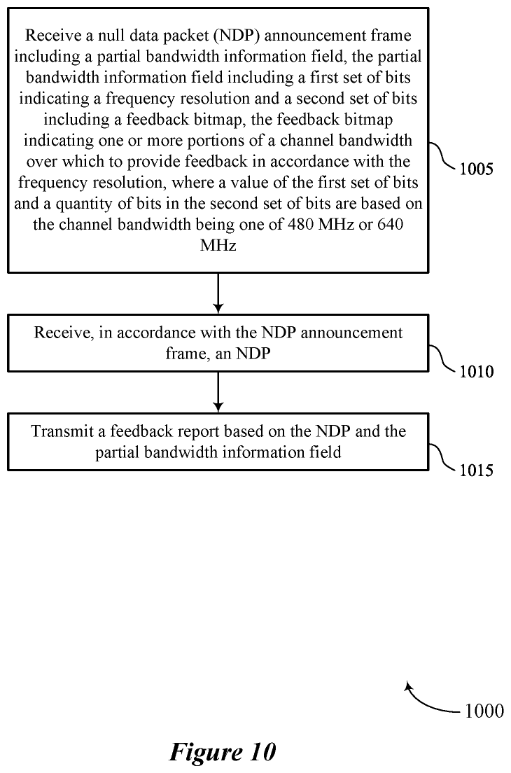

FIG. 9 shows a block diagram of an example wireless communication device 900 that supports partial bandwidth feedback for 480 and 640 MHz transmission in Wi-Fi. In various examples, the wireless communication device 900 can be a chip, SoC, chipset, package or device that may include: one or more modems (such as, a Wi-Fi (IEEE 802.11) modem or a cellular modem such as 3GPP 4G LTE or 5G compliant modem); one or more processors, processing blocks or processing elements (collectively “at least one processor”); one or more radios (collectively “at least one radio”); and one or more memories or memory blocks (collectively “at least one memory”). In some implementations, the at least one processor may include multiple processors, and the at least one memory may include multiple memories. One or more of the multiple processors may be coupled with one or more of the multiple memories which may, individually or collectively, be configured to perform various functions described herein (as part of a processing system).

In some implementations, the wireless communication device 900 can be a device for use in a communications manager, such as communications manager 820 described with reference to FIG. 8. In some other examples, the wireless communication device 900 can be a communications manager that includes such a chip, SoC, chipset, package or device as well as multiple antennas. The wireless communication device 900 is capable of transmitting and receiving wireless communications in the form of, for example, wireless packets. For example, the wireless communication device can be configured or operable to transmit and receive packets in the form of physical layer PPDUs and MPDUs conforming to one or more of the IEEE 802.11 family of wireless communication protocol standards. In some implementations, the wireless communication device 900 also includes or can be coupled with at least one application processor which may be further coupled with at least one memory. In some implementations, the wireless communication device 900 further includes at least one external network interface that enables communication with a core network or backhaul network to gain access to external networks including the Internet.

The wireless communication device 900 includes an NDP announcement frame reception manager 925, an NDP reception manager 930, a feedback report transmission manager 935, an NDP announcement frame transmission manager 940, an NDP transmission manager 945, a feedback report reception manager 950, and a subcarrier index manager 955. Portions of one or more of the NDP announcement frame reception manager 925, the NDP reception manager 930, the feedback report transmission manager 935, the NDP announcement frame transmission manager 940, the NDP transmission manager 945, the feedback report reception manager 950, and the subcarrier index manager 955 may be implemented at least in part in hardware or firmware. For example, one or more of the NDP announcement frame reception manager 925, the NDP reception manager 930, the feedback report transmission manager 935, the NDP announcement frame transmission manager 940, the NDP transmission manager 945, the feedback report reception manager 950, and the subcarrier index manager 955 may be implemented at least in part by at least one modem. In some implementations, at least some of the NDP announcement frame reception manager 925, the NDP reception manager 930, the feedback report transmission manager 935, the NDP announcement frame transmission manager 940, the NDP transmission manager 945, the feedback report reception manager 950, and the subcarrier index manager 955 are implemented at least in part by at least one processor and as software stored in at least one memory. For example, portions of one or more of the NDP announcement frame reception manager 925, the NDP reception manager 930, the feedback report transmission manager 935, the NDP announcement frame transmission manager 940, the NDP transmission manager 945, the feedback report reception manager 950, and the subcarrier index manager 955 can be implemented as non-transitory instructions (or “code”) executable by the at least one processor to perform the functions or operations of the respective module.

In some implementations, the at least one processor may be a component of a processing system. A processing system may generally refer to a system or series of machines or components that receives inputs and processes the inputs to produce a set of outputs (which may be passed to other systems or components of, for example, the device 900). For example, a processing system of the device 900 may refer to a system including the various other components or subcomponents of the device 900, such as the at least one processor, or at least one transceiver, or at least one communications manager, or other components or combinations of components of the device 900. The processing system of the device 900 may interface with other components of the device 900, and may process information received from other components (such as inputs or signals) or output information to other components. For example, a chip or modem of the device 900 may include a processing system, a first interface to output information and a second interface to obtain information. In some implementations, the first interface may refer to an interface between the processing system of the chip or modem and a transmitter, such that the device 900 may transmit information output from the chip or modem. In some implementations, the second interface may refer to an interface between the processing system of the chip or modem and a receiver, such that the device 900 may obtain information or signal inputs, and the information may be passed to the processing system. A person having ordinary skill in the art will readily recognize that the first interface also may obtain information or signal inputs, and the second interface also may output information or signal outputs.

The communications manager 920 may support wireless communications in accordance with examples as disclosed herein. The NDP announcement frame reception manager 925 is capable of, configured to, or operable to support a means for receiving an NDPA frame including a partial bandwidth information field, the partial bandwidth information field including a first set of bits indicating a frequency resolution and a second set of bits including a feedback bitmap, the feedback bitmap indicating one or more portions of a channel bandwidth over which to provide feedback in accordance with the frequency resolution, where a value of the first set of bits and a quantity of bits in the second set of bits are based on the channel bandwidth being one of 480 MHz or 640 MHz. The NDP reception manager 930 is capable of, configured to, or operable to support a means for receiving, in accordance with the NDPA frame, an NDP. The feedback report transmission manager 935 is capable of, configured to, or operable to support a means for transmitting a feedback report based on the NDP and the partial bandwidth information field.

In some examples, the channel bandwidth is 480 MHz, the first set of bits includes one bit and indicates that the frequency resolution is 40 MHz, and the feedback bitmap includes 12 bits.

In some examples, the channel bandwidth is 480 MHz, the first set of bits includes two bits and indicates that the frequency resolution is 80 MHz, and the feedback bitmap includes 6 bits.

In some examples, the channel bandwidth is 640 MHz, the first set of bits includes one bit and indicates that the frequency resolution is 40 MHz, and the feedback bitmap includes 16 bits.

In some examples, the channel bandwidth is 640 MHz, the first set of bits includes two bits and indicates that the frequency resolution is 80 MHz, and the feedback bitmap includes 8 bits.

In some examples, to support transmitting the feedback report, the subcarrier index manager 955 is capable of, configured to, or operable to support a means for transmitting feedback indexed by a set of subcarrier indices, where the set of subcarrier indices ranges from −3060 to 3060 for a 480 MHz channel bandwidth and −4084 to 4048 for a 640 MHz channel bandwidth, where subcarrier indices included in the set of subcarrier indices are based on a grouping value, where the NDPA frame includes a grouping field that indicates the grouping value.

In some examples, the channel bandwidth is 480 MHz. In some examples, the NDPA frame indicates that feedback is requested in accordance with 242 tone resource units. In some examples, a first subset of subcarrier indices that provide feedback for a first 20 MHz subchannel of the 480 MHz channel bandwidth includes [−3060:Ng:−2820]. In some examples, a second subset of subcarrier indices that provide feedback for a second 20 MHz subchannel of the 480 MHz channel bandwidth includes [−2812:Ng:−2572]. In some examples, a third subset of subcarrier indices that provide feedback for a third 20 MHz subchannel of the 480 MHz channel bandwidth includes [−2548:Ng:−2308]. In some examples, a fourth subset of subcarrier indices that provide feedback for a fourth 20 MHz subchannel of the 480 MHz channel bandwidth includes [−2300:Ng:−2060]. In some examples, a fifth subset of subcarrier indices that provide feedback for a fifth 20 MHz subchannel of the 480 MHz channel bandwidth includes [−2036:Ng: −1796]. In some examples, a sixth subset of subcarrier indices that provide feedback for a sixth 20 MHz subchannel of the 480 MHz channel bandwidth includes [−1788:Ng: −1548]. In some examples, a seventh subset of subcarrier indices that provide feedback for a seventh 20 MHz subchannel of the 480 MHz channel bandwidth includes [−1524:Ng: −1284]. In some examples, an eighth subset of subcarrier indices that provide feedback for an eighth 20 MHz subchannel of the 480 MHz channel bandwidth includes [−1276:Ng: −1036]. In some examples, a ninth subset of subcarrier indices that provide feedback for a ninth 20 MHz subchannel of the 480 MHz channel bandwidth includes [−1012:Ng: −772]. In some examples, a tenth subset of subcarrier indices that provide feedback for a tenth 20 MHz subchannel of the 480 MHz channel bandwidth includes [−764:Ng: −524]. In some examples, an eleventh subset of subcarrier indices that provide feedback for an eleventh 20 MHz subchannel of the 480 MHz channel bandwidth includes [−500:Ng: −260]. In some examples, a twelfth subset of subcarrier indices that provide feedback for a twelfth 20 MHz subchannel of the 480 MHz channel bandwidth includes [−252:Ng:−12]. In some examples, a thirteenth subset of subcarrier indices that provide feedback for a thirteenth 20 MHz subchannel of the 480 MHz channel bandwidth includes [12:Ng:252]. In some examples, a fourteenth subset of subcarrier indices that provide feedback for a fourteenth 20 MHz subchannel of the 480 MHz channel bandwidth includes [260:Ng:500]. In some examples, a fifteenth subset of subcarrier indices that provide feedback for a fifteenth 20 MHz subchannel of the 480 MHz channel bandwidth includes [524:Ng:764]. In some examples, a sixteenth subset of subcarrier indices that provide feedback for a sixteenth 20 MHz subchannel of the 480 MHz channel bandwidth includes [772:Ng:1012]. In some examples, a seventeenth subset of subcarrier indices that provide feedback for a seventeenth 20 MHz subchannel of the 480 MHz channel bandwidth includes [1036:Ng: 1276]. In some examples, an eighteenth subset of subcarrier indices that provide feedback for an eighteenth 20 MHz subchannel of the 480 MHz channel bandwidth includes [1284:Ng: 1524]. In some examples, a nineteenth subset of subcarrier indices that provide feedback for a nineteenth 20 MHz subchannel of the 480 MHz channel bandwidth includes [1548:Ng: 1788]. In some examples, a twentieth subset of subcarrier indices that provide feedback for a twentieth 20 MHz subchannel of the 480 MHz channel bandwidth includes [1796:Ng: 2036]. In some examples, a twenty-first subset of subcarrier indices that provide feedback for a twenty-first 20 MHz subchannel of the 480 MHz channel bandwidth includes [2060:Ng:2300]. In some examples, a twenty-second subset of subcarrier indices that provide feedback for a twenty-second 20 MHz subchannel of the 480 MHz channel bandwidth includes [2308:Ng:2548]. In some examples, a twenty-third subset of subcarrier indices that provide feedback for a twenty-third 20 MHz subchannel of the 480 MHz channel bandwidth includes [2572:Ng:2812]. In some examples, a twenty-fourth subset of subcarrier indices that provide feedback for a twenty-fourth 20 MHz subchannel of the 480 MHz channel bandwidth includes [2820:Ng:3060]. In some examples, Ng is equal to the grouping value.

In some examples, the channel bandwidth is 640 MHz. In some examples, the NDPA frame indicates that feedback is requested in accordance with 242 tone resource units. In some examples, a first subset of subcarrier indices that provide feedback for a first 20 MHz subchannel of the 640 MHz channel bandwidth includes [−4084:Ng:−3844]. In some examples, a second subset of subcarrier indices that provide feedback for a second 20 MHz subchannel of the 640 MHz channel bandwidth includes [−3836:Ng:−3596]. In some examples, a third subset of subcarrier indices that provide feedback for a third 20 MHz subchannel of the 640 MHz channel bandwidth includes [−3572:Ng:−3332]. In some examples, a fourth subset of subcarrier indices that provide feedback for a fourth 20 MHz subchannel of the 640 MHz channel bandwidth includes [−3324:Ng:−3084]. In some examples, a fifth subset of subcarrier indices that provide feedback for a fifth 20 MHz subchannel of the 640 MHz channel bandwidth includes [−3060:Ng:−2820]. In some examples, a sixth subset of subcarrier indices that provide feedback for a sixth 20 MHz subchannel of the 640 MHz channel bandwidth includes [−2812:Ng:−2572]. In some examples, a seventh subset of subcarrier indices that provide feedback for a seventh 20 MHz subchannel of the 640 MHz channel bandwidth includes [−2548:Ng:−2308]. In some examples, an eighth subset of subcarrier indices that provide feedback for an eighth 20 MHz subchannel of the 640 MHz channel bandwidth includes [−2300:Ng:−2060]. In some examples, a ninth subset of subcarrier indices that provide feedback for a ninth 20 MHz subchannel of the 640 MHz channel bandwidth includes [−2036:Ng: −1796]. In some examples, a tenth subset of subcarrier indices that provide feedback for a tenth 20 MHz subchannel of the 640 MHz channel bandwidth includes [−1788:Ng: −1548]. In some examples, an eleventh subset of subcarrier indices that provide feedback for an eleventh 20 MHz subchannel of the 640 MHz channel bandwidth includes [−1524:Ng: −1284]. In some examples, a twelfth subset of subcarrier indices that provide feedback for a twelfth 20 MHz subchannel of the 640 MHz channel bandwidth includes [−1276:Ng: −1036]. In some examples, a thirteenth subset of subcarrier indices that provide feedback for a thirteenth 20 MHz subchannel of the 640 MHz channel bandwidth includes [−1012:Ng: −772]. In some examples, a fourteenth subset of subcarrier indices that provide feedback for a fourteenth 20 MHz subchannel of the 640 MHz channel bandwidth includes [−764:Ng: −524]. In some examples, a fifteenth subset of subcarrier indices that provide feedback for a fifteenth 20 MHz subchannel of the 640 MHz channel bandwidth includes [−500:Ng: −260]. In some examples, a sixteenth subset of subcarrier indices that provide feedback for a sixteenth 20 MHz subchannel of the 640 MHz channel bandwidth includes [−252:Ng:−12]. In some examples, a seventeenth subset of subcarrier indices that provide feedback for a seventeenth 20 MHz subchannel of the 640 MHz channel bandwidth includes [12:Ng:252]. In some examples, an eighteenth subset of subcarrier indices that provide feedback for an eighteenth 20 MHz subchannel of the 640 MHz channel bandwidth includes [260:Ng:500]. In some examples, a nineteenth subset of subcarrier indices that provide feedback for a nineteenth 20 MHz subchannel of the 640 MHz channel bandwidth includes [524:Ng:764]. In some examples, a twentieth subset of subcarrier indices that provide feedback for a twentieth 20 MHz subchannel of the 640 MHz channel bandwidth includes [772:Ng:1012]. In some examples, a twenty-first subset of subcarrier indices that provide feedback for a twenty-first 20 MHz subchannel of the 640 MHz channel bandwidth includes [1036:Ng: 1276]. In some examples, a twenty-second subset of subcarrier indices that provide feedback for a twenty-second 20 MHz subchannel of the 640 MHz channel bandwidth includes [1284:Ng: 1524]. In some examples, a twenty-third subset of subcarrier indices that provide feedback for a twenty-third 20 MHz subchannel of the 640 MHz channel bandwidth includes [1548:Ng: 1788]. In some examples, a twenty-fourth subset of subcarrier indices that provide feedback for a twenty-fourth 20 MHz subchannel of the 640 MHz channel bandwidth includes [1796:Ng: 2036]. In some examples, a twenty-fifth subset of subcarrier indices that provide feedback for a twenty-fifth 20 MHz subchannel of the 640 MHz channel bandwidth includes [2060:Ng:2300]. In some examples, a twenty-sixth subset of subcarrier indices that provide feedback for a twenty-sixth 20 MHz subchannel of the 640 MHz channel bandwidth includes [2308:Ng:2548]. In some examples, a twenty-seventh subset of subcarrier indices that provide feedback for a twenty-seventh 20 MHz subchannel of the 640 MHz channel bandwidth includes [2572:Ng:2812]. In some examples, a twenty-eighth subset of subcarrier indices that provide feedback for a twenty-eighth 20 MHz subchannel of the 640 MHz channel bandwidth includes [2820:Ng:3060]. In some examples, a twenty-ninth subset of subcarrier indices that provide feedback for a twenty-ninth 20 MHz subchannel of the 640 MHz channel bandwidth includes [3084:Ng:3324]. In some examples, a thirtieth subset of subcarrier indices that provide feedback for a thirtieth 20 MHz subchannel of the 640 MHz channel bandwidth includes [3332:Ng:3572]. In some examples, a thirty-first subset of subcarrier indices that provide feedback for a thirty-first 20 MHz subchannel of the 640 MHz channel bandwidth includes [3596:Ng:3836]. In some examples, a thirty-second subset of subcarrier indices that provide feedback for a thirty-second 20 MHz subchannel of the 640 MHz channel bandwidth includes [3844:Ng:4084]. In some examples, Ng is equal to the grouping value.

In some examples, the channel bandwidth is 480 MHz. In some examples, the NDPA frame indicates that feedback is requested in accordance with 996 tone resource units. In some examples, the grouping value is 4. In some examples, a first subset of subcarrier indices that provide feedback for a first 80 MHz subchannel of the 480 MHz channel bandwidth includes [−3060:4:−2564, −2556:4:−2060]. In some examples, a second subset of subcarrier indices that provide feedback for a second 80 MHz subchannel of the 480 MHz channel bandwidth includes [−2036:4:−1540, −1532:4:−1036]. In some examples, a third subset of subcarrier indices that provide feedback for a third 80 MHz subchannel of the 480 MHz channel bandwidth includes [−1012:4:−516, −508:4:−12]. In some examples, a fourth subset of subcarrier indices that provide feedback for a fourth 80 MHz subchannel of the 480 MHz channel bandwidth includes [12:4:508, 516:4:1012]. In some examples, a fifth subset of subcarrier indices that provide feedback for a fifth 80 MHz subchannel of the 480 MHz channel bandwidth includes [1036:4:1532, 1540:4:2036]. In some examples, a sixth subset of subcarrier indices that provide feedback for a sixth 80 MHz subchannel of the 480 MHz channel bandwidth includes [2060:4:2556, 2564:4:3060].

In some examples, the channel bandwidth is 640 MHz. In some examples, the NDPA frame indicates that feedback is requested in accordance with 996 tone resource units. In some examples, the grouping value is 4. In some examples, a first subset of subcarrier indices that provide feedback for a first 80 MHz subchannel of the 640 MHz channel bandwidth includes [−4084:4:−3588, −3580:4:−3084]. In some examples, a second subset of subcarrier indices that provide feedback for a second 80 MHz subchannel of the 640 MHz channel bandwidth includes [−3060:4:−2564, −2556:4:−2060]. In some examples, a third subset of subcarrier indices that provide feedback for a third 80 MHz subchannel of the 640 MHz channel bandwidth includes [−2036:4:−1540, −1532:4:−1036]. In some examples, a fourth subset of subcarrier indices that provide feedback for a fourth 80 MHz subchannel of the 640 MHz channel bandwidth includes [−1012:4:−516, −508:4:−12]. In some examples, a fifth subset of subcarrier indices that provide feedback for a fifth 80 MHz subchannel of the 640 MHz channel bandwidth includes [12:4:508, 516:4:1012]. In some examples, a sixth subset of subcarrier indices that provide feedback for a sixth 80 MHz subchannel of the 640 MHz channel bandwidth includes [1036:4:1532, 1540:4:2036]. In some examples, a seventh subset of subcarrier indices that provide feedback for a seventh 80 MHz subchannel of the 640 MHz channel bandwidth includes [2060:4:2556, 2564:4:3060]. In some examples, an eighth subset of subcarrier indices that provide feedback for an eighth 80 MHz subchannel of the 640 MHz channel bandwidth includes [3084:4:3580, 3588:4:4084].

In some examples, the channel bandwidth is 480 MHz. In some examples, the NDPA frame indicates that feedback is requested in accordance with 996 tone resource units. In some examples, the grouping value is 16. In some examples, a first subset of subcarrier indices that provide feedback for a first 80 MHz subchannel of the 480 MHz channel bandwidth includes [−3060:16:−2820, −2812:16:−2572, −2564, −2556, −2548:16:−2308, −2300:16:−2060]. In some examples, a second subset of subcarrier indices that provide feedback for a second 80 MHz subchannel of the 480 MHz channel bandwidth includes [−2036:16:−1796, −1788:16:−1548, −1540, −1532, −1524:16:−1284, −1276:16:−1036]. In some examples, a third subset of subcarrier indices that provide feedback for a third 80 MHz subchannel of the 480 MHz channel bandwidth includes [−1012:16:−772, −764:16:−524, −516, −508, −500:16:−260, −252:16:−12]. In some examples, a fourth subset of subcarrier indices that provide feedback for a fourth 80 MHz subchannel of the 480 MHz channel bandwidth includes [12:16:252, 260:16:500, 508, 516, 524:16:764, 772:16:1012]. In some examples, a fifth subset of subcarrier indices that provide feedback for a fifth 80 MHz subchannel of the 480 MHz channel bandwidth includes [1036:16:1276, 1284:16:1524, 1532, 1540, 1548:16:1788, 1796:16:2036]. In some examples, a sixth subset of subcarrier indices that provide feedback for a sixth 80 MHz subchannel of the 480 MHz channel bandwidth includes [2060:16:2300, 2308:16:2548, 2556, 2564, 2572:16:2812, 2820:16:3060].

In some examples, the channel bandwidth is 640 MHz. In some examples, the NDPA frame indicates that feedback is requested in accordance with 996 tone resource units. In some examples, the grouping value is 16. In some examples, a first subset of subcarrier indices that provide feedback for a first 80 MHz subchannel of the 640 MHz channel bandwidth includes [−4084:16:−3844, −3836:16:−3596, −3588, −3580, −3572:16:−3332, −3324:16:−3084]. In some examples, a second subset of subcarrier indices that provide feedback for a second 80 MHz subchannel of the 640 MHz channel bandwidth includes [−3060:16:−2820, −2812:16:−2572, −2564, −2556, −2548:16:−2308, −2300:16:−2060]. In some examples, a third subset of subcarrier indices that provide feedback for a third 80 MHz subchannel of the 640 MHz channel bandwidth includes [−2036:16:−1796, −1788:16:−1548, −1540, −1532, −1524:16:−1284, −1276:16:−1036]. In some examples, a fourth subset of subcarrier indices that provide feedback for a fourth 80 MHz subchannel of the 640 MHz channel bandwidth includes [−1012:16:−772, −764:16:−524, −516, −508, −500:16:−260, −252:16:−12]. In some examples, a fifth subset of subcarrier indices that provide feedback for a fifth 80 MHz subchannel of the 640 MHz channel bandwidth includes [12:16:252, 260:16:500, 508, 516, 524:16:764, 772:16:1012]. In some examples, a sixth subset of subcarrier indices that provide feedback for a sixth 80 MHz subchannel of the 640 MHz channel bandwidth includes [1036:16:1276, 1284:16:1524, 1532, 1540, 1548:16:1788, 1796:16:2036]. In some examples, a seventh subset of subcarrier indices that provide feedback for a seventh 80 MHz subchannel of the 640 MHz channel bandwidth includes [2060:16:2300, 2308:16:2548, 2556, 2564, 2572:16:2812, 2820:16:3060]. In some examples, an eighth subset of subcarrier indices that provide feedback for an eighth 80 MHz subchannel of the 640 MHz channel bandwidth includes [3084:16:3324, 3332:16:3572, 3580, 3588, 3596:16:3836, 3844:16:4084].

Additionally, or alternatively, the communications manager 920 may support wireless communications wireless communications device in accordance with examples as disclosed herein. The NDPA frame transmission manager 940 is capable of, configured to, or operable to support a means for transmitting an NDPA frame including a partial bandwidth information field, the partial bandwidth information field including a first set of bits indicating a frequency resolution and a second set of bits including a feedback bitmap, the feedback bitmap indicating one or more portions of a channel bandwidth over which to provide feedback in accordance with the frequency resolution, where a value of the first set of bits and a quantity of bits in the second set of bits are based on the channel bandwidth being one of 480 MHz or 640 MHz. The NDP transmission manager 945 is capable of, configured to, or operable to support a means for transmitting, in accordance with the NDPA frame, an NDP. The feedback report reception manager 950 is capable of, configured to, or operable to support a means for receiving a feedback report based on the NDP and the partial bandwidth information field.

In some examples, the channel bandwidth is 480 MHz, the first set of bits includes one bit and indicates that the frequency resolution is 40 MHz, and the feedback bitmap includes 12 bits.

In some examples, the channel bandwidth is 480 MHz, the first set of bits includes two bits and indicates that the frequency resolution is 80 MHz, and the feedback bitmap includes 6 bits.

In some examples, the channel bandwidth is 640 MHz, the first set of bits includes one bit and indicates that the frequency resolution is 40 MHz, and the feedback bitmap includes 16 bits.

In some examples, the channel bandwidth is 640 MHz, the first set of bits includes two bits and indicates that the frequency resolution is 80 MHz, and the feedback bitmap includes 8 bits.

In some examples, to support receiving the feedback report, the subcarrier index manager 955 is capable of, configured to, or operable to support a means for receiving feedback indexed by a set of subcarrier indices, where the set of subcarrier indices ranges from −3060 to 3060 for a 480 MHz channel bandwidth and −4084 to 4048 for a 640 MHz channel bandwidth, where subcarrier indices included in the set of subcarrier indices are based on a grouping value, where the NDPA frame includes a grouping field that indicates the grouping value.

In some examples, the channel bandwidth is 480 MHz. In some examples, the NDPA frame indicates that feedback is requested in accordance with 242 tone resource units. In some examples, a first subset of subcarrier indices that provide feedback for a first 20 MHz subchannel of the 480 MHz channel bandwidth includes [−3060:Ng:−2820]. In some examples, a second subset of subcarrier indices that provide feedback for a second 20 MHz subchannel of the 480 MHz channel bandwidth includes [−2812:Ng:−2572]. In some examples, a third subset of subcarrier indices that provide feedback for a third 20 MHz subchannel of the 480 MHz channel bandwidth includes [−2548:Ng:−2308]. In some examples, a fourth subset of subcarrier indices that provide feedback for a fourth 20 MHz subchannel of the 480 MHz channel bandwidth includes [−2300:Ng:−2060]. In some examples, a fifth subset of subcarrier indices that provide feedback for a fifth 20 MHz subchannel of the 480 MHz channel bandwidth includes [−2036:Ng: −1796]. In some examples, a sixth subset of subcarrier indices that provide feedback for a sixth 20 MHz subchannel of the 480 MHz channel bandwidth includes [−1788:Ng: −1548]. In some examples, a seventh subset of subcarrier indices that provide feedback for a seventh 20 MHz subchannel of the 480 MHz channel bandwidth includes [−1524:Ng: −1284]. In some examples, an eighth subset of subcarrier indices that provide feedback for an eighth 20 MHz subchannel of the 480 MHz channel bandwidth includes [−1276:Ng: −1036]. In some examples, a ninth subset of subcarrier indices that provide feedback for a ninth 20 MHz subchannel of the 480 MHz channel bandwidth includes [−1012:Ng: −772]. In some examples, a tenth subset of subcarrier indices that provide feedback for a tenth 20 MHz subchannel of the 480 MHz channel bandwidth includes [−764:Ng: −524]. In some examples, an eleventh subset of subcarrier indices that provide feedback for an eleventh 20 MHz subchannel of the 480 MHz channel bandwidth includes [−500:Ng: −260]. In some examples, a twelfth subset of subcarrier indices that provide feedback for a twelfth 20 MHz subchannel of the 480 MHz channel bandwidth includes [−252:Ng:−12]. In some examples, a thirteenth subset of subcarrier indices that provide feedback for a thirteenth 20 MHz subchannel of the 480 MHz channel bandwidth includes [12:Ng:252]. In some examples, a fourteenth subset of subcarrier indices that provide feedback for a fourteenth 20 MHz subchannel of the 480 MHz channel bandwidth includes [260:Ng:500]. In some examples, a fifteenth subset of subcarrier indices that provide feedback for a fifteenth 20 MHz subchannel of the 480 MHz channel bandwidth includes [524:Ng:764]. In some examples, a sixteenth subset of subcarrier indices that provide feedback for a sixteenth 20 MHz subchannel of the 480 MHz channel bandwidth includes [772:Ng:1012]. In some examples, a seventeenth subset of subcarrier indices that provide feedback for a seventeenth 20 MHz subchannel of the 480 MHz channel bandwidth includes [1036:Ng: 1276]. In some examples, an eighteenth subset of subcarrier indices that provide feedback for an eighteenth 20 MHz subchannel of the 480 MHz channel bandwidth includes [1284:Ng: 1524]. In some examples, a nineteenth subset of subcarrier indices that provide feedback for a nineteenth 20 MHz subchannel of the 480 MHz channel bandwidth includes [1548:Ng: 1788]. In some examples, a twentieth subset of subcarrier indices that provide feedback for a twentieth 20 MHz subchannel of the 480 MHz channel bandwidth includes [1796:Ng: 2036]. In some examples, a twenty-first subset of subcarrier indices that provide feedback for a twenty-first 20 MHz subchannel of the 480 MHz channel bandwidth includes [2060:Ng:2300]. In some examples, a twenty-second subset of subcarrier indices that provide feedback for a twenty-second 20 MHz subchannel of the 480 MHz channel bandwidth includes [2308:Ng:2548]. In some examples, a twenty-third subset of subcarrier indices that provide feedback for a twenty-third 20 MHz subchannel of the 480 MHz channel bandwidth includes [2572:Ng:2812]. In some examples, a twenty-fourth subset of subcarrier indices that provide feedback for a twenty-fourth 20 MHz subchannel of the 480 MHz channel bandwidth includes [2820:Ng:3060]. In some examples, Ng is equal to the grouping value.

In some examples, the channel bandwidth is 640 MHz. In some examples, the NDPA frame indicates that feedback is requested in accordance with 242 tone resource units. In some examples, a first subset of subcarrier indices that provide feedback for a first 20 MHz subchannel of the 640 MHz channel bandwidth includes [−4084:Ng:−3844]. In some examples, a second subset of subcarrier indices that provide feedback for a second 20 MHz subchannel of the 640 MHz channel bandwidth includes [−3836:Ng:−3596]. In some examples, a third subset of subcarrier indices that provide feedback for a third 20 MHz subchannel of the 640 MHz channel bandwidth includes [−3572:Ng:−3332]. In some examples, a fourth subset of subcarrier indices that provide feedback for a fourth 20 MHz subchannel of the 640 MHz channel bandwidth includes [−3324:Ng:−3084]. In some examples, a fifth subset of subcarrier indices that provide feedback for a fifth 20 MHz subchannel of the 640 MHz channel bandwidth includes [−3060:Ng:−2820]. In some examples, a sixth subset of subcarrier indices that provide feedback for a sixth 20 MHz subchannel of the 640 MHz channel bandwidth includes [−2812:Ng:−2572]. In some examples, a seventh subset of subcarrier indices that provide feedback for a seventh 20 MHz subchannel of the 640 MHz channel bandwidth includes [−2548:Ng:−2308]. In some examples, an eighth subset of subcarrier indices that provide feedback for an eighth 20 MHz subchannel of the 640 MHz channel bandwidth includes [−2300:Ng:−2060]. In some examples, a ninth subset of subcarrier indices that provide feedback for a ninth 20 MHz subchannel of the 640 MHz channel bandwidth includes [−2036:Ng: −1796]. In some examples, a tenth subset of subcarrier indices that provide feedback for a tenth 20 MHz subchannel of the 640 MHz channel bandwidth includes [−1788:Ng: −1548]. In some examples, an eleventh subset of subcarrier indices that provide feedback for an eleventh 20 MHz subchannel of the 640 MHz channel bandwidth includes [−1524:Ng: −1284]. In some examples, a twelfth subset of subcarrier indices that provide feedback for a twelfth 20 MHz subchannel of the 640 MHz channel bandwidth includes [−1276:Ng: −1036]. In some examples, a thirteenth subset of subcarrier indices that provide feedback for a thirteenth 20 MHz subchannel of the 640 MHz channel bandwidth includes [−1012:Ng: −772]. In some examples, a fourteenth subset of subcarrier indices that provide feedback for a fourteenth 20 MHz subchannel of the 640 MHz channel bandwidth includes [−764:Ng: −524]. In some examples, a fifteenth subset of subcarrier indices that provide feedback for a fifteenth 20 MHz subchannel of the 640 MHz channel bandwidth includes [−500:Ng: −260]. In some examples, a sixteenth subset of subcarrier indices that provide feedback for a sixteenth 20 MHz subchannel of the 640 MHz channel bandwidth includes [−252:Ng:−12]. In some examples, a seventeenth subset of subcarrier indices that provide feedback for a seventeenth 20 MHz subchannel of the 640 MHz channel bandwidth includes [12:Ng:252]. In some examples, an eighteenth subset of subcarrier indices that provide feedback for an eighteenth 20 MHz subchannel of the 640 MHz channel bandwidth includes [260:Ng:500]. In some examples, a nineteenth subset of subcarrier indices that provide feedback for a nineteenth 20 MHz subchannel of the 640 MHz channel bandwidth includes [524:Ng:764]. In some examples, a twentieth subset of subcarrier indices that provide feedback for a twentieth 20 MHz subchannel of the 640 MHz channel bandwidth includes [772:Ng:1012]. In some examples, a twenty-first subset of subcarrier indices that provide feedback for a twenty-first 20 MHz subchannel of the 640 MHz channel bandwidth includes [1036:Ng: 1276]. In some examples, a twenty-second subset of subcarrier indices that provide feedback for a twenty-second 20 MHz subchannel of the 640 MHz channel bandwidth includes [1284:Ng: 1524]. In some examples, a twenty-third subset of subcarrier indices that provide feedback for a twenty-third 20 MHz subchannel of the 640 MHz channel bandwidth includes [1548:Ng: 1788]. In some examples, a twenty-fourth subset of subcarrier indices that provide feedback for a twenty-fourth 20 MHz subchannel of the 640 MHz channel bandwidth includes [1796:Ng: 2036]. In some examples, a twenty-fifth subset of subcarrier indices that provide feedback for a twenty-fifth 20 MHz subchannel of the 640 MHz channel bandwidth includes [2060:Ng:2300]. In some examples, a twenty-sixth subset of subcarrier indices that provide feedback for a twenty-sixth 20 MHz subchannel of the 640 MHz channel bandwidth includes [2308:Ng:2548]. In some examples, a twenty-seventh subset of subcarrier indices that provide feedback for a twenty-seventh 20 MHz subchannel of the 640 MHz channel bandwidth includes [2572:Ng:2812]. In some examples, a twenty-eighth subset of subcarrier indices that provide feedback for a twenty-eighth 20 MHz subchannel of the 640 MHz channel bandwidth includes [2820:Ng:3060]. In some examples, a twenty-ninth subset of subcarrier indices that provide feedback for a twenty-ninth 20 MHz subchannel of the 640 MHz channel bandwidth includes [3084:Ng:3324]. In some examples, a thirtieth subset of subcarrier indices that provide feedback for a thirtieth 20 MHz subchannel of the 640 MHz channel bandwidth includes [3332:Ng:3572]. In some examples, a thirty-first subset of subcarrier indices that provide feedback for a thirty-first 20 MHz subchannel of the 640 MHz channel bandwidth includes [3596:Ng:3836]. In some examples, a thirty-second subset of subcarrier indices that provide feedback for a thirty-second 20 MHz subchannel of the 640 MHz channel bandwidth includes [3844:Ng:4084]. In some examples, Ng is equal to the grouping value.

In some examples, the channel bandwidth is 480 MHz. In some examples, the NDPA frame indicates that feedback is requested in accordance with 996 tone resource units. In some examples, the grouping value is 4. In some examples, a first subset of subcarrier indices that provide feedback for a first 80 MHz subchannel of the 480 MHz channel bandwidth includes [−3060:4:−2564, −2556:4:−2060]. In some examples, a second subset of subcarrier indices that provide feedback for a second 80 MHz subchannel of the 480 MHz channel bandwidth includes [−2036:4:−1540, −1532:4:−1036]. In some examples, a third subset of subcarrier indices that provide feedback for a third 80 MHz subchannel of the 480 MHz channel bandwidth includes [−1012:4:−516, −508:4:−12]. In some examples, a fourth subset of subcarrier indices that provide feedback for a fourth 80 MHz subchannel of the 480 MHz channel bandwidth includes [12:4:508, 516:4:1012]. In some examples, a fifth subset of subcarrier indices that provide feedback for a fifth 80 MHz subchannel of the 480 MHz channel bandwidth includes [1036:4:1532, 1540:4:2036]. In some examples, a sixth subset of subcarrier indices that provide feedback for a sixth 80 MHz subchannel of the 480 MHz channel bandwidth includes [2060:4:2556, 2564:4:3060].

In some examples, the channel bandwidth is 640 MHz. In some examples, the NDPA frame indicates that feedback is requested in accordance with 996 tone resource units. In some examples, the grouping value is 4. In some examples, a first subset of subcarrier indices that provide feedback for a first 80 MHz subchannel of the 640 MHz channel bandwidth includes [−4084:4:−3588, −3580:4:−3084]. In some examples, a second subset of subcarrier indices that provide feedback for a second 80 MHz subchannel of the 640 MHz channel bandwidth includes [−3060:4:−2564, −2556:4:−2060]. In some examples, a third subset of subcarrier indices that provide feedback for a third 80 MHz subchannel of the 640 MHz channel bandwidth includes [−2036:4:−1540, −1532:4:−1036]. In some examples, a fourth subset of subcarrier indices that provide feedback for a fourth 80 MHz subchannel of the 640 MHz channel bandwidth includes [−1012:4:−516, −508:4:−12]. In some examples, a fifth subset of subcarrier indices that provide feedback for a fifth 80 MHz subchannel of the 640 MHz channel bandwidth includes [12:4:508, 516:4:1012]. In some examples, a sixth subset of subcarrier indices that provide feedback for a sixth 80 MHz subchannel of the 640 MHz channel bandwidth includes [1036:4:1532, 1540:4:2036]. In some examples, a seventh subset of subcarrier indices that provide feedback for a seventh 80 MHz subchannel of the 640 MHz channel bandwidth includes [2060:4:2556, 2564:4:3060]. In some examples, an eighth subset of subcarrier indices that provide feedback for an eighth 80 MHz subchannel of the 640 MHz channel bandwidth includes [3084:4:3580, 3588:4:4084].

In some examples, the channel bandwidth is 480 MHz. In some examples, the NDPA frame indicates that feedback is requested in accordance with 996 tone resource units. In some examples, the grouping value is 16. In some examples, a first subset of subcarrier indices that provide feedback for a first 80 MHz subchannel of the 480 MHz channel bandwidth includes [−3060:16:−2820, −2812:16:−2572, −2564, −2556, −2548:16:−2308, −2300:16:−2060]. In some examples, a second subset of subcarrier indices that provide feedback for a second 80 MHz subchannel of the 480 MHz channel bandwidth includes [−2036:16:−1796, −1788:16:−1548, −1540, −1532, −1524:16:−1284, −1276:16:−1036]. In some examples, a third subset of subcarrier indices that provide feedback for a third 80 MHz subchannel of the 480 MHz channel bandwidth includes [−1012:16:−772, −764:16:−524, −516, −508, −500:16:−260, −252:16:−12]. In some examples, a fourth subset of subcarrier indices that provide feedback for a fourth 80 MHz subchannel of the 480 MHz channel bandwidth includes [12:16:252, 260:16:500, 508, 516, 524:16:764, 772:16:1012]. In some examples, a fifth subset of subcarrier indices that provide feedback for a fifth 80 MHz subchannel of the 480 MHz channel bandwidth includes [1036:16:1276, 1284:16:1524, 1532, 1540, 1548:16:1788, 1796:16:2036]. In some examples, a sixth subset of subcarrier indices that provide feedback for a sixth 80 MHz subchannel of the 480 MHz channel bandwidth includes [2060:16:2300, 2308:16:2548, 2556, 2564, 2572:16:2812, 2820:16:3060].

In some examples, the channel bandwidth is 640 MHz. In some examples, the NDPA frame indicates that feedback is requested in accordance with 996 tone resource units. In some examples, the grouping value is 16. In some examples, a first subset of subcarrier indices that provide feedback for a first 80 MHz subchannel of the 640 MHz channel bandwidth includes [−4084:16:−3844, −3836:16:−3596, −3588, −3580, −3572:16:−3332, −3324:16:−3084]. In some examples, a second subset of subcarrier indices that provide feedback for a second 80 MHz subchannel of the 640 MHz channel bandwidth includes [−3060:16:−2820, −2812:16:−2572, −2564, −2556, −2548:16:−2308, −2300:16:−2060]. In some examples, a third subset of subcarrier indices that provide feedback for a third 80 MHz subchannel of the 640 MHz channel bandwidth includes [−2036:16:−1796, −1788:16:−1548, −1540, −1532, −1524:16:−1284, −1276:16:−1036]. In some examples, a fourth subset of subcarrier indices that provide feedback for a fourth 80 MHz subchannel of the 640 MHz channel bandwidth includes [−1012:16:−772, −764:16:−524, −516, −508, −500:16:−260, −252:16:−12]. In some examples, a fifth subset of subcarrier indices that provide feedback for a fifth 80 MHz subchannel of the 640 MHz channel bandwidth includes [12:16:252, 260:16:500, 508, 516, 524:16:764, 772:16:1012]. In some examples, a sixth subset of subcarrier indices that provide feedback for a sixth 80 MHz subchannel of the 640 MHz channel bandwidth includes [1036:16:1276, 1284:16:1524, 1532, 1540, 1548:16:1788, 1796:16:2036]. In some examples, a seventh subset of subcarrier indices that provide feedback for a seventh 80 MHz subchannel of the 640 MHz channel bandwidth includes [2060:16:2300, 2308:16:2548, 2556, 2564, 2572:16:2812, 2820:16:3060]. In some examples, an eighth subset of subcarrier indices that provide feedback for an eighth 80 MHz subchannel of the 640 MHz channel bandwidth includes [3084:16:3324, 3332:16:3572, 3580, 3588, 3596:16:3836, 3844:16:4084].

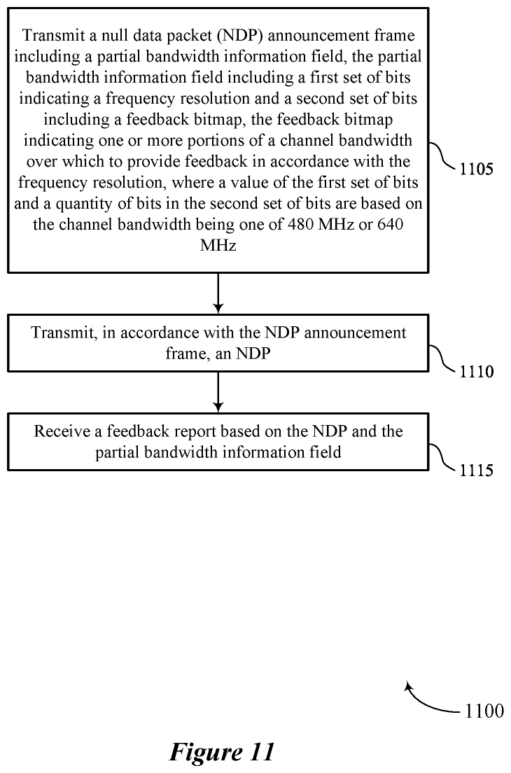

FIG. 10 shows a flowchart illustrating a method 1000 that supports partial bandwidth feedback for 480 and 640 MHz transmission in Wi-Fi in accordance with one or more aspects of the present disclosure. The operations of the method 1000 may be implemented by a STA or an AP or its components as described herein. For example, the operations of the method 1000 may be performed by a STA or an AP as described with reference to FIGS. 2 through 9. In some examples, a STA or an AP may execute a set of instructions to control the functional elements of the wireless STA or the wireless AP to perform the described functions. Additionally, or alternatively, the wireless STA or the wireless AP may perform aspects of the described functions using special-purpose hardware.

In some examples, in block 1005, the wireless STA or the wireless AP may receive an NDPA frame including a partial bandwidth information field, the partial bandwidth information field including a first set of bits indicating a frequency resolution and a second set of bits including a feedback bitmap, the feedback bitmap indicating one or more portions of a channel bandwidth over which to provide feedback in accordance with the frequency resolution, where a value of the first set of bits and a quantity of bits in the second set of bits are based on the channel bandwidth being one of 480 MHz or 640 MHz. The operations of block 1005 may be performed in accordance with examples as disclosed herein, such as the reception of an NDPA frame 506 of FIG. 5. In some implementations, aspects of the operations of block 1005 may be performed by an NDP announcement frame reception manager 925 as described with reference to FIG. 9.

In some examples, in block 1010, the wireless STA or the wireless AP may receive, in accordance with the NDPA frame, an NDP. The operations of block 1010 may be performed in accordance with examples as disclosed herein, such as the reception of an NDP 508 of FIG. 5. In some implementations, aspects of the operations of block 1010 may be performed by an NDP reception manager 930 as described with reference to FIG. 9.

In some examples, in block 1015, the wireless STA or the wireless AP may transmit a feedback report based on the NDP and the partial bandwidth information field. The operations of block 1015 may be performed in accordance with examples as disclosed herein, such as the transmission of a feedback report 510 of FIG. 5. In some implementations, aspects of the operations of block 1015 may be performed by a feedback report transmission manager 935 as described with reference to FIG. 9.

FIG. 11 shows a flowchart illustrating a method 1100 that supports partial bandwidth feedback for 480 and 640 MHz transmission in Wi-Fi in accordance with one or more aspects of the present disclosure. The operations of the method 1100 may be implemented by a STA or an AP or its components as described herein. For example, the operations of the method 1100 may be performed by a STA or an AP as described with reference to FIGS. 2 through 9. In some examples, a STA or an AP may execute a set of instructions to control the functional elements of the wireless STA or the wireless AP to perform the described functions. Additionally, or alternatively, the wireless STA or the wireless AP may perform aspects of the described functions using special-purpose hardware.

In some examples, in block 1105, the wireless STA or the wireless AP may transmit an NDPA frame including a partial bandwidth information field, the partial bandwidth information field including a first set of bits indicating a frequency resolution and a second set of bits including a feedback bitmap, the feedback bitmap indicating one or more portions of a channel bandwidth over which to provide feedback in accordance with the frequency resolution, where a value of the first set of bits and a quantity of bits in the second set of bits are based on the channel bandwidth being one of 480 MHz or 640 MHz. The operations of block 1105 may be performed in accordance with examples as disclosed herein, such as the transmission of an NDPA frame 506 of FIG. 5. In some implementations, aspects of the operations of block 1105 may be performed by an NDP announcement frame transmission manager 940 as described with reference to FIG. 9.

In some examples, in block 1110, the wireless STA or the wireless AP may transmit, in accordance with the NDPA frame, an NDP. The operations of block 1110 may be performed in accordance with examples as disclosed herein, such as the transmission of an NDP 508 of FIG. 5. In some implementations, aspects of the operations of block 1110 may be performed by an NDP transmission manager 945 as described with reference to FIG. 9.

In some examples, in block 1115, the wireless STA or the wireless AP may receive a feedback report based on the NDP and the partial bandwidth information field. The operations of block 1115 may be performed in accordance with examples as disclosed herein, such as the reception of a feedback report 510 of FIG. 5. In some implementations, aspects of the operations of block 1115 may be performed by a feedback report reception manager 950 as described with reference to FIG. 9.

Implementation examples are described in the following numbered clauses:

Clause 1: A method for wireless communications by a wireless communications device, including: receiving an NDPA frame including a partial bandwidth information field, the partial bandwidth information field including a first set of bits of indicating a frequency resolution and a second set of bits including a feedback bitmap, the feedback bitmap indicating one or more portions of a channel bandwidth over which to provide feedback in accordance with the frequency resolution, where a value of the first set of bits and a quantity of bits in the second set of bits are based at least in part on the channel bandwidth being one of 480 MHz or 640 MHz; receiving, in accordance with the NDPA frame, an NDP; and transmitting a feedback report based at least in part on the NDP and the partial bandwidth information field.

Clause 2: The method of clause 1, where the channel bandwidth is 480 MHz, the first set of bits includes one bit and indicates that the frequency resolution is 40 MHz, and the feedback bitmap includes 12 bits.

Clause 3: The method of clause 1, where the channel bandwidth is 480 MHz, the first set of bits includes two bits and indicates that the frequency resolution is 80 MHz, and the feedback bitmap includes 6 bits.

Clause 4: The method of clause 1, where the channel bandwidth is 640 MHz, the first set of bits includes one bit and indicates that the frequency resolution is 40 MHz, and the feedback bitmap includes 16 bits.

Clause 5: The method of clause 1, where the channel bandwidth is 640 MHz, the first set of bits includes two bits and indicates that the frequency resolution is 80 MHz, and the feedback bitmap includes 8 bits.

Clause 6: The method of any of clauses 1 through 5, where transmitting the feedback report includes: transmitting feedback indexed by a set of subcarrier indices, where the set of subcarrier indices ranges from −3060 to 3060 for a 480 MHz channel bandwidth and −4084 to 4048 for a 640 MHz channel bandwidth, where subcarrier indices included in the set of subcarrier indices are based on a grouping value, where the NDPA frame includes a grouping field that indicates the grouping value.

Clause 7: The method of clause 6, where the channel bandwidth is 480 MHz, the NDPA frame indicates that feedback is requested in accordance with 242 tone resource units, a first subset of subcarrier indices that provide feedback for a first 20 MHz subchannel of the 480 MHz channel bandwidth includes [−3060:Ng:−2820], a second subset of subcarrier indices that provide feedback for a second 20 MHz subchannel of the 480 MHz channel bandwidth includes [−2812:Ng:−2572], a third subset of subcarrier indices that provide feedback for a third 20 MHz subchannel of the 480 MHz channel bandwidth includes [−2548:Ng:−2308], a fourth subset of subcarrier indices that provide feedback for a fourth 20 MHz subchannel of the 480 MHz channel bandwidth includes [−2300:Ng:−2060], a fifth subset of subcarrier indices that provide feedback for a fifth 20 MHz subchannel of the 480 MHz channel bandwidth includes [−2036:Ng: −1796], a sixth subset of subcarrier indices that provide feedback for a sixth 20 MHz subchannel of the 480 MHz channel bandwidth includes [−1788:Ng: −1548], a seventh subset of subcarrier indices that provide feedback for a seventh 20 MHz subchannel of the 480 MHz channel bandwidth includes [−1524:Ng: −1284], an eighth subset of subcarrier indices that provide feedback for an eighth 20 MHz subchannel of the 480 MHz channel bandwidth includes [−1276:Ng: −1036], a ninth subset of subcarrier indices that provide feedback for a ninth 20 MHz subchannel of the 480 MHz channel bandwidth includes [−1012:Ng: −772], a tenth subset of subcarrier indices that provide feedback for a tenth 20 MHz subchannel of the 480 MHz channel bandwidth includes [−764:Ng: −524], an eleventh subset of subcarrier indices that provide feedback for an eleventh 20 MHz subchannel of the 480 MHz channel bandwidth includes [−500:Ng: −260], a twelfth subset of subcarrier indices that provide feedback for a twelfth 20 MHz subchannel of the 480 MHz channel bandwidth includes [−252:Ng:−12], a thirteenth subset of subcarrier indices that provide feedback for a thirteenth 20 MHz subchannel of the 480 MHz channel bandwidth includes [12:Ng:252], a fourteenth subset of subcarrier indices that provide feedback for a fourteenth 20 MHz subchannel of the 480 MHz channel bandwidth includes [260:Ng:500], a fifteenth subset of subcarrier indices that provide feedback for a fifteenth 20 MHz subchannel of the 480 MHz channel bandwidth includes [524:Ng:764], a sixteenth subset of subcarrier indices that provide feedback for a sixteenth 20 MHz subchannel of the 480 MHz channel bandwidth includes [772:Ng:1012], a seventeenth subset of subcarrier indices that provide feedback for a seventeenth 20 MHz subchannel of the 480 MHz channel bandwidth includes [1036:Ng: 1276], an eighteenth subset of subcarrier indices that provide feedback for an eighteenth 20 MHz subchannel of the 480 MHz channel bandwidth includes [1284:Ng: 1524], a nineteenth subset of subcarrier indices that provide feedback for a nineteenth 20 MHz subchannel of the 480 MHz channel bandwidth includes [1548:Ng: 1788], a twentieth subset of subcarrier indices that provide feedback for a twentieth 20 MHz subchannel of the 480 MHz channel bandwidth includes [1796:Ng: 2036], a twenty-first subset of subcarrier indices that provide feedback for a twenty-first 20 MHz subchannel of the 480 MHz channel bandwidth includes [2060:Ng:2300], a twenty-second subset of subcarrier indices that provide feedback for a twenty-second 20 MHz subchannel of the 480 MHz channel bandwidth includes [2308:Ng:2548], a twenty-third subset of subcarrier indices that provide feedback for a twenty-third 20 MHz subchannel of the 480 MHz channel bandwidth includes [2572:Ng:2812], a twenty-fourth subset of subcarrier indices that provide feedback for a twenty-fourth 20 MHz subchannel of the 480 MHz channel bandwidth includes [2820:Ng:3060], and Ng is equal to the grouping value.

Clause 8: The method of clause 6, where the channel bandwidth is 640 MHz, the NDPA frame indicates that feedback is requested in accordance with 242 tone resource units, a first subset of subcarrier indices that provide feedback for a first 20 MHz subchannel of the 640 MHz channel bandwidth includes [−4084:Ng:−3844], a second subset of subcarrier indices that provide feedback for a second 20 MHz subchannel of the 640 MHz channel bandwidth includes [−3836:Ng:−3596], a third subset of subcarrier indices that provide feedback for a third 20 MHz subchannel of the 640 MHz channel bandwidth includes [−3572:Ng:−3332], a fourth subset of subcarrier indices that provide feedback for a fourth 20 MHz subchannel of the 640 MHz channel bandwidth includes [−3324:Ng:−3084], a fifth subset of subcarrier indices that provide feedback for a fifth 20 MHz subchannel of the 640 MHz channel bandwidth includes [−3060:Ng:−2820], a sixth subset of subcarrier indices that provide feedback for a sixth 20 MHz subchannel of the 640 MHz channel bandwidth includes [−2812:Ng:−2572], a seventh subset of subcarrier indices that provide feedback for a seventh 20 MHz subchannel of the 640 MHz channel bandwidth includes [−2548:Ng:−2308], an eighth subset of subcarrier indices that provide feedback for an eighth 20 MHz subchannel of the 640 MHz channel bandwidth includes [−2300:Ng:−2060], a ninth subset of subcarrier indices that provide feedback for a ninth 20 MHz subchannel of the 640 MHz channel bandwidth includes [−2036:Ng: −1796], a tenth subset of subcarrier indices that provide feedback for a tenth 20 MHz subchannel of the 640 MHz channel bandwidth includes [−1788:Ng: −1548], an eleventh subset of subcarrier indices that provide feedback for an eleventh 20 MHz subchannel of the 640 MHz channel bandwidth includes [−1524:Ng: −1284], a twelfth subset of subcarrier indices that provide feedback for a twelfth 20 MHz subchannel of the 640 MHz channel bandwidth includes [−1276:Ng: −1036], a thirteenth subset of subcarrier indices that provide feedback for a thirteenth 20 MHz subchannel of the 640 MHz channel bandwidth includes [−1012:Ng: −772], a fourteenth subset of subcarrier indices that provide feedback for a fourteenth 20 MHz subchannel of the 640 MHz channel bandwidth includes [−764:Ng: −524], a fifteenth subset of subcarrier indices that provide feedback for a fifteenth 20 MHz subchannel of the 640 MHz channel bandwidth includes [−500:Ng: −260], a sixteenth subset of subcarrier indices that provide feedback for a sixteenth 20 MHz subchannel of the 640 MHz channel bandwidth includes [−252:Ng:−12], a seventeenth subset of subcarrier indices that provide feedback for a seventeenth 20 MHz subchannel of the 640 MHz channel bandwidth includes [12:Ng:252], an eighteenth subset of subcarrier indices that provide feedback for an eighteenth 20 MHz subchannel of the 640 MHz channel bandwidth includes [260:Ng:500], a nineteenth subset of subcarrier indices that provide feedback for a nineteenth 20 MHz subchannel of the 640 MHz channel bandwidth includes [524:Ng:764], a twentieth subset of subcarrier indices that provide feedback for a twentieth 20 MHz subchannel of the 640 MHz channel bandwidth includes [772:Ng:1012], a twenty-first subset of subcarrier indices that provide feedback for a twenty-first 20 MHz subchannel of the 640 MHz channel bandwidth includes [1036:Ng: 1276], a twenty-second subset of subcarrier indices that provide feedback for a twenty-second 20 MHz subchannel of the 640 MHz channel bandwidth includes [1284:Ng: 1524], a twenty-third subset of subcarrier indices that provide feedback for a twenty-third 20 MHz subchannel of the 640 MHz channel bandwidth includes [1548:Ng: 1788], a twenty-fourth subset of subcarrier indices that provide feedback for a twenty-fourth 20 MHz subchannel of the 640 MHz channel bandwidth includes [1796:Ng: 2036], a twenty-fifth subset of subcarrier indices that provide feedback for a twenty-fifth 20 MHz subchannel of the 640 MHz channel bandwidth includes [2060:Ng:2300], a twenty-sixth subset of subcarrier indices that provide feedback for a twenty-sixth 20 MHz subchannel of the 640 MHz channel bandwidth includes [2308:Ng:2548], a twenty-seventh subset of subcarrier indices that provide feedback for a twenty-seventh 20 MHz subchannel of the 640 MHz channel bandwidth includes [2572:Ng:2812], a twenty-eighth subset of subcarrier indices that provide feedback for a twenty-eighth 20 MHz subchannel of the 640 MHz channel bandwidth includes [2820:Ng:3060], a twenty-ninth subset of subcarrier indices that provide feedback for a twenty-ninth 20 MHz subchannel of the 640 MHz channel bandwidth includes [3084:Ng:3324], a thirtieth subset of subcarrier indices that provide feedback for a thirtieth 20 MHz subchannel of the 640 MHz channel bandwidth includes [3332:Ng:3572], a thirty-first subset of subcarrier indices that provide feedback for a thirty-first 20 MHz subchannel of the 640 MHz channel bandwidth includes [3596:Ng:3836], a thirty-second subset of subcarrier indices that provide feedback for a thirty-second 20 MHz subchannel of the 640 MHz channel bandwidth includes [3844:Ng:4084], and Ng is equal to the grouping value.

Clause 9: The method of clause 6, where the channel bandwidth is 480 MHz, the NDPA frame indicates that feedback is requested in accordance with 996 tone resource units, the grouping value is 4, a first subset of subcarrier indices that provide feedback for a first 80 MHz subchannel of the 480 MHz channel bandwidth includes [−3060:4:−2564, −2556:4:−2060], a second subset of subcarrier indices that provide feedback for a second 80 MHz subchannel of the 480 MHz channel bandwidth includes [−2036:4:−1540, −1532:4:−1036], a third subset of subcarrier indices that provide feedback for a third 80 MHz subchannel of the 480 MHz channel bandwidth includes [−1012:4:−516, −508:4:−12], a fourth subset of subcarrier indices that provide feedback for a fourth 80 MHz subchannel of the 480 MHz channel bandwidth includes [12:4:508, 516:4:1012], a fifth subset of subcarrier indices that provide feedback for a fifth 80 MHz subchannel of the 480 MHz channel bandwidth includes [1036:4:1532, 1540:4:2036], and a sixth subset of subcarrier indices that provide feedback for a sixth 80 MHz subchannel of the 480 MHz channel bandwidth includes [2060:4:2556, 2564:4:3060].

Clause 10: The method of clause 6, where the channel bandwidth is 640 MHz, the NDPA frame indicates that feedback is requested in accordance with 996 tone resource units, the grouping value is 4, a first subset of subcarrier indices that provide feedback for a first 80 MHz subchannel of the 640 MHz channel bandwidth includes [−4084:4:−3588, −3580:4:−3084], a second subset of subcarrier indices that provide feedback for a second 80 MHz subchannel of the 640 MHz channel bandwidth includes [−3060:4:−2564, −2556:4:−2060], a third subset of subcarrier indices that provide feedback for a third 80 MHz subchannel of the 640 MHz channel bandwidth includes [−2036:4:−1540, −1532:4:−1036], a fourth subset of subcarrier indices that provide feedback for a fourth 80 MHz subchannel of the 640 MHz channel bandwidth includes [−1012:4:−516, −508:4:−12], a fifth subset of subcarrier indices that provide feedback for a fifth 80 MHz subchannel of the 640 MHz channel bandwidth includes [12:4:508, 516:4:1012], a sixth subset of subcarrier indices that provide feedback for a sixth 80 MHz subchannel of the 640 MHz channel bandwidth includes [1036:4:1532, 1540:4:2036], a seventh subset of subcarrier indices that provide feedback for a seventh 80 MHz subchannel of the 640 MHz channel bandwidth includes [2060:4:2556, 2564:4:3060], and an eighth subset of subcarrier indices that provide feedback for an eighth 80 MHz subchannel of the 640 MHz channel bandwidth includes [3084:4:3580, 3588:4:4084].

Clause 11: The method of clause 6, where the channel bandwidth is 480 MHz, the NDPA frame indicates that feedback is requested in accordance with 996 tone resource units, the grouping value is 16, a first subset of subcarrier indices that provide feedback for a first 80 MHz subchannel of the 480 MHz channel bandwidth includes [−3060:16:−2820, −2812:16:−2572, −2564, −2556, −2548:16:−2308, −2300:16:−2060], a second subset of subcarrier indices that provide feedback for a second 80 MHz subchannel of the 480 MHz channel bandwidth includes [−2036:16:−1796, −1788:16:−1548, −1540, −1532, −1524:16:−1284, −1276:16:−1036], a third subset of subcarrier indices that provide feedback for a third 80 MHz subchannel of the 480 MHz channel bandwidth includes [−1012:16:−772, −764:16:−524, −516, −508, −500:16:−260, −252:16:−12], a fourth subset of subcarrier indices that provide feedback for a fourth 80 MHz subchannel of the 480 MHz channel bandwidth includes [12:16:252, 260:16:500, 508, 516, 524:16:764, 772:16:1012], a fifth subset of subcarrier indices that provide feedback for a fifth 80 MHz subchannel of the 480 MHz channel bandwidth includes [1036:16:1276, 1284:16:1524, 1532, 1540, 1548:16:1788, 1796:16:2036], and a sixth subset of subcarrier indices that provide feedback for a sixth 80 MHz subchannel of the 480 MHz channel bandwidth includes [2060:16:2300, 2308:16:2548, 2556, 2564, 2572:16:2812, 2820:16:3060].

Clause 12: The method of clause 6, where the channel bandwidth is 640 MHz, the NDPA frame indicates that feedback is requested in accordance with 996 tone resource units, the grouping value is 16, a first subset of subcarrier indices that provide feedback for a first 80 MHz subchannel of the 640 MHz channel bandwidth includes [−4084:16:−3844, −3836:16:−3596, −3588, −3580, −3572:16:−3332, −3324:16:−3084], a second subset of subcarrier indices that provide feedback for a second 80 MHz subchannel of the 640 MHz channel bandwidth includes [−3060:16:−2820, −2812:16:−2572, −2564, −2556, −2548:16:−2308, −2300:16:−2060], a third subset of subcarrier indices that provide feedback for a third 80 MHz subchannel of the 640 MHz channel bandwidth includes [−2036:16:−1796, −1788:16:−1548, −1540, −1532, −1524:16:−1284, −1276:16:−1036], a fourth subset of subcarrier indices that provide feedback for a fourth 80 MHz subchannel of the 640 MHz channel bandwidth includes [−1012:16:−772, −764:16:−524, −516, −508, −500:16:−260, −252:16:−12], a fifth subset of subcarrier indices that provide feedback for a fifth 80 MHz subchannel of the 640 MHz channel bandwidth includes [12:16:252, 260:16:500, 508, 516, 524:16:764, 772:16:1012], a sixth subset of subcarrier indices that provide feedback for a sixth 80 MHz subchannel of the 640 MHz channel bandwidth includes [1036:16:1276, 1284:16:1524, 1532, 1540, 1548:16:1788, 1796:16:2036], a seventh subset of subcarrier indices that provide feedback for a seventh 80 MHz subchannel of the 640 MHz channel bandwidth includes [2060:16:2300, 2308:16:2548, 2556, 2564, 2572:16:2812, 2820:16:3060], and an eighth subset of subcarrier indices that provide feedback for an eighth 80 MHz subchannel of the 640 MHz channel bandwidth includes [3084:16:3324, 3332:16:3572, 3580, 3588, 3596:16:3836, 3844:16:4084].

Clause 13: A method for wireless communications wireless communications device, including: transmitting an NDPA frame including a partial bandwidth information field, the partial bandwidth information field including a first set of bits of indicating a frequency resolution and a second set of bits including a feedback bitmap, the feedback bitmap indicating one or more portions of a channel bandwidth over which to provide feedback in accordance with the frequency resolution, where a value of the first set of bits and a quantity of bits in the second set of bits are based at least in part on the channel bandwidth being one of 480 MHz or 640 MHz; transmitting, in accordance with the NDPA frame, an NDP; and receiving a feedback report based at least in part on the NDP and the partial bandwidth information field.

Clause 14: The method of clause 13, where the channel bandwidth is 480 MHz, the first set of bits includes one bit and indicates that the frequency resolution is 40 MHz, and the feedback bitmap includes 12 bits.

Clause 15: The method of clause 13, where the channel bandwidth is 480 MHz, the first set of bits includes two bits and indicates that the frequency resolution is 80 MHz, and the feedback bitmap includes 6 bits.

Clause 16: The method of clause 13, where the channel bandwidth is 640 MHz, the first set of bits includes one bit and indicates that the frequency resolution is 40 MHz, and the feedback bitmap includes 16 bits.

Clause 17: The method of clause 13, where the channel bandwidth is 640 MHz, the first set of bits includes two bits and indicates that the frequency resolution is 80 MHz, and the feedback bitmap includes 8 bits.

Clause 18: The method of any of clauses 13 through 17, where receiving the feedback report includes: receiving feedback indexed by a set of subcarrier indices, where the set of subcarrier indices ranges from −3060 to 3060 for a 480 MHz channel bandwidth and −4084 to 4048 for a 640 MHz channel bandwidth, where subcarrier indices included in the set of subcarrier indices are based on a grouping value, where the NDPA frame includes a grouping field that indicates the grouping value.

Clause 19: The method of clause 18, where the channel bandwidth is 480 MHz, the NDPA frame indicates that feedback is requested in accordance with 242 tone resource units, a first subset of subcarrier indices that provide feedback for a first 20 MHz subchannel of the 480 MHz channel bandwidth includes [−3060:Ng:−2820], a second subset of subcarrier indices that provide feedback for a second 20 MHz subchannel of the 480 MHz channel bandwidth includes [−2812:Ng:−2572], a third subset of subcarrier indices that provide feedback for a third 20 MHz subchannel of the 480 MHz channel bandwidth includes [−2548:Ng:−2308], a fourth subset of subcarrier indices that provide feedback for a fourth 20 MHz subchannel of the 480 MHz channel bandwidth includes [−2300:Ng:−2060], a fifth subset of subcarrier indices that provide feedback for a fifth 20 MHz subchannel of the 480 MHz channel bandwidth includes [−2036:Ng: −1796], a sixth subset of subcarrier indices that provide feedback for a sixth 20 MHz subchannel of the 480 MHz channel bandwidth includes [−1788:Ng: −1548], a seventh subset of subcarrier indices that provide feedback for a seventh 20 MHz subchannel of the 480 MHz channel bandwidth includes [−1524:Ng: −1284], an eighth subset of subcarrier indices that provide feedback for an eighth 20 MHz subchannel of the 480 MHz channel bandwidth includes [−1276:Ng: −1036], a ninth subset of subcarrier indices that provide feedback for a ninth 20 MHz subchannel of the 480 MHz channel bandwidth includes [−1012:Ng: −772], a tenth subset of subcarrier indices that provide feedback for a tenth 20 MHz subchannel of the 480 MHz channel bandwidth includes [−764:Ng: −524], an eleventh subset of subcarrier indices that provide feedback for an eleventh 20 MHz subchannel of the 480 MHz channel bandwidth includes [−500:Ng: −260], a twelfth subset of subcarrier indices that provide feedback for a twelfth 20 MHz subchannel of the 480 MHz channel bandwidth includes [−252:Ng:−12], a thirteenth subset of subcarrier indices that provide feedback for a thirteenth 20 MHz subchannel of the 480 MHz channel bandwidth includes [12:Ng:252], a fourteenth subset of subcarrier indices that provide feedback for a fourteenth 20 MHz subchannel of the 480 MHz channel bandwidth includes [260:Ng:500], a fifteenth subset of subcarrier indices that provide feedback for a fifteenth 20 MHz subchannel of the 480 MHz channel bandwidth includes [524:Ng:764], a sixteenth subset of subcarrier indices that provide feedback for a sixteenth 20 MHz subchannel of the 480 MHz channel bandwidth includes [772:Ng:1012], a seventeenth subset of subcarrier indices that provide feedback for a seventeenth 20 MHz subchannel of the 480 MHz channel bandwidth includes [1036:Ng: 1276], an eighteenth subset of subcarrier indices that provide feedback for an eighteenth 20 MHz subchannel of the 480 MHz channel bandwidth includes [1284:Ng: 1524], a nineteenth subset of subcarrier indices that provide feedback for a nineteenth 20 MHz subchannel of the 480 MHz channel bandwidth includes [1548:Ng: 1788], a twentieth subset of subcarrier indices that provide feedback for a twentieth 20 MHz subchannel of the 480 MHz channel bandwidth includes [1796:Ng: 2036], a twenty-first subset of subcarrier indices that provide feedback for a twenty-first 20 MHz subchannel of the 480 MHz channel bandwidth includes [2060:Ng:2300], a twenty-second subset of subcarrier indices that provide feedback for a twenty-second 20 MHz subchannel of the 480 MHz channel bandwidth includes [2308:Ng:2548], a twenty-third subset of subcarrier indices that provide feedback for a twenty-third 20 MHz subchannel of the 480 MHz channel bandwidth includes [2572:Ng:2812], a twenty-fourth subset of subcarrier indices that provide feedback for a twenty-fourth 20 MHz subchannel of the 480 MHz channel bandwidth includes [2820:Ng:3060], and Ng is equal to the grouping value.

Clause 20: The method of clause 18, where the channel bandwidth is 640 MHz, the NDPA frame indicates that feedback is requested in accordance with 242 tone resource units, a first subset of subcarrier indices that provide feedback for a first 20 MHz subchannel of the 640 MHz channel bandwidth includes [−4084:Ng:−3844], a second subset of subcarrier indices that provide feedback for a second 20 MHz subchannel of the 640 MHz channel bandwidth includes [−3836:Ng:−3596], a third subset of subcarrier indices that provide feedback for a third 20 MHz subchannel of the 640 MHz channel bandwidth includes [−3572:Ng:−3332], a fourth subset of subcarrier indices that provide feedback for a fourth 20 MHz subchannel of the 640 MHz channel bandwidth includes [−3324:Ng:−3084], a fifth subset of subcarrier indices that provide feedback for a fifth 20 MHz subchannel of the 640 MHz channel bandwidth includes [−3060:Ng:−2820], a sixth subset of subcarrier indices that provide feedback for a sixth 20 MHz subchannel of the 640 MHz channel bandwidth includes [−2812:Ng:−2572], a seventh subset of subcarrier indices that provide feedback for a seventh 20 MHz subchannel of the 640 MHz channel bandwidth includes [−2548:Ng:−2308], an eighth subset of subcarrier indices that provide feedback for an eighth 20 MHz subchannel of the 640 MHz channel bandwidth includes [−2300:Ng:−2060], a ninth subset of subcarrier indices that provide feedback for a ninth 20 MHz subchannel of the 640 MHz channel bandwidth includes [−2036:Ng: −1796], a tenth subset of subcarrier indices that provide feedback for a tenth 20 MHz subchannel of the 640 MHz channel bandwidth includes [−1788:Ng: −1548], an eleventh subset of subcarrier indices that provide feedback for an eleventh 20 MHz subchannel of the 640 MHz channel bandwidth includes [−1524:Ng: −1284], a twelfth subset of subcarrier indices that provide feedback for a twelfth 20 MHz subchannel of the 640 MHz channel bandwidth includes [−1276:Ng: −1036], a thirteenth subset of subcarrier indices that provide feedback for a thirteenth 20 MHz subchannel of the 640 MHz channel bandwidth includes [−1012:Ng: −772], a fourteenth subset of subcarrier indices that provide feedback for a fourteenth 20 MHz subchannel of the 640 MHz channel bandwidth includes [−764:Ng: −524], a fifteenth subset of subcarrier indices that provide feedback for a fifteenth 20 MHz subchannel of the 640 MHz channel bandwidth includes [−500:Ng: −260], a sixteenth subset of subcarrier indices that provide feedback for a sixteenth 20 MHz subchannel of the 640 MHz channel bandwidth includes [−252:Ng:−12], a seventeenth subset of subcarrier indices that provide feedback for a seventeenth 20 MHz subchannel of the 640 MHz channel bandwidth includes [12:Ng:252], an eighteenth subset of subcarrier indices that provide feedback for an eighteenth 20 MHz subchannel of the 640 MHz channel bandwidth includes [260:Ng:500], a nineteenth subset of subcarrier indices that provide feedback for a nineteenth 20 MHz subchannel of the 640 MHz channel bandwidth includes [524:Ng:764], a twentieth subset of subcarrier indices that provide feedback for a twentieth 20 MHz subchannel of the 640 MHz channel bandwidth includes [772:Ng:1012], a twenty-first subset of subcarrier indices that provide feedback for a twenty-first 20 MHz subchannel of the 640 MHz channel bandwidth includes [1036:Ng: 1276], a twenty-second subset of subcarrier indices that provide feedback for a twenty-second 20 MHz subchannel of the 640 MHz channel bandwidth includes [1284:Ng: 1524], a twenty-third subset of subcarrier indices that provide feedback for a twenty-third 20 MHz subchannel of the 640 MHz channel bandwidth includes [1548:Ng: 1788], a twenty-fourth subset of subcarrier indices that provide feedback for a twenty-fourth 20 MHz subchannel of the 640 MHz channel bandwidth includes [1796:Ng: 2036], a twenty-fifth subset of subcarrier indices that provide feedback for a twenty-fifth 20 MHz subchannel of the 640 MHz channel bandwidth includes [2060:Ng:2300], a twenty-sixth subset of subcarrier indices that provide feedback for a twenty-sixth 20 MHz subchannel of the 640 MHz channel bandwidth includes [2308:Ng:2548], a twenty-seventh subset of subcarrier indices that provide feedback for a twenty-seventh 20 MHz subchannel of the 640 MHz channel bandwidth includes [2572:Ng:2812], a twenty-eighth subset of subcarrier indices that provide feedback for a twenty-eighth 20 MHz subchannel of the 640 MHz channel bandwidth includes [2820:Ng:3060], a twenty-ninth subset of subcarrier indices that provide feedback for a twenty-ninth 20 MHz subchannel of the 640 MHz channel bandwidth includes [3084:Ng:3324], a thirtieth subset of subcarrier indices that provide feedback for a thirtieth 20 MHz subchannel of the 640 MHz channel bandwidth includes [3332:Ng:3572], a thirty-first subset of subcarrier indices that provide feedback for a thirty-first 20 MHz subchannel of the 640 MHz channel bandwidth includes [3596:Ng:3836], a thirty-second subset of subcarrier indices that provide feedback for a thirty-second 20 MHz subchannel of the 640 MHz channel bandwidth includes [3844:Ng:4084], and Ng is equal to the grouping value.

Clause 21: The method of clause 18, where the channel bandwidth is 480 MHz, the NDPA frame indicates that feedback is requested in accordance with 996 tone resource units, the grouping value is 4, a first subset of subcarrier indices that provide feedback for a first 80 MHz subchannel of the 480 MHz channel bandwidth includes [−3060:4:−2564, −2556:4:−2060], a second subset of subcarrier indices that provide feedback for a second 80 MHz subchannel of the 480 MHz channel bandwidth includes [−2036:4:−1540, −1532:4:−1036], a third subset of subcarrier indices that provide feedback for a third 80 MHz subchannel of the 480 MHz channel bandwidth includes [−1012:4:−516, −508:4:−12], a fourth subset of subcarrier indices that provide feedback for a fourth 80 MHz subchannel of the 480 MHz channel bandwidth includes [12:4:508, 516:4:1012], a fifth subset of subcarrier indices that provide feedback for a fifth 80 MHz subchannel of the 480 MHz channel bandwidth includes [1036:4:1532, 1540:4:2036], and a sixth subset of subcarrier indices that provide feedback for a sixth 80 MHz subchannel of the 480 MHz channel bandwidth includes [2060:4:2556, 2564:4:3060].

Clause 22: The method of clause 18, where the channel bandwidth is 640 MHz, the NDPA frame indicates that feedback is requested in accordance with 996 tone resource units, the grouping value is 4, a first subset of subcarrier indices that provide feedback for a first 80 MHz subchannel of the 640 MHz channel bandwidth includes [−4084:4:−3588, −3580:4:−3084], a second subset of subcarrier indices that provide feedback for a second 80 MHz subchannel of the 640 MHz channel bandwidth includes [−3060:4:−2564, −2556:4:−2060], a third subset of subcarrier indices that provide feedback for a third 80 MHz subchannel of the 640 MHz channel bandwidth includes [−2036:4:−1540, −1532:4:−1036], a fourth subset of subcarrier indices that provide feedback for a fourth 80 MHz subchannel of the 640 MHz channel bandwidth includes [−1012:4:−516, −508:4:−12], a fifth subset of subcarrier indices that provide feedback for a fifth 80 MHz subchannel of the 640 MHz channel bandwidth includes [12:4:508, 516:4:1012], a sixth subset of subcarrier indices that provide feedback for a sixth 80 MHz subchannel of the 640 MHz channel bandwidth includes [1036:4:1532, 1540:4:2036], a seventh subset of subcarrier indices that provide feedback for a seventh 80 MHz subchannel of the 640 MHz channel bandwidth includes [2060:4:2556, 2564:4:3060], and an eighth subset of subcarrier indices that provide feedback for an eighth 80 MHz subchannel of the 640 MHz channel bandwidth includes [3084:4:3580, 3588:4:4084].

Clause 23: The method of clause 18, where the channel bandwidth is 480 MHz, the NDPA frame indicates that feedback is requested in accordance with 996 tone resource units, the grouping value is 16, a first subset of subcarrier indices that provide feedback for a first 80 MHz subchannel of the 480 MHz channel bandwidth includes [−3060:16:−2820, −2812:16:−2572, −2564, −2556, −2548:16:−2308, −2300:16:−2060], a second subset of subcarrier indices that provide feedback for a second 80 MHz subchannel of the 480 MHz channel bandwidth includes [−2036:16:−1796, −1788:16:−1548, −1540, −1532, −1524:16:−1284, −1276:16:−1036], a third subset of subcarrier indices that provide feedback for a third 80 MHz subchannel of the 480 MHz channel bandwidth includes [−1012:16:−772, −764:16:−524, −516, −508, −500:16:−260, −252:16:−12], a fourth subset of subcarrier indices that provide feedback for a fourth 80 MHz subchannel of the 480 MHz channel bandwidth includes [12:16:252, 260:16:500, 508, 516, 524:16:764, 772:16:1012], a fifth subset of subcarrier indices that provide feedback for a fifth 80 MHz subchannel of the 480 MHz channel bandwidth includes [1036:16:1276, 1284:16:1524, 1532, 1540, 1548:16:1788, 1796:16:2036], and a sixth subset of subcarrier indices that provide feedback for a sixth 80 MHz subchannel of the 480 MHz channel bandwidth includes [2060:16:2300, 2308:16:2548, 2556, 2564, 2572:16:2812, 2820:16:3060].

Clause 24: The method of clause 18, where the channel bandwidth is 640 MHz, the NDPA frame indicates that feedback is requested in accordance with 996 tone resource units, the grouping value is 16, a first subset of subcarrier indices that provide feedback for a first 80 MHz subchannel of the 640 MHz channel bandwidth includes [−4084:16:−3844, −3836:16:−3596, −3588, −3580, −3572:16:−3332, −3324:16:−3084], a second subset of subcarrier indices that provide feedback for a second 80 MHz subchannel of the 640 MHz channel bandwidth includes [−3060:16:−2820, −2812:16:−2572, −2564, −2556, −2548:16:−2308, −2300:16:−2060], a third subset of subcarrier indices that provide feedback for a third 80 MHz subchannel of the 640 MHz channel bandwidth includes [−2036:16:−1796, −1788:16:−1548, −1540, −1532, −1524:16:−1284, −1276:16:−1036], a fourth subset of subcarrier indices that provide feedback for a fourth 80 MHz subchannel of the 640 MHz channel bandwidth includes [−1012:16:−772, −764:16:−524, −516, −508, −500:16:−260, −252:16:−12], a fifth subset of subcarrier indices that provide feedback for a fifth 80 MHz subchannel of the 640 MHz channel bandwidth includes [12:16:252, 260:16:500, 508, 516, 524:16:764, 772:16:1012], a sixth subset of subcarrier indices that provide feedback for a sixth 80 MHz subchannel of the 640 MHz channel bandwidth includes [1036:16:1276, 1284:16:1524, 1532, 1540, 1548:16:1788, 1796:16:2036], a seventh subset of subcarrier indices that provide feedback for a seventh 80 MHz subchannel of the 640 MHz channel bandwidth includes [2060:16:2300, 2308:16:2548, 2556, 2564, 2572:16:2812, 2820:16:3060], and an eighth subset of subcarrier indices that provide feedback for an eighth 80 MHz subchannel of the 640 MHz channel bandwidth includes [3084:16:3324, 3332:16:3572, 3580, 3588, 3596:16:3836, 3844:16:4084].

Clause 25: A wireless communications device for wireless communications, including a processing system that includes processor circuitry and memory circuitry that stores code, the processing system configured to cause the wireless communications device to perform a method of any of clauses 1 through 12.

Clause 26: A wireless communications device for wireless communications, including at least one means for performing a method of any of clauses 1 through 12.

Clause 27: A non-transitory computer-readable medium storing code for wireless communications, the code including instructions executable by a processor to perform a method of any of clauses 1 through 12.

Clause 28: A wireless communications device for wireless communications, including a processing system that includes processor circuitry and memory circuitry that stores code, the processing system configured to cause the wireless communications device to perform a method of any of clauses 13 through 24.

Clause 29: An apparatus for wireless communications wireless communications device, including at least one means for performing a method of any of clauses 13 through 24.

Clause 30: A non-transitory computer-readable medium storing code for wireless communications wireless communications device, the code including instructions executable by a processor to perform a method of any of clauses 13 through 24.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A wireless communications device, comprising:
a processing system that includes processor circuitry and memory circuitry that stores code, the processing system configured to cause the wireless communications device to:
receive a null data packet announcement frame comprising a partial bandwidth information field, the partial bandwidth information field including a first set of bits indicating a frequency resolution and a second set of bits including a feedback bitmap, the feedback bitmap indicating one or more portions of a channel bandwidth over which to provide feedback in accordance with the frequency resolution, wherein a value of the first set of bits and a quantity of bits in the second set of bits are based at least in part on the channel bandwidth being one of 480 MHz or 640 MHz;
receive, in accordance with the null data packet announcement frame, a null data packet; and
transmit a feedback report based at least in part on the null data packet and the partial bandwidth information field.

2. The wireless communications device of claim 1, wherein the channel bandwidth is 480 MHz, the first set of bits comprises one bit and indicates that the frequency resolution is 40 MHz, and the feedback bitmap comprises 12 bits.

3. The wireless communications device of claim 1, wherein the channel bandwidth is 480 MHz, the first set of bits comprises two bits and indicates that the frequency resolution is 80 MHz, and the feedback bitmap comprises 6 bits.

4. The wireless communications device of claim 1, wherein the channel bandwidth is 640 MHz, the first set of bits comprises one bit and indicates that the frequency resolution is 40 MHz, and the feedback bitmap comprises 16 bits.

5. The wireless communications device of claim 1, wherein the channel bandwidth is 640 MHz, the first set of bits comprises two bits and indicates that the frequency resolution is 80 MHz, and the feedback bitmap comprises 8 bits.

6. The wireless communications device of claim 1, wherein, to transmit the feedback report, the processing system is further configured to cause the wireless communications device to:
transmit feedback indexed by a set of subcarrier indices, wherein the set of subcarrier indices ranges from −3060 to 3060 for a 480 MHz channel bandwidth and −4084 to 4048 for a 640 MHz channel bandwidth, wherein subcarrier indices included in the set of subcarrier indices are based on a grouping value, wherein the null data packet announcement frame comprises a grouping field that indicates the grouping value.

7. The wireless communications device of claim 6, wherein:
the channel bandwidth is 480 MHz,
the null data packet announcement frame indicates that feedback is requested in accordance with 242 tone resource units,
a first subset of subcarrier indices that provide feedback for a first 20 MHz subchannel of the 480 MHz channel bandwidth includes [−3060:Ng:−2820],
a second subset of subcarrier indices that provide feedback for a second 20 MHz subchannel of the 480 MHz channel bandwidth includes [−2812:Ng:−2572],
a third subset of subcarrier indices that provide feedback for a third 20 MHz subchannel of the 480 MHz channel bandwidth includes [−2548:Ng:−2308],
a fourth subset of subcarrier indices that provide feedback for a fourth 20 MHz subchannel of the 480 MHz channel bandwidth includes [−2300:Ng:−2060],
a fifth subset of subcarrier indices that provide feedback for a fifth 20 MHz subchannel of the 480 MHz channel bandwidth includes [−2036:Ng: −1796],
a sixth subset of subcarrier indices that provide feedback for a sixth 20 MHz subchannel of the 480 MHz channel bandwidth includes [−1788:Ng: −1548],
a seventh subset of subcarrier indices that provide feedback for a seventh 20 MHz subchannel of the 480 MHz channel bandwidth includes [−1524:Ng: −1284],
an eighth subset of subcarrier indices that provide feedback for an eighth 20 MHz subchannel of the 480 MHz channel bandwidth includes [−1276:Ng: −1036],
a ninth subset of subcarrier indices that provide feedback for a ninth 20 MHz subchannel of the 480 MHz channel bandwidth includes [−1012:Ng: −772],
a tenth subset of subcarrier indices that provide feedback for a tenth 20 MHz subchannel of the 480 MHz channel bandwidth includes [−764:Ng: −524],
an eleventh subset of subcarrier indices that provide feedback for an eleventh 20 MHz subchannel of the 480 MHz channel bandwidth includes [−500:Ng: −260],
a twelfth subset of subcarrier indices that provide feedback for a twelfth 20 MHz subchannel of the 480 MHz channel bandwidth includes [−252:Ng:−12],
a thirteenth subset of subcarrier indices that provide feedback for a thirteenth 20 MHz subchannel of the 480 MHz channel bandwidth includes [12:Ng:252],
a fourteenth subset of subcarrier indices that provide feedback for a fourteenth 20 MHz subchannel of the 480 MHz channel bandwidth includes [260:Ng:500],
a fifteenth subset of subcarrier indices that provide feedback for a fifteenth 20 MHz subchannel of the 480 MHz channel bandwidth includes [524:Ng:764],
a sixteenth subset of subcarrier indices that provide feedback for a sixteenth 20 MHz subchannel of the 480 MHz channel bandwidth includes [772:Ng:1012],
a seventeenth subset of subcarrier indices that provide feedback for a seventeenth 20 MHz subchannel of the 480 MHz channel bandwidth includes [1036:Ng: 1276],
an eighteenth subset of subcarrier indices that provide feedback for an eighteenth 20 MHz subchannel of the 480 MHz channel bandwidth includes [1284:Ng: 1524],
a nineteenth subset of subcarrier indices that provide feedback for a nineteenth 20 MHz subchannel of the 480 MHz channel bandwidth includes [1548:Ng: 1788],
a twentieth subset of subcarrier indices that provide feedback for a twentieth 20 MHz subchannel of the 480 MHz channel bandwidth includes [1796:Ng: 2036],
a twenty-first subset of subcarrier indices that provide feedback for a twenty-first 20 MHz subchannel of the 480 MHz channel bandwidth includes [2060:Ng:2300],
a twenty-second subset of subcarrier indices that provide feedback for a twenty-second 20 MHz subchannel of the 480 MHz channel bandwidth includes [2308:Ng:2548],
a twenty-third subset of subcarrier indices that provide feedback for a twenty-third 20 MHz subchannel of the 480 MHz channel bandwidth includes [2572:Ng:2812],
a twenty-fourth subset of subcarrier indices that provide feedback for a twenty-fourth 20 MHz subchannel of the 480 MHz channel bandwidth includes [2820:Ng:3060], and
Ng is equal to the grouping value.

8. The wireless communications device of claim 6, wherein:
the channel bandwidth is 640 MHz,
the null data packet announcement frame indicates that feedback is requested in accordance with 242 tone resource units,
a first subset of subcarrier indices that provide feedback for a first 20 MHz subchannel of the 640 MHz channel bandwidth includes [−4084:Ng:−3844],
a second subset of subcarrier indices that provide feedback for a second 20 MHz subchannel of the 640 MHz channel bandwidth includes [−3836:Ng:−3596],
a third subset of subcarrier indices that provide feedback for a third 20 MHz subchannel of the 640 MHz channel bandwidth includes [−3572:Ng:−3332],
a fourth subset of subcarrier indices that provide feedback for a fourth 20 MHz subchannel of the 640 MHz channel bandwidth includes [−3324:Ng:−3084],
a fifth subset of subcarrier indices that provide feedback for a fifth 20 MHz subchannel of the 640 MHz channel bandwidth includes [−3060:Ng:−2820],
a sixth subset of subcarrier indices that provide feedback for a sixth 20 MHz subchannel of the 640 MHz channel bandwidth includes [−2812:Ng:−2572],
a seventh subset of subcarrier indices that provide feedback for a seventh 20 MHz subchannel of the 640 MHz channel bandwidth includes [−2548:Ng:−2308],
an eighth subset of subcarrier indices that provide feedback for an eighth 20 MHz subchannel of the 640 MHz channel bandwidth includes [−2300:Ng:−2060],
a ninth subset of subcarrier indices that provide feedback for a ninth 20 MHz subchannel of the 640 MHz channel bandwidth includes [−2036:Ng: −1796],
a tenth subset of subcarrier indices that provide feedback for a tenth 20 MHz subchannel of the 640 MHz channel bandwidth includes [−1788:Ng: −1548],
an eleventh subset of subcarrier indices that provide feedback for an eleventh 20 MHz subchannel of the 640 MHz channel bandwidth includes [−1524:Ng: −1284],
a twelfth subset of subcarrier indices that provide feedback for a twelfth 20 MHz subchannel of the 640 MHz channel bandwidth includes [−1276:Ng: −1036],
a thirteenth subset of subcarrier indices that provide feedback for a thirteenth 20 MHz subchannel of the 640 MHz channel bandwidth includes [−1012:Ng: −772],
a fourteenth subset of subcarrier indices that provide feedback for a fourteenth 20 MHz subchannel of the 640 MHz channel bandwidth includes [−764:Ng: −524],
a fifteenth subset of subcarrier indices that provide feedback for a fifteenth 20 MHz subchannel of the 640 MHz channel bandwidth includes [−500:Ng: −260],
a sixteenth subset of subcarrier indices that provide feedback for a sixteenth 20 MHz subchannel of the 640 MHz channel bandwidth includes [−252:Ng:−12],
a seventeenth subset of subcarrier indices that provide feedback for a seventeenth 20 MHz subchannel of the 640 MHz channel bandwidth includes [12:Ng:252],
an eighteenth subset of subcarrier indices that provide feedback for an eighteenth 20 MHz subchannel of the 640 MHz channel bandwidth includes [260:Ng:500],
a nineteenth subset of subcarrier indices that provide feedback for a nineteenth 20 MHz subchannel of the 640 MHz channel bandwidth includes [524:Ng:764],
a twentieth subset of subcarrier indices that provide feedback for a twentieth 20 MHz subchannel of the 640 MHz channel bandwidth includes [772:Ng:1012],
a twenty-first subset of subcarrier indices that provide feedback for a twenty-first 20 MHz subchannel of the 640 MHz channel bandwidth includes [1036:Ng: 1276],
a twenty-second subset of subcarrier indices that provide feedback for a twenty-second 20 MHz subchannel of the 640 MHz channel bandwidth includes [1284:Ng: 1524],
a twenty-third subset of subcarrier indices that provide feedback for a twenty-third 20 MHz subchannel of the 640 MHz channel bandwidth includes [1548:Ng: 1788],
a twenty-fourth subset of subcarrier indices that provide feedback for a twenty-fourth 20 MHz subchannel of the 640 MHz channel bandwidth includes [1796:Ng: 2036],
a twenty-fifth subset of subcarrier indices that provide feedback for a twenty-fifth 20 MHz subchannel of the 640 MHz channel bandwidth includes [2060:Ng:2300],
a twenty-sixth subset of subcarrier indices that provide feedback for a twenty-sixth 20 MHz subchannel of the 640 MHz channel bandwidth includes [2308:Ng:2548],
a twenty-seventh subset of subcarrier indices that provide feedback for a twenty-seventh 20 MHz subchannel of the 640 MHz channel bandwidth includes [2572:Ng:2812],
a twenty-eighth subset of subcarrier indices that provide feedback for a twenty-eighth 20 MHz subchannel of the 640 MHz channel bandwidth includes [2820:Ng:3060],
a twenty-ninth subset of subcarrier indices that provide feedback for a twenty-ninth 20 MHz subchannel of the 640 MHz channel bandwidth includes [3084:Ng:3324],
a thirtieth subset of subcarrier indices that provide feedback for a thirtieth 20 MHz subchannel of the 640 MHz channel bandwidth includes [3332:Ng:3572],
a thirty-first subset of subcarrier indices that provide feedback for a thirty-first 20 MHz subchannel of the 640 MHz channel bandwidth includes [3596:Ng:3836],
a thirty-second subset of subcarrier indices that provide feedback for a thirty-second 20 MHz subchannel of the 640 MHz channel bandwidth includes [3844:Ng:4084], and
Ng is equal to the grouping value.

9. The wireless communications device of claim 6, wherein:
the channel bandwidth is 480 MHz,
the null data packet announcement frame indicates that feedback is requested in accordance with 996 tone resource units,
the grouping value is 4,
a first subset of subcarrier indices that provide feedback for a first 80 MHz subchannel of the 480 MHz channel bandwidth includes [−3060:4:−2564, −2556:4:−2060],
a second subset of subcarrier indices that provide feedback for a second 80 MHz subchannel of the 480 MHz channel bandwidth includes [−2036:4:−1540, −1532:4:−1036],
a third subset of subcarrier indices that provide feedback for a third 80 MHz subchannel of the 480 MHz channel bandwidth includes [−1012:4:−516, −508:4:−12],
a fourth subset of subcarrier indices that provide feedback for a fourth 80 MHz subchannel of the 480 MHz channel bandwidth includes [12:4:508, 516:4:1012],
a fifth subset of subcarrier indices that provide feedback for a fifth 80 MHz subchannel of the 480 MHz channel bandwidth includes [1036:4:1532, 1540:4:2036], and
a sixth subset of subcarrier indices that provide feedback for a sixth 80 MHz subchannel of the 480 MHz channel bandwidth includes [2060:4:2556, 2564:4:3060].

10. The wireless communications device of claim 6, wherein:
the channel bandwidth is 640 MHz,
the null data packet announcement frame indicates that feedback is requested in accordance with 996 tone resource units,
the grouping value is 4,
a first subset of subcarrier indices that provide feedback for a first 80 MHz subchannel of the 640 MHz channel bandwidth includes [−4084:4:−3588, −3580:4:−3084],
a second subset of subcarrier indices that provide feedback for a second 80 MHz subchannel of the 640 MHz channel bandwidth includes [−3060:4:−2564, −2556:4:−2060],
a third subset of subcarrier indices that provide feedback for a third 80 MHz subchannel of the 640 MHz channel bandwidth includes [−2036:4:−1540, −1532:4:−1036],
a fourth subset of subcarrier indices that provide feedback for a fourth 80 MHz subchannel of the 640 MHz channel bandwidth includes [−1012:4:−516, −508:4:−12],
a fifth subset of subcarrier indices that provide feedback for a fifth 80 MHz subchannel of the 640 MHz channel bandwidth includes [12:4:508, 516:4:1012],
a sixth subset of subcarrier indices that provide feedback for a sixth 80 MHz subchannel of the 640 MHz channel bandwidth includes [1036:4:1532, 1540:4:2036],
a seventh subset of subcarrier indices that provide feedback for a seventh 80 MHz subchannel of the 640 MHz channel bandwidth includes [2060:4:2556, 2564:4:3060], and
an eighth subset of subcarrier indices that provide feedback for an eighth 80 MHz subchannel of the 640 MHz channel bandwidth includes [3084:4:3580, 3588:4:4084].

11. The wireless communications device of claim 6, wherein:
the channel bandwidth is 480 MHz,
the null data packet announcement frame indicates that feedback is requested in accordance with 996 tone resource units,
the grouping value is 16,
a first subset of subcarrier indices that provide feedback for a first 80 MHz subchannel of the 480 MHz channel bandwidth includes [−3060:16:−2820, −2812:16:−2572, −2564, −2556, −2548:16:−2308, −2300:16:−2060],
a second subset of subcarrier indices that provide feedback for a second 80 MHz subchannel of the 480 MHz channel bandwidth includes [−2036:16:−1796, −1788:16:−1548, −1540, −1532, −1524:16:−1284, −1276:16:−1036],
a third subset of subcarrier indices that provide feedback for a third 80 MHz subchannel of the 480 MHz channel bandwidth includes [−1012:16:−772, −764:16:−524, −516, −508, −500:16:−260, −252:16:−12],
a fourth subset of subcarrier indices that provide feedback for a fourth 80 MHz subchannel of the 480 MHz channel bandwidth includes [12:16:252, 260:16:500, 508, 516, 524:16:764, 772:16:1012],
a fifth subset of subcarrier indices that provide feedback for a fifth 80 MHz subchannel of the 480 MHz channel bandwidth includes [1036:16:1276, 1284:16:1524, 1532, 1540, 1548:16:1788, 1796:16:2036], and
a sixth subset of subcarrier indices that provide feedback for a sixth 80 MHz subchannel of the 480 MHz channel bandwidth includes [2060:16:2300, 2308:16:2548, 2556, 2564, 2572:16:2812, 2820:16:3060].

12. The wireless communications device of claim 6, wherein:
the channel bandwidth is 640 MHz,
the null data packet announcement frame indicates that feedback is requested in accordance with 996 tone resource units,
the grouping value is 16,
a first subset of subcarrier indices that provide feedback for a first 80 MHz subchannel of the 640 MHz channel bandwidth includes [−4084:16:−3844, −3836:16:−3596, −3588, −3580, −3572:16:−3332, −3324:16:−3084],
a second subset of subcarrier indices that provide feedback for a second 80 MHz subchannel of the 640 MHz channel bandwidth includes [−3060:16:−2820, −2812:16:−2572, −2564, −2556, −2548:16:−2308, −2300:16:−2060],
a third subset of subcarrier indices that provide feedback for a third 80 MHz subchannel of the 640 MHz channel bandwidth includes [−2036:16:−1796, −1788:16:−1548, −1540, −1532, −1524:16:−1284, −1276:16:−1036],
a fourth subset of subcarrier indices that provide feedback for a fourth 80 MHz subchannel of the 640 MHz channel bandwidth includes [−1012:16:−772, −764:16:−524, −516, −508, −500:16:−260, −252:16:−12],
a fifth subset of subcarrier indices that provide feedback for a fifth 80 MHz subchannel of the 640 MHz channel bandwidth includes [12:16:252, 260:16:500, 508, 516, 524:16:764, 772:16:1012],
a sixth subset of subcarrier indices that provide feedback for a sixth 80 MHz subchannel of the 640 MHz channel bandwidth includes [1036:16:1276, 1284:16:1524, 1532, 1540, 1548:16:1788, 1796:16:2036],
a seventh subset of subcarrier indices that provide feedback for a seventh 80 MHz subchannel of the 640 MHz channel bandwidth includes [2060:16:2300, 2308:16:2548, 2556, 2564, 2572:16:2812, 2820:16:3060], and
an eighth subset of subcarrier indices that provide feedback for an eighth 80 MHz subchannel of the 640 MHz channel bandwidth includes [3084:16:3324, 3332:16:3572, 3580, 3588, 3596:16:3836, 3844:16:4084].

13. An wireless communications device, comprising:
a processing system that includes processor circuitry and memory circuitry that stores code, the processing system configured to cause the wireless communications device to:
transmit a null data packet announcement frame comprising a partial bandwidth information field, the partial bandwidth information field including a first set of bits indicating a frequency resolution and a second set of bits including a feedback bitmap, the feedback bitmap indicating one or more portions of a channel bandwidth over which to provide feedback in accordance with the frequency resolution, wherein a value of the first set of bits and a quantity of bits in the second set of bits are based at least in part on the channel bandwidth being one of 480 MHz or 640 MHz;
transmit, in accordance with the null data packet announcement frame, a null data packet; and
receive a feedback report based at least in part on the null data packet and the partial bandwidth information field.

14. The wireless communications device of claim 13, wherein the channel bandwidth is 480 MHz, the first set of bits comprises one bit and indicates that the frequency resolution is 40 MHz, and the feedback bitmap comprises 12 bits.

15. The wireless communications device of claim 13, wherein the channel bandwidth is 480 MHz, the first set of bits comprises two bits and indicates that the frequency resolution is 80 MHz, and the feedback bitmap comprises 6 bits.

16. The wireless communications device of claim 13, wherein the channel bandwidth is 640 MHz, the first set of bits comprises one bit and indicates that the frequency resolution is 40 MHz, and the feedback bitmap comprises 16 bits.

17. The wireless communications device of claim 13, wherein the channel bandwidth is 640 MHz, the first set of bits comprises two bits and indicates that the frequency resolution is 80 MHz, and the feedback bitmap comprises 8 bits.

18. The wireless communications device of claim 13, wherein, to receive the feedback report, the processing system is configured to cause the wireless communications device to:
receive feedback indexed by a set of subcarrier indices, wherein the set of subcarrier indices ranges from −3060 to 3060 for a 480 MHz channel bandwidth and −4084 to 4048 for a 640 MHz channel bandwidth, wherein subcarrier indices included in the set of subcarrier indices are based on a grouping value, wherein the null data packet announcement frame comprises a grouping field that indicates the grouping value.

19. The wireless communications device of claim 18, wherein:
the channel bandwidth is 480 MHz,
the null data packet announcement frame indicates that feedback is requested in accordance with 242 tone resource units,
a first subset of subcarrier indices that provide feedback for a first 20 MHz subchannel of the 480 MHz channel bandwidth includes [−3060:Ng:−2820],
a second subset of subcarrier indices that provide feedback for a second 20 MHz subchannel of the 480 MHz channel bandwidth includes [−2812:Ng:−2572],
a third subset of subcarrier indices that provide feedback for a third 20 MHz subchannel of the 480 MHz channel bandwidth includes [−2548:Ng:−2308],
a fourth subset of subcarrier indices that provide feedback for a fourth 20 MHz subchannel of the 480 MHz channel bandwidth includes [−2300:Ng:−2060],
a fifth subset of subcarrier indices that provide feedback for a fifth 20 MHz subchannel of the 480 MHz channel bandwidth includes [−2036:Ng: −1796],
a sixth subset of subcarrier indices that provide feedback for a sixth 20 MHz subchannel of the 480 MHz channel bandwidth includes [−1788:Ng: −1548],
a seventh subset of subcarrier indices that provide feedback for a seventh 20 MHz subchannel of the 480 MHz channel bandwidth includes [−1524:Ng: −1284],
an eighth subset of subcarrier indices that provide feedback for an eighth 20 MHz subchannel of the 480 MHz channel bandwidth includes [−1276:Ng: −1036],
a ninth subset of subcarrier indices that provide feedback for a ninth 20 MHz subchannel of the 480 MHz channel bandwidth includes [−1012:Ng: −772],
a tenth subset of subcarrier indices that provide feedback for a tenth 20 MHz subchannel of the 480 MHz channel bandwidth includes [−764:Ng: −524],
an eleventh subset of subcarrier indices that provide feedback for an eleventh 20 MHz subchannel of the 480 MHz channel bandwidth includes [−500:Ng: −260],
a twelfth subset of subcarrier indices that provide feedback for a twelfth 20 MHz subchannel of the 480 MHz channel bandwidth includes [−252:Ng:−12],
a thirteenth subset of subcarrier indices that provide feedback for a thirteenth 20 MHz subchannel of the 480 MHz channel bandwidth includes [12:Ng:252],
a fourteenth subset of subcarrier indices that provide feedback for a fourteenth 20 MHz subchannel of the 480 MHz channel bandwidth includes [260:Ng:500],
a fifteenth subset of subcarrier indices that provide feedback for a fifteenth 20 MHz subchannel of the 480 MHz channel bandwidth includes [524:Ng:764],
a sixteenth subset of subcarrier indices that provide feedback for a sixteenth 20 MHz subchannel of the 480 MHz channel bandwidth includes [772:Ng:1012],
a seventeenth subset of subcarrier indices that provide feedback for a seventeenth 20 MHz subchannel of the 480 MHz channel bandwidth includes [1036:Ng: 1276],
an eighteenth subset of subcarrier indices that provide feedback for an eighteenth 20 MHz subchannel of the 480 MHz channel bandwidth includes [1284:Ng: 1524],
a nineteenth subset of subcarrier indices that provide feedback for a nineteenth 20 MHz subchannel of the 480 MHz channel bandwidth includes [1548:Ng: 1788],
a twentieth subset of subcarrier indices that provide feedback for a twentieth 20 MHz subchannel of the 480 MHz channel bandwidth includes [1796:Ng: 2036],
a twenty-first subset of subcarrier indices that provide feedback for a twenty-first 20 MHz subchannel of the 480 MHz channel bandwidth includes [2060:Ng:2300],
a twenty-second subset of subcarrier indices that provide feedback for a twenty-second 20 MHz subchannel of the 480 MHz channel bandwidth includes [2308:Ng:2548],
a twenty-third subset of subcarrier indices that provide feedback for a twenty-third 20 MHz subchannel of the 480 MHz channel bandwidth includes [2572:Ng:2812],
a twenty-fourth subset of subcarrier indices that provide feedback for a twenty-fourth 20 MHz subchannel of the 480 MHz channel bandwidth includes [2820:Ng:3060], and
Ng is equal to the grouping value.

20. The wireless communications device of claim 18, wherein:
the channel bandwidth is 640 MHz,
the null data packet announcement frame indicates that feedback is requested in accordance with 242 tone resource units,
a first subset of subcarrier indices that provide feedback for a first 20 MHz subchannel of the 640 MHz channel bandwidth includes [−4084:Ng:−3844],
a second subset of subcarrier indices that provide feedback for a second 20 MHz subchannel of the 640 MHz channel bandwidth includes [−3836:Ng:−3596],
a third subset of subcarrier indices that provide feedback for a third 20 MHz subchannel of the 640 MHz channel bandwidth includes [−3572:Ng:−3332],
a fourth subset of subcarrier indices that provide feedback for a fourth 20 MHz subchannel of the 640 MHz channel bandwidth includes [−3324:Ng:−3084],
a fifth subset of subcarrier indices that provide feedback for a fifth 20 MHz subchannel of the 640 MHz channel bandwidth includes [−3060:Ng:−2820],
a sixth subset of subcarrier indices that provide feedback for a sixth 20 MHz subchannel of the 640 MHz channel bandwidth includes [−2812:Ng:−2572],
a seventh subset of subcarrier indices that provide feedback for a seventh 20 MHz subchannel of the 640 MHz channel bandwidth includes [−2548:Ng:−2308],
an eighth subset of subcarrier indices that provide feedback for an eighth 20 MHz subchannel of the 640 MHz channel bandwidth includes [−2300:Ng:−2060],
a ninth subset of subcarrier indices that provide feedback for a ninth 20 MHz subchannel of the 640 MHz channel bandwidth includes [−2036:Ng: −1796],
a tenth subset of subcarrier indices that provide feedback for a tenth 20 MHz subchannel of the 640 MHz channel bandwidth includes [−1788:Ng: −1548],
an eleventh subset of subcarrier indices that provide feedback for an eleventh 20 MHz subchannel of the 640 MHz channel bandwidth includes [−1524:Ng: −1284],
a twelfth subset of subcarrier indices that provide feedback for a twelfth 20 MHz subchannel of the 640 MHz channel bandwidth includes [−1276:Ng: −1036],
a thirteenth subset of subcarrier indices that provide feedback for a thirteenth 20 MHz subchannel of the 640 MHz channel bandwidth includes [−1012:Ng: −772],
a fourteenth subset of subcarrier indices that provide feedback for a fourteenth 20 MHz subchannel of the 640 MHz channel bandwidth includes [−764:Ng: −524],
a fifteenth subset of subcarrier indices that provide feedback for a fifteenth 20 MHz subchannel of the 640 MHz channel bandwidth includes [−500:Ng: −260],
a sixteenth subset of subcarrier indices that provide feedback for a sixteenth 20 MHz subchannel of the 640 MHz channel bandwidth includes [−252:Ng:−12],
a seventeenth subset of subcarrier indices that provide feedback for a seventeenth 20 MHz subchannel of the 640 MHz channel bandwidth includes [12:Ng:252],
an eighteenth subset of subcarrier indices that provide feedback for an eighteenth 20 MHz subchannel of the 640 MHz channel bandwidth includes [260:Ng:500],
a nineteenth subset of subcarrier indices that provide feedback for a nineteenth 20 MHz subchannel of the 640 MHz channel bandwidth includes [524:Ng:764],
a twentieth subset of subcarrier indices that provide feedback for a twentieth 20 MHz subchannel of the 640 MHz channel bandwidth includes [772:Ng:1012],
a twenty-first subset of subcarrier indices that provide feedback for a twenty-first 20 MHz subchannel of the 640 MHz channel bandwidth includes [1036:Ng: 1276],
a twenty-second subset of subcarrier indices that provide feedback for a twenty-second 20 MHz subchannel of the 640 MHz channel bandwidth includes [1284:Ng: 1524],
a twenty-third subset of subcarrier indices that provide feedback for a twenty-third 20 MHz subchannel of the 640 MHz channel bandwidth includes [1548:Ng: 1788],
a twenty-fourth subset of subcarrier indices that provide feedback for a twenty-fourth 20 MHz subchannel of the 640 MHz channel bandwidth includes [1796:Ng: 2036],
a twenty-fifth subset of subcarrier indices that provide feedback for a twenty-fifth 20 MHz subchannel of the 640 MHz channel bandwidth includes [2060:Ng:2300],
a twenty-sixth subset of subcarrier indices that provide feedback for a twenty-sixth 20 MHz subchannel of the 640 MHz channel bandwidth includes [2308:Ng:2548],
a twenty-seventh subset of subcarrier indices that provide feedback for a twenty-seventh 20 MHz subchannel of the 640 MHz channel bandwidth includes [2572:Ng:2812],
a twenty-eighth subset of subcarrier indices that provide feedback for a twenty-eighth 20 MHz subchannel of the 640 MHz channel bandwidth includes [2820:Ng:3060],
a twenty-ninth subset of subcarrier indices that provide feedback for a twenty-ninth 20 MHz subchannel of the 640 MHz channel bandwidth includes [3084:Ng:3324],
a thirtieth subset of subcarrier indices that provide feedback for a thirtieth 20 MHz subchannel of the 640 MHz channel bandwidth includes [3332:Ng:3572],
a thirty-first subset of subcarrier indices that provide feedback for a thirty-first 20 MHz subchannel of the 640 MHz channel bandwidth includes [3596:Ng:3836],
a thirty-second subset of subcarrier indices that provide feedback for a thirty-second 20 MHz subchannel of the 640 MHz channel bandwidth includes [3844:Ng:4084], and
Ng is equal to the grouping value.

21. The wireless communications device of claim 18, wherein:
the channel bandwidth is 480 MHz,
the null data packet announcement frame indicates that feedback is requested in accordance with 996 tone resource units,
the grouping value is 4,
a first subset of subcarrier indices that provide feedback for a first 80 MHz subchannel of the 480 MHz channel bandwidth includes [−3060:4:−2564, −2556:4:−2060],
a second subset of subcarrier indices that provide feedback for a second 80 MHz subchannel of the 480 MHz channel bandwidth includes [−2036:4:−1540, −1532:4:−1036],
a third subset of subcarrier indices that provide feedback for a third 80 MHz subchannel of the 480 MHz channel bandwidth includes [−1012:4:−516, −508:4:−12],
a fourth subset of subcarrier indices that provide feedback for a fourth 80 MHz subchannel of the 480 MHz channel bandwidth includes [12:4:508, 516:4:1012],
a fifth subset of subcarrier indices that provide feedback for a fifth 80 MHz subchannel of the 480 MHz channel bandwidth includes [1036:4:1532, 1540:4:2036], and
a sixth subset of subcarrier indices that provide feedback for a sixth 80 MHz subchannel of the 480 MHz channel bandwidth includes [2060:4:2556, 2564:4:3060].

22. The wireless communications device of claim 18, wherein:
the channel bandwidth is 640 MHz,
the null data packet announcement frame indicates that feedback is requested in accordance with 996 tone resource units,
the grouping value is 4,
a first subset of subcarrier indices that provide feedback for a first 80 MHz subchannel of the 640 MHz channel bandwidth includes [−4084:4:−3588, −3580:4:−3084],
a second subset of subcarrier indices that provide feedback for a second 80 MHz subchannel of the 640 MHz channel bandwidth includes [−3060:4:−2564, −2556:4:−2060],
a third subset of subcarrier indices that provide feedback for a third 80 MHz subchannel of the 640 MHz channel bandwidth includes [−2036:4:−1540, −1532:4:−1036],
a fourth subset of subcarrier indices that provide feedback for a fourth 80 MHz subchannel of the 640 MHz channel bandwidth includes [−1012:4:−516, −508:4:−12],
a fifth subset of subcarrier indices that provide feedback for a fifth 80 MHz subchannel of the 640 MHz channel bandwidth includes [12:4:508, 516:4:1012],
a sixth subset of subcarrier indices that provide feedback for a sixth 80 MHz subchannel of the 640 MHz channel bandwidth includes [1036:4:1532, 1540:4:2036],
a seventh subset of subcarrier indices that provide feedback for a seventh 80 MHz subchannel of the 640 MHz channel bandwidth includes [2060:4:2556, 2564:4:3060], and
an eighth subset of subcarrier indices that provide feedback for an eighth 80 MHz subchannel of the 640 MHz channel bandwidth includes [3084:4:3580, 3588:4:4084].

23. The wireless communications device of claim 18, wherein:
the channel bandwidth is 480 MHz,
the null data packet announcement frame indicates that feedback is requested in accordance with 996 tone resource units,
the grouping value is 16,
a first subset of subcarrier indices that provide feedback for a first 80 MHz subchannel of the 480 MHz channel bandwidth includes [−3060:16:−2820, −2812:16:−2572, −2564, −2556, −2548:16:−2308, −2300:16:−2060],
a second subset of subcarrier indices that provide feedback for a second 80 MHz subchannel of the 480 MHz channel bandwidth includes [−2036:16:−1796, −1788:16:−1548, −1540, −1532, −1524:16:−1284, −1276:16:−1036],
a third subset of subcarrier indices that provide feedback for a third 80 MHz subchannel of the 480 MHz channel bandwidth includes [−1012:16:−772, −764:16:−524, −516, −508, −500:16:−260, −252:16:−12],
a fourth subset of subcarrier indices that provide feedback for a fourth 80 MHz subchannel of the 480 MHz channel bandwidth includes [12:16:252, 260:16:500, 508, 516, 524:16:764, 772:16:1012],
a fifth subset of subcarrier indices that provide feedback for a fifth 80 MHz subchannel of the 480 MHz channel bandwidth includes [1036:16:1276, 1284:16:1524, 1532, 1540, 1548:16:1788, 1796:16:2036], and
a sixth subset of subcarrier indices that provide feedback for a sixth 80 MHz subchannel of the 480 MHz channel bandwidth includes [2060:16:2300, 2308:16:2548, 2556, 2564, 2572:16:2812, 2820:16:3060].

24. The wireless communications device of claim 18, wherein:
the channel bandwidth is 640 MHz,
the null data packet announcement frame indicates that feedback is requested in accordance with 996 tone resource units,
the grouping value is 16,
a first subset of subcarrier indices that provide feedback for a first 80 MHz subchannel of the 640 MHz channel bandwidth includes [−4084:16:−3844, −3836:16:−3596, −3588, −3580, −3572:16:−3332, −3324:16:−3084],
a second subset of subcarrier indices that provide feedback for a second 80 MHz subchannel of the 640 MHz channel bandwidth includes [−3060:16:−2820, −2812:16:−2572, −2564, −2556, −2548:16:−2308, −2300:16:−2060],
a third subset of subcarrier indices that provide feedback for a third 80 MHz subchannel of the 640 MHz channel bandwidth includes [−2036:16:−1796, −1788:16:−1548, −1540, −1532, −1524:16:−1284, −1276:16:−1036],
a fourth subset of subcarrier indices that provide feedback for a fourth 80 MHz subchannel of the 640 MHz channel bandwidth includes [−1012:16:−772, −764:16:−524, −516, −508, −500:16:−260, −252:16:−12],
a fifth subset of subcarrier indices that provide feedback for a fifth 80 MHz subchannel of the 640 MHz channel bandwidth includes [12:16:252, 260:16:500, 508, 516, 524:16:764, 772:16:1012],
a sixth subset of subcarrier indices that provide feedback for a sixth 80 MHz subchannel of the 640 MHz channel bandwidth includes [1036:16:1276, 1284:16:1524, 1532, 1540, 1548:16:1788, 1796:16:2036],
a seventh subset of subcarrier indices that provide feedback for a seventh 80 MHz subchannel of the 640 MHz channel bandwidth includes [2060:16:2300, 2308:16:2548, 2556, 2564, 2572:16:2812, 2820:16:3060], and
an eighth subset of subcarrier indices that provide feedback for an eighth 80 MHz subchannel of the 640 MHz channel bandwidth includes [3084:16:3324, 3332:16:3572, 3580, 3588, 3596:16:3836, 3844:16:4084].

25. A method for wireless communications by a wireless communications device, comprising:
receiving a null data packet announcement frame comprising a partial bandwidth information field, the partial bandwidth information field including a first set of bits indicating a frequency resolution and a second set of bits including a feedback bitmap, the feedback bitmap indicating one or more portions of a channel bandwidth over which to provide feedback in accordance with the frequency resolution, wherein a value of the first set of bits and a quantity of bits in the second set of bits are based at least in part on the channel bandwidth being one of 480 MHz or 640 MHz;
receiving, in accordance with the null data packet announcement frame, a null data packet; and
transmitting a feedback report based at least in part on the null data packet and the partial bandwidth information field.

26. The method of claim 25, wherein the channel bandwidth is 480 MHz, the first set of bits comprises one bit and indicates that the frequency resolution is 40 MHz, and the feedback bitmap comprises 12 bits.

27. The method of claim 25, wherein the channel bandwidth is 480 MHz, the first set of bits comprises two bits and indicates that the frequency resolution is 80 MHz, and the feedback bitmap comprises 6 bits.

28. The method of claim 25, wherein the channel bandwidth is 640 MHz, the first set of bits comprises one bit and indicates that the frequency resolution is 40 MHz, and the feedback bitmap comprises 16 bits.

29. The method of claim 25, wherein the channel bandwidth is 640 MHz, the first set of bits comprises two bits and indicates that the frequency resolution is 80 MHz, and the feedback bitmap comprises 8 bits.

30. A method for wireless communications wireless communications device, comprising:
transmitting a null data packet announcement frame comprising a partial bandwidth information field, the partial bandwidth information field including a first set of bits indicating a frequency resolution and a second set of bits including a feedback bitmap, the feedback bitmap indicating one or more portions of a channel bandwidth over which to provide feedback in accordance with the frequency resolution, wherein a value of the first set of bits and a quantity of bits in the second set of bits are based at least in part on the channel bandwidth being one of 480 MHz or 640 MHz;
transmitting, in accordance with the null data packet announcement frame, a null data packet; and
receiving a feedback report based at least in part on the null data packet and the partial bandwidth information field.
